(19) United States
(12) Patent Application Publication
(10) Pub. No.: US 2026/0342547 A1
(43) Pub. Date: Oct. 29, 2026

(54) CONTENT ENCRYPTION CONFIGURATION MANAGEMENT FOR ENCRYPTION OF MEDIA CONTENT

(71) Applicant: QUALCOMM Incorporated, San Diego, CA (US)

(72) Inventor: Khalid TAHBOUB, San Diego, CA (US)

(21) Appl. No.: 19/659,840

(22) Filed: Apr. 27, 2026

Related U.S. Application Data
(60) Provisional application No. 63/796,952, filed on Apr. 29, 2025.

(51) Int. Cl. H04L 9/08; G06V 10/25; G06V 10/764; H04L 9/30

(52) U.S. Cl. CPC H04L 9/0825; G06V 10/25; G06V 10/764; H04L 9/0861; H04L 9/30

(57) ABSTRACT

A device includes a memory configured to store one or more content encryption configuration entries. A first content encryption configuration entry of the one or more content encryption configuration entries is associated with a first content encryption configuration and indicates a first object class indicating a first object to be detected based on input media data, and a first key associated with the first object class. The device also includes one or more processors configured to maintain the one or more content encryption configuration entries at the memory. To maintain the first content encryption configuration entry, the one or more processors are further configured to modify, based on a received update associated with the first content encryption configuration, the first content encryption configuration entry to generate an updated first content encryption configuration entry.

### I. CROSS-REFERENCE TO RELATED APPLICATIONS

The present application claims priority from the commonly owned U.S. Provisional Patent Application No. 63/796,952, filed Apr. 29, 2025, entitled “CONTENT ENCRYPTION CONFIGURATION MANAGEMENT FOR ENCRYPTION OF MEDIA CONTENT”, the content of which is incorporated herein by reference in its entirety.

### II. FIELD

The present disclosure is generally related to management of one or more content encryption configurations.

### III. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

The advances in technology have also made digital cameras ubiquitous to modern life. The prevalence of digital cameras and the availability of low-cost memory devices to store images and videos has resulted in a large amount of image and video content. The ability to generate, store, and share the image and video content has increased privacy and security concerns. For example, privacy concerns may be related to an individual’s right to his or her personal information, likeness or image, or a combination thereof. As another example, privacy concerns have increased in view of the potential of personal content being used to train artificial intelligence (AI) models. Various regulations have been enacted to address such privacy concerns and that detail storage and sharing of images or video collected in certain circumstances, such as images or video collection associated with autonomous driving, a dashboard camera, surveillance systems, in-cabin monitoring or personal use. However, the assumption of privacy varies based on different regulations and in different countries.

One technique that has been used to comply with the various regulations includes masking content to be protected. For example, traditional masking can include encoding an input video into a bitstream and providing manual or automated annotation to the bitstream to generate processed pixel data (e.g., YUV values) that is then encoded into a second bitstream having masked content. Another technique that has been used includes applying an encryption method, such as advanced encryption standard (AES) encryption. For example, an input video is encoded into a bitstream, a fragment/scramble operation is performed on the bitstream to generate bitstream segments, and asymmetric encryption is performed, based on or using a key (e.g., a secret key), on the bitstream segments to generate an encrypted bitstream. However, the conventional techniques can often encrypt more content (e.g., a whole bitstream) than is needed to comply with a regulation, which results in high computational complexity and power consumption. Additionally, the conventional techniques do not allow for both authorized and non-authorized access of encrypted content using the same encrypted bitstream (e.g., a single bitstream having encrypted and/or masked content).

Still other techniques selectively encrypt fields, records, or messages within application data streams or network communications based on data-schema rules or policy configurations. However, such techniques operate on structured data fields or messages at an application or network level and do not operate within a media generation pipeline to encrypt perceptually meaningful regions of captured media, such as regions of interest corresponding to detected instances of object classes in image or video media data.

### IV. SUMMARY

According to one implementation of the present disclosure, a device includes a memory configured to store one or more content encryption configuration entries. A first content encryption configuration entry of the one or more content encryption configuration entries is associated with a first content encryption configuration and indicates a first object class indicating a first object to be detected based on input media data, and a first key associated with the first object class. The device also includes one or more processors configured to maintain the one or more content encryption configuration entries at the memory. To maintain the first content encryption configuration entry, the one or more processors are further configured to receive an update associated with the first content encryption configuration, and modify, based on the update, the first content encryption configuration entry to generate an updated first content encryption configuration entry.

According to another implementation of the present disclosure, a method includes storing, at a memory, one or more content encryption configuration entries. A first content encryption configuration entry of the one or more content encryption configuration entries is associated with a first content encryption configuration and indicates a first object class indicating a first object to be detected based on input media data , and a first key associated with the first object class. The method further includes maintaining the one or more content encryption configuration entries at the memory. Maintaining the one or more content encryption configuration entries includes receiving an update associated with the first content encryption configuration, and modifying, based on the update, the first content encryption configuration entry to generate an updated first content encryption configuration entry.

According to another implementation of the present disclosure, a non-transitory computer-readable medium stores instructions that are executable by one or more processors to cause the one or more processors to store, at a memory, one or more content encryption configuration entries. A first content encryption configuration entry of the one or more content encryption configuration entries is associated with a first content encryption configuration and indicates a first object class indicating a first object to be detected based on input media data, and a first key associated with the first object class. The instructions further cause the one or more processors to maintain the one or more content encryption configuration entries at the memory. To maintain the one or more content encryption configuration entries, the instructions are further executable by the one or more processors to cause the one or more processors to receive an update associated with the first content encryption configuration, and modify, based on the update, the first content encryption configuration entry to generate an updated first content encryption configuration entry.

According to another implementation of the present disclosure, an apparatus includes means for storing one or more content encryption configuration entries. A first content encryption configuration entry of the one or more content encryption configuration entries is associated with a first content encryption configuration and indicates a first object class indicating a first object to be detected based on input media data, and a first key associated with the first object class. The apparatus further includes means for maintaining the one or more content encryption configuration entries at the means for storing. The means for maintaining includes means for receiving an update associated with the first content encryption configuration, and means for modifying, based on the update, the first content encryption configuration entry to generate an updated first content encryption configuration entry.

Other aspects, advantages, and features of the present disclosure will become apparent after review of the entire application, including the following sections: Brief Description of the Drawings, Detailed Description, and the Claims.

### V .BRIEF DESCRIPTION OF THE DRAWINGS

FIG. 1 is a block diagram of an example of a system to manage one or more content encryption configurations, in accordance with one or more aspects of the present disclosure.

FIGS. 2A, 2B, 2C, 2D, and 2E are diagrams of examples of content encryption configurations associated with the system of FIG. 1, in accordance with one or more aspects of the present disclosure.

FIG. 3 is a diagram of an example of a method for management of one or more content encryption configurations, in accordance with some aspects of the present disclosure.

FIG. 4 is a diagram of an example of management of one or more content encryption configurations, in accordance with some aspects of the present disclosure.

FIG. 5 is a block diagram of an example of a system to manage one or more content encryption configurations, in accordance with one or more aspects of the present disclosure.

FIGS. 6A, 6B, 6C, 6D, and 6E are diagrams of examples of image frames to illustrate operations associated with the system of FIG. 1, in accordance with one or more aspects of the present disclosure.

FIG. 7A is a diagram of examples of encoded output data to illustrate operations associated with the system of FIG. 1, in accordance with one or more aspects of the present disclosure.

FIG. 7B is a diagram of an example of a bitstream of encoded output data to illustrate operations associated with the system of FIG. 1, in accordance with one or more aspects of the present disclosure.

FIG. 8A is a diagram of an illustrative example of a processor of the system of FIG. 1, in accordance with one or more aspects of the present disclosure.

FIG. 8B is a diagram of an example of a bitstream of encoded output data to illustrate operations associated with the system of FIG. 8A, in accordance with one or more aspects of the present disclosure.

FIGS. 9A, 9B, 9C, 9D, and 9E are diagrams of examples of image frames to illustrate operations associated with the system of FIG. 1, in accordance with one or more aspects of the present disclosure.

FIG. 10A is a block diagram of an example of a system to decode media content, in accordance with one or more aspects of the present disclosure.

FIG. 10B is a diagram of an example of operations that may be performed at the system of FIG. 10A.

FIGS. 10C, 10D, 10E, and 10F are block diagrams to illustrate operations associated with the system of FIG. 10A.

FIG. 11 is a block diagram of an example of a system to manage one or more content encryption configurations, in accordance with one or more aspects of the present disclosure.

FIG. 12 is a diagram of an example of an integrated circuit to manage one or more content encryption configurations, in accordance with some examples of the present disclosure.

FIG. 13 is a diagram of a mobile device operable to manage one or more content encryption configurations, in accordance with some examples of the present disclosure.

FIG. 14 is a diagram of a wearable electronic device operable to manage one or more content encryption configurations, in accordance with some examples of the present disclosure.

FIG. 15 is a diagram of a voice-controlled speaker system operable to manage one or more content encryption configurations, in accordance with some examples of the present disclosure.

FIG. 16 is a diagram of a camera operable to manage one or more content encryption configurations, in accordance with some examples of the present disclosure.

FIG. 17 is a diagram of a headset, such as a virtual reality, mixed reality, or augmented reality headset, operable to manage one or more content encryption configurations, in accordance with some examples of the present disclosure.

FIG. 18 is a diagram of a mixed reality or augmented reality glasses device operable to manage one or more content encryption configurations, in accordance with some examples of the present disclosure.

FIG. 19 is a diagram of a first example of a vehicle operable to manage one or more content encryption configurations, in accordance with some examples of the present disclosure.

FIG. 20 is a diagram of a second example of a vehicle operable to manage one or more content encryption configurations, in accordance with some examples of the present disclosure.

FIG. 21 is a diagram of an example of a method of management of one or more content encryption configurations, in accordance with some aspects of the present disclosure.

FIG. 22 is a block diagram of an illustrative example of a device that is operable to manage one or more content encryption configurations, in accordance with one or more aspects of the present disclosure.

### VI. DETAILED DESCRIPTION

The above-described problems associated with encryption of a whole bitstream and/or failure to allow for both authorized and non-authorized access of encrypted content using the same encrypted bitstream are solved by managing one or more content encryption configurations to enable selective encryption of at least a portion of a bitstream, as described herein. The present disclosure provides systems, devices, apparatus, methods, and computer-readable media for management of one or more content encryption configurations for media content systems. The management of the one or more content encryption configurations supports encryption of media content, such as encryption of at least a portion of the media content that includes an object. Some aspects more specifically relate to storing the one or more content encryption configurations at a device. For example, the one or more content encryption configuration may be stored as one or more content encryption configuration entries at a memory of the device. A first content encryption configuration entry of the one or more content encryption configuration entries may be associated with a first content encryption configuration and may indicate a first object class to be encrypted. In some aspects, the first content encryption configuration is obtained based on an input from a user of a device. In some other aspects, the first content encryption configuration is obtained (e.g., received) from another device, such as a device associated with an entity (e.g., a company, an organization, an original equipment manufacturer (OEM), etc.), a service provider, or another user (e.g., a contact of the user of the device). Some aspects also specifically relate to maintaining the one or more content encryption configuration entries by adding, updating, or removing at least one content encryption configuration entry. For example, the device may receive an update for the first content encryption configuration and may modify the first content encryption configuration entry based on the update. Some aspects also relate to detecting an instance of the first object class (of a first content encryption configuration entry) in input media data and generating encrypted media data based on a portion of the input media data that includes the instance of the object class. Additionally, the portion of the input media data can also be masked (e.g., in the input media data) to generate a masked version of the input media data. Output media data, such as a bitstream, can be generated that includes the masked version of the input media data, the encrypted media data, or a combination thereof.

Particular implementations of the subject matter described in this disclosure can be implemented to realize one or more of the following technical advantages. In some aspects, the present disclosure provides techniques for managing one or more content encryption configurations, such as one or more content encryption configuration entries, that can be used to detect and encrypt an object class at a device, such as a capture device. In some embodiments, at least one content encryption configuration may be received at the device from another device associated with a third party, such as an entity or user other than a user of the device, to enable the third party to request or implement content encryption at the device. In some other aspects, the present disclosure provides techniques for identifying a region of interest (associated with an object class) of the input media data, and encrypting at least the portion for privacy control and content management. In some examples, the techniques may also mask the sensitive content of the input media data to generate a masked version that can be displayed by one or more device or users that do not have authorization or access to the sensitive content (e.g., the encrypted data). A user or a device that has access to a key can decrypt the encrypted portion and thereby recover the sensitive content and combine the recovered sensitive content with the masked content to generate (e.g., recreate) the original content. In some embodiments, the techniques may be applied to provide automatic sensitive content (partial video) encryption while the video is captured for the first time. The partial video encryption can allow for both authorized and non-authorized access of encrypted content using the same encrypted bitstream, thus reducing the amount of transmission bandwidth and storage capacity that would otherwise be required to accommodate receipt, storage, and playback of both authorized and non-authorized versions of the media data at a device and, as a result, improving the efficiency of the device by enabling provision of both authorized and non-authorized versions using fewer resources as compared to conventional devices. In some aspects, the techniques described herein provide an encryption infrastructure embedded in a media generation pipeline, where encryption is bound to one or more object classes detected within media content rather than to data fields or messages of an application data stream or a network communication.

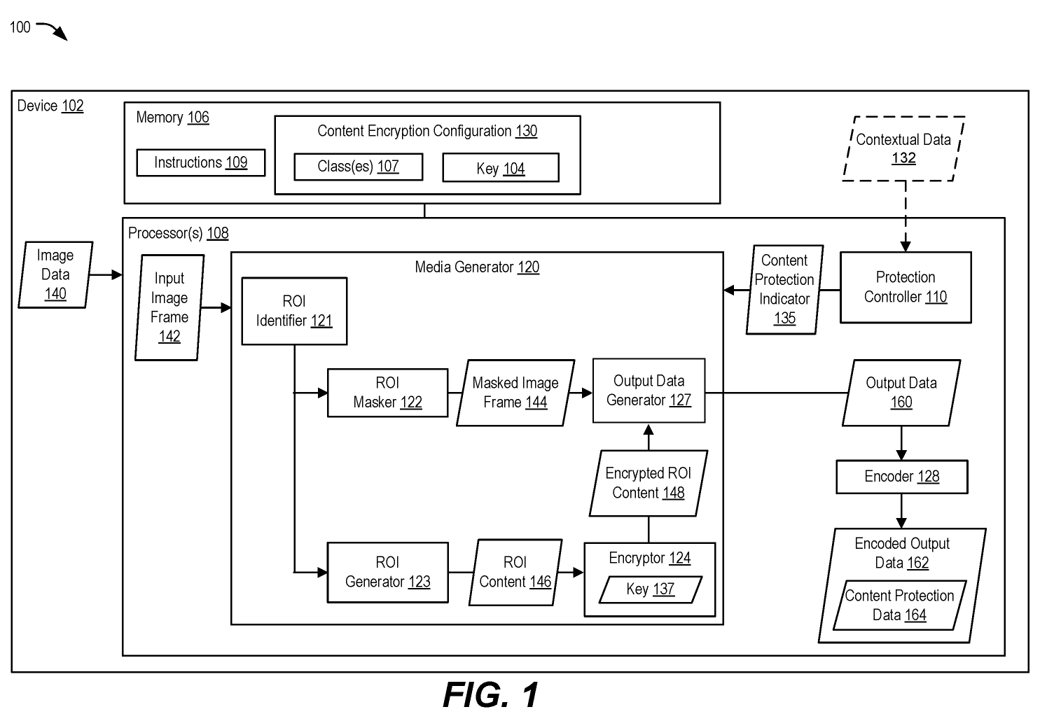

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 102 including one or more processors (“processor(s)” 108 of FIG. 1), which indicates that in some implementations the device 102 includes a single processor 108 and in other implementations the device 102 includes multiple processors 108. For ease of reference herein, such features are generally introduced as “one or more” features and are subsequently referred to in the singular or optional plural (as indicated by “(s)”) unless aspects related to multiple of the features are being described.

In some drawings, multiple instances of a particular type of feature are used. Although these features are physically and/or logically distinct, the same reference number is used for each, and the different instances are distinguished by addition of a letter to the reference number. When the features as a group or a type are referred to herein - e.g., when no particular one of the features is being referenced, the reference number is used without a distinguishing letter. However, when one particular feature of multiple features of the same type is referred to herein, the reference number is used with the distinguishing letter.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “obtaining,” “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “obtaining,” “generating,” “calculating,” “estimating,” “using,” “selecting,” “accessing,” and “determining” may be used interchangeably. For example, “obtaining,” “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows – a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” In transfer learning a base model may be trained using a generic or typical data set, and the base model may be subsequently refined (e.g., re-trained or further trained) using a more specific data set.

A data set used during training is referred to as a “training data set” or simply “training data.” The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

FIG. 1 is a block diagram of an example of a system 100 to manage one or more content encryption configurations 130, in accordance with one or more aspects of the present disclosure. The system 100 includes a device 102 that is configured to or is operable to manage the one or more content encryption configurations 130. Additionally, the device 102 is configured to or is operable to, based on at least one of the one or more content encryption configurations 130, identify and encrypt media content.

The device 102 includes, or is coupled to, a memory 106 (e.g., a memory device) and one or more processors 108 (collectively referred to herein as the “processor 108”). The memory 106 may include one or more memory devices, such as a single memory or multiple different memory devices (of the same type or of different types).

The memory 106 is configured to store instructions 109 and the one or more content encryption configurations 130 (collectively referred to herein as the “content encryption configuration 130”). The instructions 109, when executed by the processor 108, cause the processor 108 to perform one or more operations as described herein. The content encryption configuration 130 may be associated with or indicate content (e.g., sensitive content) to be protected. The content encryption configuration 130 may be determined or generated by a user of the device 102, by another user (e.g., a contact of the user of the device 102), by a provider (e.g., a service provider or OEM) associated with the device 102, by a company or entity, based on a regulation, or a combination thereof. In some embodiments, the content encryption configuration 130 may be associated with media content generated in association with a surveillance system (e.g., a body camera or a closed circuit camera system), a personal recording (e.g., recorded in a public space or a private space), a vehicle (e.g., for autonomous driving, a dashboard camera, or for in-cabin monitoring), or a combination thereof, as illustrative, non-limiting examples.

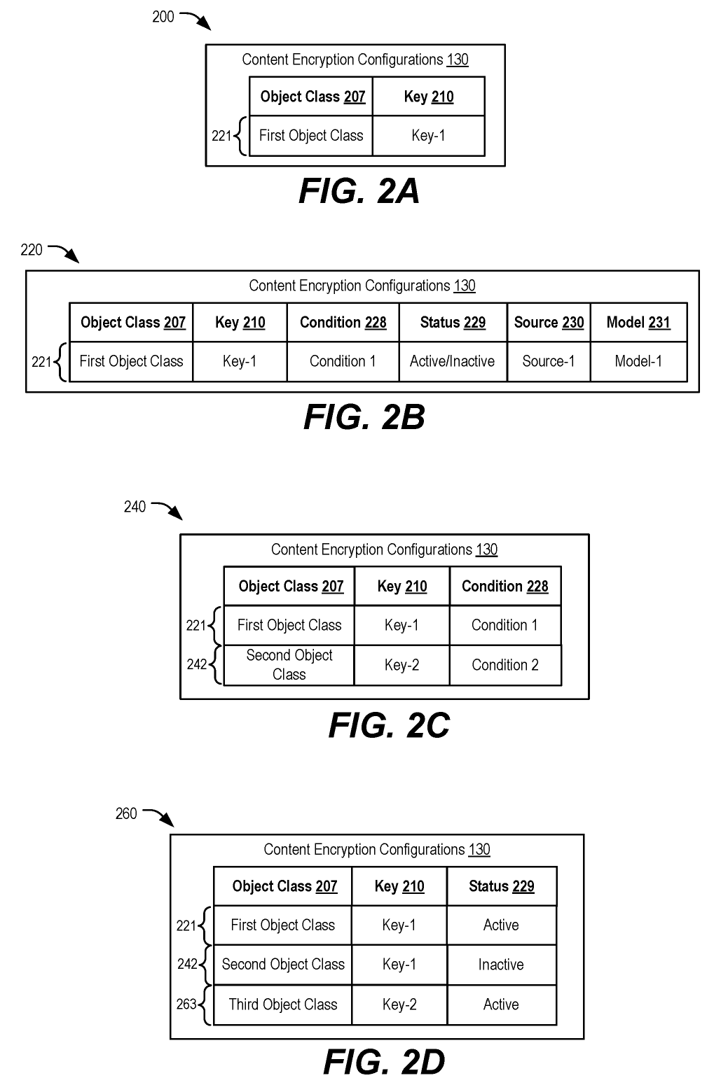

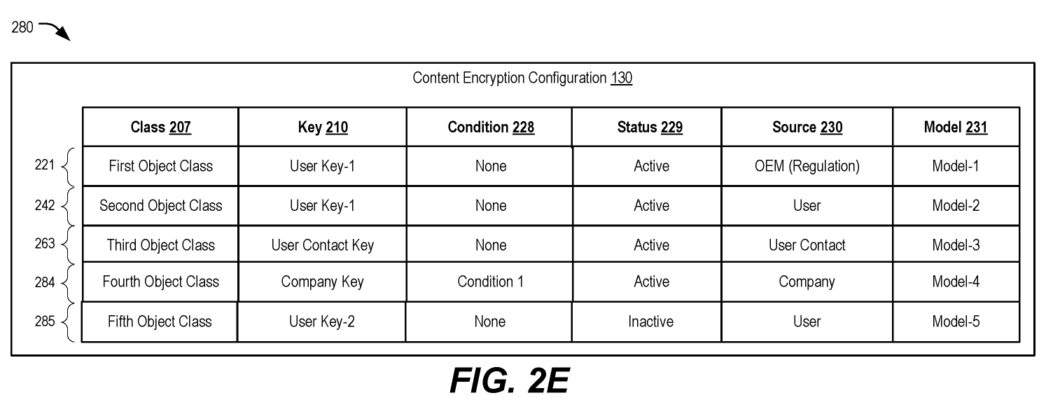

In some embodiments, the content encryption configuration 130 includes multiple content encryption configurations. For example, the content encryption configuration 130 may include a first content encryption configuration and a second content encryption configuration. In some embodiments, different configurations of the content encryption configuration 130 are stored in the memory 106 as different entries, such as different content encryption configuration entries. For example, the memory 106 may store a first content encryption configuration entry associated with the first content encryption configuration, a second content encryption configuration entry associated with the second content encryption configuration, or both. Examples of different entries of the content encryption configuration 130 are described further herein at least with reference to FIGS. 2A-2E.

The content encryption configuration 130, such as a first content encryption configuration, includes or indicates one or more object classes 107 (collectively referred to herein as the “object class 107”) and one or more keys 104 (collectively referred to herein as the “key 104”). The object class 107 indicates a class or type of one or more objects to be identified or detected within media content. The media content, such as input media content, may include image data, an image frame, video data (e.g., a sequence of multiple image frames), audio data, or a combination thereof. The object class 107 may include or be associated with sensitive, private, or confidential content to be protected. In some embodiments, the class or type of the one or more objects may include or indicate a human body, a body part, a particular individual, a human face, a voice, a word or phrase, a sound, a vehicle, a type of vehicle, a vehicle manufacturer, a vehicle model, a vehicle license plate, an address, a street name, a weapon, a type of weapon, an animal, a document, a poster, a display or monitor (e.g., a computer screen or a display device), a whiteboard, a logo or company identifier, or a combination thereof, as illustrative, non-limiting examples. Additionally, or alternatively, the object class 107 includes or indicates all media content, such as an entire image frame, an entire bitstream, all audio content, or a combination thereof).

The key 104 may include or correspond to a respective object class 107. The key 104 may be configured to encrypt at least a portion of media content that includes or is associated with an instance of the object class 107, decrypt an encrypted portion of the media content, encrypt another key, decrypt the other encrypted key, or a combination thereof. In an example in which the key 104 includes multiple keys, the key 104 may include a first key (e.g., the key 137) configured to encrypt at least a portion of media content that includes or is associated with an instance of the object class 107 or decrypted an encrypted version of the portion, a second key (e.g., a public key of a public-private key pair) configured to encrypt information (such as the first key), a third key (e.g., a private key of the public-private key pair) configured to decrypt information encrypted using the second key, or a combination thereof. In some embodiments, the key 137 is configured to be used to encrypt at least the portion of media content that includes or is associated with the instance of the object class 107 in order to generate an encrypted version of the portion, and to decrypted the encrypted version of the portion to recover the portion. It is noted that in some embodiments, the content encryption configuration 130 may not include or indicate the key 104.

In some embodiments, the content encryption configuration 130 includes or indicates a condition. The condition (e.g., an encryption condition) may indicate or define one or more situations or circumstances in which the object class 107 is to be encrypted. For example, when the condition is satisfied (e.g., the condition is present), an instance of the object class 107 detected within the media content is to be encrypted. Alternatively, when the condition is not satisfied (e.g., the condition is not present) the instance of the object class 107 does not need to be detected within the media content and/or a detected instance of the object class 107 within the media content does not need to be encrypted.

In some embodiments, the condition indicates to encrypt the object class 107 based on a physical space or an environment, such as a physical space or environment associated with an office, a public space, an outdoor space, a restricted area, or a particular geographic location. Additionally, or alternatively, the condition may indicate to encrypt the object class 107 based on an object, availability of a particular wireless network, a positioning system (e.g., a global positioning system, an indoor positioning system, etc.), a location of the device 102 (e.g., a geographic coordinate), or a combination thereof.

In a first example of the content encryption configuration 130, the condition indicates to encrypt the object class 107 based on a physical space (e.g., a geofenced area) associated with an office, availability of a particular wireless network to the device 102, a positioning system (e.g., a location of the device 102 as determined by the positioning system), or a particular geographic location associated with the device 102. Additionally, in the first example of the content encryption configuration 130, the object class 107 includes a document, a whiteboard, a poster, a computer screen, a display device, or a combination thereof. In a second example of the content encryption configuration 130, the condition indicates to encrypt the object class 107 based on the device 102 being located in or associated with a physical space or an environment that is associated with a restricted area. Additionally, in the second example of the content encryption configuration 130, the object class 107 includes all content of the input media data. In a third example of the content encryption configuration 130, the condition indicates to encrypt the object class 107 based on an environment associated with the device 102 being an outdoor area, a public area, or a combination thereof. Additionally, in the third example of the content encryption configuration 130, the object class 107 includes human faces. In a fourth example of the content encryption configuration 130, the condition indicates to encrypt the object class 107 based on the object class being located on a building, a document, a sign, or a combination thereof. Additionally, in the fourth example of the content encryption configuration 130, the object class 107 includes an address, a street name, or a combination thereof. In a fifth example of the content encryption configuration 130, the condition indicates to encrypt the object class 107 based on the object class being located on a vehicle. Additionally, in the fifth example of the content encryption configuration 130, the object class 107 includes a license plate. It is noted that the examples of the content encryption configuration 130 are provided as non-limiting examples and that other examples of the content encryption configuration 130 (e.g., the condition and/or the object class 107) are possible. In some embodiments, the content encryptions configuration 130 described with reference to the first example, the second example, the third example, the fourth example, the fifth example, or another example, may not include or indicate a key (e.g., the key 104). In some such embodiments, the device 102 may be configured to generate a masked image frame 144 without generating region of interest (ROI) content 146 and/or encrypted ROI content 148, as described further herein.

In some embodiments, the content encryption configuration 130 and/or the object class 107 may also include or indicate a model, such as a neural network model, AI model or ML model, to be used to identify or detect a corresponding object class or object type of one or more objects within media content. In some other implementations, the content encryption configuration 130 may include additional information, such as a status indicator that indicates whether or not the content encryption configuration 130 is active (e.g., whether or not the condition is satisfied), a source (e.g., an owner) of the content encryption configuration 130, a timestamp or date of when the content encryption configuration 130 was stored or updated, a time period or duration during which the content configuration 130 is active, or a combination thereof.

In some embodiments, the content encryption configuration 130 includes multiple configurations (e.g., multiple entries) that originate from different sources, such as a user of the device 102, a contact of the user, a provider associated with the device 102, a company or other entity, a regulation, or a combination thereof. In some embodiments, the content encryption configuration 130 includes or indicates a priority associated with one or more of the multiple configurations. The priority may be determined based on the source of the respective configuration (e.g., a regulation-based configuration may have a higher priority than a company-based configuration, which may have a higher priority than a personal or contact-based configuration), based on a sensitivity level associated with the respective object class 107, based on a geographic or contextual scope associated with the respective configuration, based on a user-defined ranking, based on a recency of provisioning of the respective configuration, or a combination thereof. In some embodiments, the priority is included as a field of an entry of the content encryption configuration 130, similar to or in addition to the object class 107, the condition, the key 104, and the status described further herein at least with reference to FIGS. 2A-2E. In some embodiments, the priority of a configuration of the content encryption configuration 130 is context-bounded, such that the configuration has a first priority when the device 102 is associated with a particular context (e.g., when the contextual data 132 indicates that the device 102 is in a particular geographic location, is connected to a particular network, is in a particular environment, or a combination thereof) and has a second priority that is different than the first priority when the device 102 is not associated with the particular context. For example, the protection controller 110 may elevate a priority of a corporate configuration when the device 102 is determined to be at a particular facility based on the contextual data 132, such that the corporate configuration controls over a personal configuration within the facility and the personal configuration controls outside the facility.

In some embodiments, the protection controller 110 is configured to evaluate compatibility between two or more configurations of the content encryption configuration 130 that are simultaneously active (e.g., that each have a status indicating active). For example, the protection controller 110 may determine that two or more configurations are compatible (e.g., the configurations have non-overlapping object classes 107 or non-conflicting encryption settings such that each of the configurations may be applied independently of one or more other of the configurations), incompatible (e.g., the configurations indicate different keys 104 for a same object class 107, indicate different conditions for a same object class 107, indicate different mask techniques for a same object class 107, indicate overlapping object classes 107 that result in overlapping regions of interest within the input image frame 142, indicate conflicting encrypt-or-do-not-encrypt settings for a same object class 107, or a combination thereof), or that a first configuration is subsumed by a second configuration (e.g., the first configuration applies broadly to an object class 107 and the second configuration applies to a narrower subset of the same object class 107). Compatible configurations may be applied independently of one another, and incompatible configurations may be processed using a conflict resolution rule.

In some embodiments, the protection controller 110 is configured to resolve a conflict between two or more configurations of the content encryption configuration 130 based on a conflict resolution rule. The conflict resolution rule may include a strict priority rule (e.g., a configuration having a highest priority among the conflicting configurations controls, and one or more lower-priority configurations are not applied for the conflicting entry), a most-restrictive rule (e.g., the encrypted ROI content 148 is generated based on a most-restrictive of the conflicting configurations, such that the ROI is encrypted if any one of the conflicting configurations indicates that encryption is required for the ROI), a compound encryption rule (e.g., ROI content corresponding to the ROI is encrypted using multiple keys 104 corresponding to the conflicting configurations, in series or in parallel, such that the encrypted ROI content 148 is decryptable based on a private key associated with any one of the conflicting configurations), a subsumption rule (e.g., a narrower of the conflicting configurations applies within a scope of the narrower configuration and a broader of the conflicting configurations applies outside the scope of the narrower configuration), or a combination thereof. The conflict resolution rule may be indicated by the content encryption configuration 130, the content protection indicator 135, or a combination thereof. In some embodiments, the encoded output data 162 includes the content protection data 164 that indicates one or more of the configurations of the content encryption configuration 130 that contributed to generation of the encrypted ROI content 148, such that the content protection data 164 enables identification of which of multiple active configurations was applied to generate the encrypted ROI content 148.

In some embodiments, the content encryption configuration 130 includes or indicates, for one or more entries of the content encryption configuration 130, a designation of an entry as required or preferred. A required entry may be applied when the corresponding condition is satisfied regardless of conflicts with one or more other entries, and a preferred entry may be applied when the corresponding condition is satisfied and when the preferred entry does not conflict with one or more required entries. In some embodiments, two or more required entries from different sources are applied cumulatively, and one or more preferred entries are applied only when compatible with one or more active required entries. In some embodiments, the priority of one or more configurations of the content encryption configuration 130 is user-configurable, such that a user of the device 102 is able to adjust an order or ranking of the one or more configurations (e.g., via a user interface of the device 102). In some embodiments, the user configurability is tiered, such that one or more configurations are not user-modifiable (e.g., a regulation-based configuration is fixed and is not modifiable by the user of the device 102) and one or more other configurations are user-modifiable within one or more constraints imposed by the one or more non-user-modifiable configurations (e.g., a corporate configuration is reorderable within a corporate-permitted range but is not reorderable above a regulation-based configuration, and a personal configuration is fully user-configurable).

In some embodiments, the protection controller 110 is configured to determine that a conflict exists between two or more configurations of the content encryption configuration 130 and to generate a notification (e.g., to be provided via a user interface of the device 102) of the conflict. In some embodiments, the protection controller 110 is configured to apply a default conflict resolution rule without user intervention based on a determination of the conflict. In some other embodiments, the protection controller 110 is configured to prompt a user of the device 102, via the user interface, to select a conflict resolution rule from among multiple conflict resolution rules or to override a default conflict resolution rule, where an ability of the user to override the default conflict resolution rule may be limited based on the tiered user configurability described above (e.g., the user is permitted to override the default conflict resolution rule for one or more personal configurations and is not permitted to override the default conflict resolution rule for one or more regulation-based configurations).

In some embodiments, the protection controller 110 is configured to maintain the content encryption configuration 130 by performing one or more management operations that include modifying a priority of a configuration of the content encryption configuration 130. For example, the processor 108 (e.g., the protection controller 110) may receive an update associated with the content encryption configuration 130, where the update indicates a modified priority for one or more entries of the content encryption configuration 130, and the protection controller 110 may modify the priority of the one or more entries based on the update. In some embodiments, the update is received from a same source as the source associated with the entry being modified, such as a regulation-based update that modifies a priority of a regulation-based entry or a company-based update that modifies a priority of a company-based entry. In some embodiments, the update is received from a different source than the source associated with the entry being modified, and the protection controller 110 is configured to process the update based on whether the source of the update has authority to modify the priority of the entry, as described further herein with reference to tiered authority enforcement. In some embodiments, modifying a priority of one entry of the content encryption configuration 130 results in a change in which configuration controls a region of interest associated with a particular object class 107, even where one or more other fields of the entry (e.g., the object class 107, the condition, the key 104, and the status) remain unchanged.

In some embodiments, the protection controller 110 is configured to maintain the content encryption configuration 130 by modifying a designation of an entry of the content encryption configuration 130 as required or preferred. For example, the processor 108 (e.g., the protection controller 110) may receive an update that indicates a modified designation for one or more entries (e.g., to re-designate a preferred entry as required or to re-designate a required entry as preferred), and the protection controller 110 may modify the designation of the one or more entries based on the update. In some embodiments, the modification of the designation is performed responsive to a change in conditions associated with the entry (e.g., a change from a baseline condition to a heightened condition that warrants re-designation of a preferred entry as a required entry). In some embodiments, the modification of the designation is conditioned upon the source of the update having authority to modify the designation of the entry.

In some embodiments, the protection controller 110 is configured to detect, in association with adding a new configuration entry to the content encryption configuration 130 or modifying an existing configuration entry of the content encryption configuration 130, that the new configuration entry or the modified configuration entry would conflict with one or more existing configuration entries of the content encryption configuration 130. For example, the protection controller 110 may evaluate the new or modified entry against existing entries to determine whether one or more conflict types described herein (e.g., overlapping object classes 107, conflicting keys 104 for a same object class 107, conflicting conditions for a same object class 107, or conflicting encrypt-or-do-not-encrypt settings for a same object class 107) would arise upon addition or modification. Based on detection of a conflict, the protection controller 110 may generate an output associated with the conflict, such as a notification, a prompt to a user of the device 102, an automatic application of a default conflict resolution rule, a deferral of the new or modified entry to a pending state, or a combination thereof.

In some embodiments, the protection controller 110 is configured to prompt a user of the device 102, via a user interface of the device 102, to resolve a conflict detected in association with adding or modifying a configuration entry of the content encryption configuration 130. For example, the prompt may identify the conflicting configuration entries, indicate one or more conflict types (e.g., overlapping object classes 107, conflicting keys 104, conflicting conditions, conflicting encrypt-or-do-not-encrypt settings, or a combination thereof), and present one or more selectable options for resolving the conflict. The selectable options may include accepting the new or modified entry as-is, rejecting the new or modified entry, modifying a priority of one or more of the conflicting entries, designating one of the conflicting entries as required and another of the conflicting entries as preferred, applying a particular conflict resolution rule (e.g., a strict priority rule, a most-restrictive rule, a compound encryption rule, a subsumption rule, or a combination thereof) to the conflicting entries on a one-time basis or as a default rule going forward, or a combination thereof. In some embodiments, the user's selection is stored as part of the content encryption configuration 130, such that the protection controller 110 applies the user's resolution to the conflicting entries during one or more subsequent media generation operations. In some embodiments, the user's ability to resolve the conflict is limited based on tiered authority, such that the user is permitted to resolve conflicts among certain types of entries (e.g., personal entries) and is not permitted to resolve conflicts among other types of entries (e.g., regulation-based entries) without further authorization.

In some embodiments, the protection controller 110 is configured to enforce a tiered authority structure when receiving an update associated with the content encryption configuration 130. For example, the protection controller 110 may identify a source of the update (e.g., a user of the device 102, a contact of the user, a provider, an entity, or a regulation), determine an authority associated with the source, and determine whether the authority is sufficient to perform the requested update on a target entry of the content encryption configuration 130. In some embodiments, an update from a regulation-based source is permitted to add, modify, or remove regulation-based entries and to modify priority or designation fields of one or more entries from any other source, an update from an entity-based source is permitted to add, modify, or remove entity-based entries and to modify priority or designation fields of one or more entries from a personal-based source, and an update from a personal-based source is permitted to add, modify, or remove personal-based entries but is not permitted to modify one or more fields of one or more entries from an entity-based source or a regulation-based source. In some embodiments, the protection controller 110 is configured to reject an update that exceeds the authority of the source associated with the update, and to generate a notification (e.g., to be provided to a user of the device 102 or to a source associated with the update) indicating that the update was rejected. In some embodiments, the protection controller 110 is configured to defer an update that exceeds the authority of the source associated with the update to a pending state, where the deferred update may be subsequently approved by a higher-authority source (e.g., a regulation-based source).

In some embodiments, the status of a configuration entry of the content encryption configuration 130 includes an active status, an inactive status, and a pending status. An entry having a pending status is stored at the memory 106 but is not applied during one or more media generation operations until the pending status is resolved (e.g., by a user input, by an authority-based approval, or by an automatic conflict resolution). In some embodiments, the protection controller 110 is configured to assign the pending status to a new or modified configuration entry based on detection of an unresolved conflict with one or more existing entries, based on a determination that the source of the new or modified configuration entry has insufficient authority to perform the requested operation, or both. In some embodiments, the protection controller 110 is configured to maintain the pending entries by periodically re-evaluating the conflict or authority condition that resulted in the pending status and transitioning the pending entry to the active status or the inactive status based on the re-evaluation.

In some embodiments, the content encryption configuration 130 includes or is associated with audit data that indicates a history of one or more management operations performed on one or more entries of the content encryption configuration 130. The audit data may include, for one or more management operations, an identifier of an entry that was added, modified, or removed, a source associated with the management operation, a timestamp of the management operation, one or more fields of the entry that were modified (e.g., the object class 107, the condition, the key 104, the status, the priority, the designation as required or preferred, or a combination thereof), prior values of the one or more fields, current values of the one or more fields, or a combination thereof. In some embodiments, the audit data is stored at the memory 106 and is accessible to one or more authorized sources (e.g., a regulation-based source, an entity-based source, or a user of the device 102 with sufficient authority). In some embodiments, the audit data is included in the content protection data 164, such that the audit data is associated with the encoded output data 162 to indicate a provenance of the configuration entries that contributed to generation of the encrypted ROI content 148.

In some embodiments, the content encryption configuration 130 includes a group of related configuration entries that share a common origin (e.g., a set of object class 107 / key 104 pairs that originate from a same entity, regulation, or provisioning event). In some embodiments, the related configuration entries inherit a common priority associated with the group, such that an update to a priority of the group propagates to one or more of the related configuration entries. In some embodiments, an individual configuration entry of the group may be assigned an entry-specific priority that overrides the group priority for that individual entry, while the remaining entries of the group continue to inherit the group priority. In some embodiments, the group of related configuration entries shares a common designation (e.g., as required or preferred), and a modification of the group designation propagates to one or more of the related configuration entries.

In some embodiments, removing a configuration entry from the content encryption configuration 130 triggers a re-evaluation of priority and conflict relationships among one or more remaining configuration entries. For example, where a removed entry was a required entry that previously suppressed application of one or more preferred entries, removal of the required entry may cause the protection controller 110 to re-evaluate the one or more preferred entries (e.g., to transition one or more preferred entries from an inactive or suppressed state to an active state). In some embodiments, removal of a configuration entry that was previously identified as a contributor to generation of the encrypted ROI content 148 (e.g., as identified by the content protection data 164) results in generation of a notification associated with the removal, where the notification indicates that subsequent media generation operations will not include encryption based on the removed entry. In some embodiments, removal of a configuration entry of a group of related configuration entries (as described above) is performed individually for one entry of the group or collectively for the group as a whole, based on a scope indicated by the remove request.

In some embodiments, the protection controller 110 is configured to evaluate, in association with receiving an update associated with the content encryption configuration 130, whether the update would result in a duplicate configuration entry within the content encryption configuration 130. For example, where an update would generate a new configuration entry having a same object class 107, a same key 104, and a same condition as an existing configuration entry, the protection controller 110 may determine that the update is a duplicate and may merge the update with the existing configuration entry rather than generating a parallel configuration entry. Merging the update with the existing configuration entry may include updating a source field of the existing configuration entry to include the source associated with the update, updating a priority of the existing configuration entry based on a priority indicated by the update, updating a designation of the existing configuration entry as required or preferred based on a designation indicated by the update, or a combination thereof. In some embodiments, where an update is functionally equivalent to an existing configuration entry but originates from a different source, the protection controller 110 is configured to extend the existing configuration entry's source field to include the additional source, rather than creating a parallel configuration entry.

In some examples, the memory 106 stores other information or data, such as media content. The media content can include or indicate audio content, video content, or a combination thereof. In some examples, the stored media content includes at least an encrypted portion.

The processor 108 includes a protection controller 110, a media generator 120, and an encoder 128. Each of the protection controller 110, the media generator 120, and the encoder 128, or a portion thereof, may be implemented by the processor 108 executing instructions (e.g., software), dedicated hardware (e.g., circuitry), or a combination thereof. It is noted that in some embodiments, two or more of the protection controller 110, the media generator 120, or the encoder 128 may be combined. For example, the media generator 120 may include the protection controller 110, the encoder 128, or both.

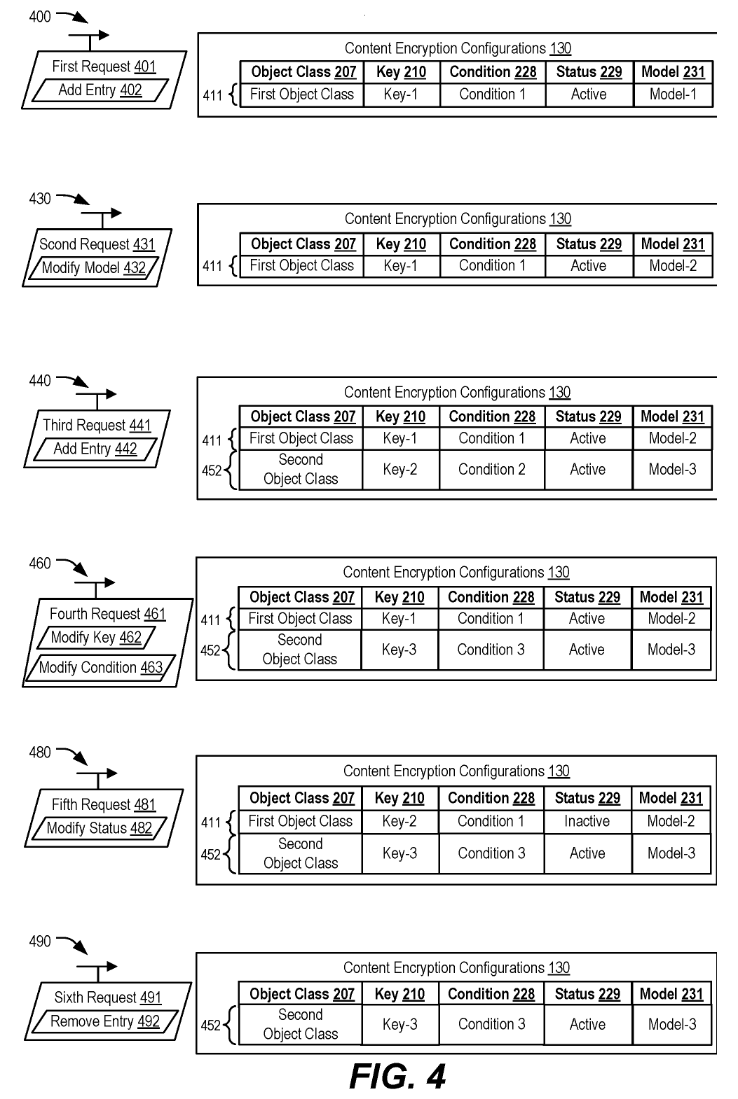

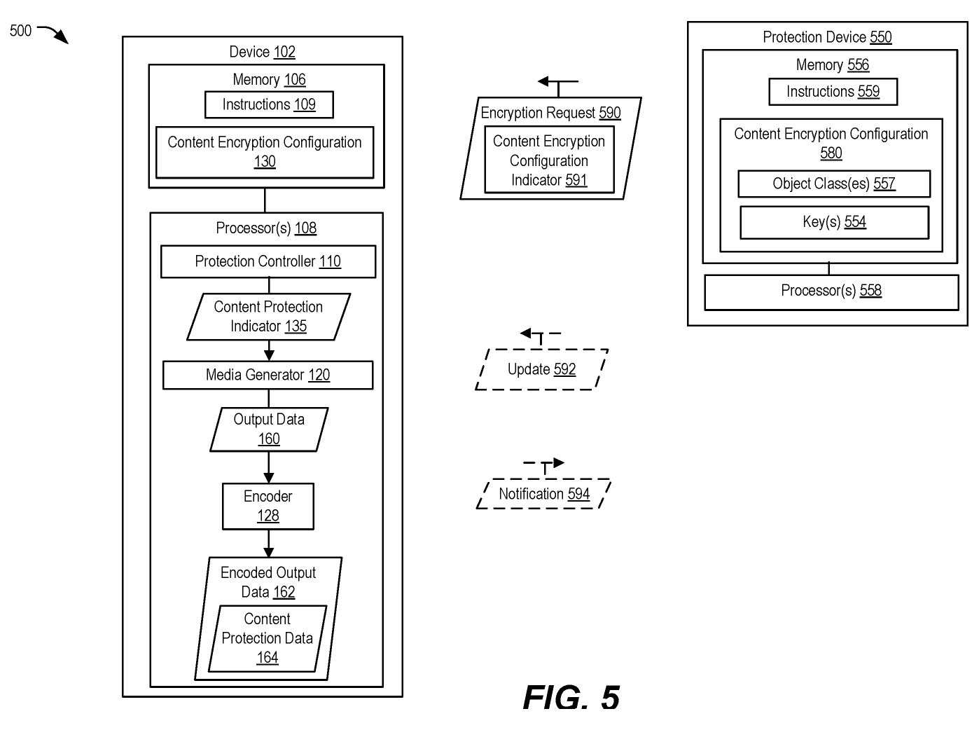

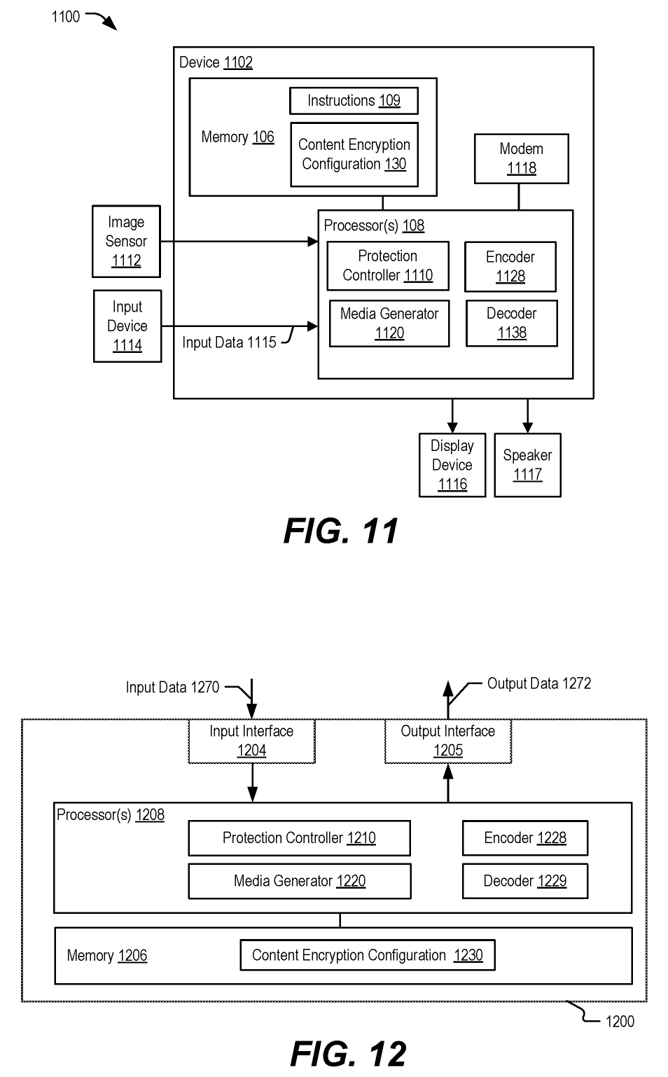

The processor 108 (e.g., the protection controller 110) is configured to manage the content encryption configuration 130. For example, the processor 108 may add, modify, or remove a content encryption configuration, such as the content encryption configuration 130. Examples of operations to manage the content encryption configuration 130 are described further herein at least with reference to FIG. 4. In some embodiments, the processor 108 may receive a request to add a content encryption configuration to the content encryption configuration 130, or an update to modify the content encryption configuration, or a request to remove the content encryption configuration. For example, the request (to add or remove) or the update may be received from another device, as described further herein at least with reference to FIG. 5. As another example, the request (to add or remove) or the update may be received from a user of the device 102, such as via an input device as described further herein at least with reference to FIG. 11.

The protection controller 110 is configured to provide a content protection indicator 135 to the media generator 120 for the media generator 120 to implement an encryption requirement (e.g., the content encryption configuration 130). The content protection indicator 135 may indicate the encryption requirement that includes the object class 107, an encryption key (e.g., the key 137), or a combination thereof, to be applied by the media generator 120 to identify or detect, and encrypt, media content to be protected. In some embodiments, the content protection indicator 135 may indicate a list of object classes 107 and, for each object class, a key associated with an instance of the object class. Additionally, or alternatively, the protection controller 110 is configured to program or configure the encoder 128. In some implementations, the protection controller 110 may generate the content protection indicator 135 based on an input, location data that indicates a location of the device 102, the content encryption configuration 130 or a status (e.g., an active status) thereof, or a combination thereof.

In some embodiments, the protection controller 110 may optionally (as indicated by the dashed lines) obtain contextual data 132. For example, the contextual data 132 (e.g., contextual information) may include or indicate position data associated with the device 102, a wireless network identifier, an environment associated with the input media data, an object included in the input media data, or a combination thereof. In some embodiments, the protection controller 110 obtains the contextual data 132 from a positioning system, map data, a wireless network detector, an object detector (e.g., an ROI identifier 121) configured to detect a conditional object included in the media content, or a combination thereof.

The protection controller 110 may be configured to determine whether the condition is satisfied based on the contextual data 132. In some embodiments, the protection controller 110 is configured to access the content encryption configuration 130 and determine whether the condition is satisfied based on the contextual data 132. Additionally, or alternatively, the protection controller 110 may determine whether a status of the content encryption configuration 130 is inactive or active. The protection controller 110 is configured to generate the content protection indicator 135 based on the condition being satisfied, based on the status of the content encryption configuration 130 being active, or a combination thereof.

In some embodiments, the protection controller 110 is configured to obtain an encryption key, such as the key 137, for the content encryption configuration 130. For example, the protection controller 110 may obtain the key 137 from the memory 106 (e.g., from the content encryption configuration 130). As another example, the protection controller 110 may generate the key 137, such as an encryption key for a respective object class 107. In some such examples, the protection controller 110 may store the key 137 at the memory 106, indicate the key 137 by the content protection indicator 135, or a combination thereof. In some embodiments, the protection controller 110 obtains the key 137 in association with a respective object class 107, and the key 137 is included in the content protection indicator 135 (provided to the media generator 120) and the key 137 is not provided to the memory 106. In such embodiments, the key 137 is not stored as part of the content encryption configuration 130. In some embodiments, the key 137 may be obtained based on the condition being satisfied, based on the status of the content encryption configuration 130 being active, or a combination thereof.

The media generator 120 is configured to identify and encrypt media data based on the content protection indicator 135 – e.g., in accordance with a content encryption configuration 130 indicated by the content protection indicator 135. The media generator 120 includes the ROI identifier 121, an ROI masker 122, an ROI generator 123, an encryptor 124, and an output data generator 127.

The ROI identifier 121 is configured to process media content to detect the object class 107 included in media content, such as an input image frame 142, and identify an ROI associated with the detected object class. In an example, the ROI identifier 121 processes media content to detect when an object having the object class 107 is in the media content; to illustrate, the ROI identifier may include a face detector configured to detect a person’s face – e.g., a “face” object class - in the media content. The ROI may include at least a portion of an image frame, or a time period or frequency of an audio signal. For example, the ROI may include an outline of the detected object class or a region that is larger than the detected object class.

In another example, the object class 107 includes an audio object class, such as a voice of a particular individual, a word or phrase, or a sound. In such an example, the ROI identifier 121 may process audio data of the media content to detect when an instance of the audio object class is in the audio data; to illustrate, the ROI identifier 121 may include a voice detector configured to detect a voice of a particular individual – e.g., a “voice” object class – in the audio data, a keyword detector configured to detect a word or phrase – e.g., a “word” object class or a “phrase” object class – in the audio data, or a sound detector configured to detect a sound – e.g., a “sound” object class – in the audio data. The ROI associated with the detected audio object class may include a time period or a frequency range of the audio data, as illustrative, non-limiting examples. In some embodiments, the ROI identifier 121 is configured to detect both a visual object class within image or video data of the media content and an audio object class within audio data of the media content.

In some embodiments, to detect the object class 107 and/or to identify the ROI, the ROI identifier 121 may use a model (e.g., a neural network model, an AI model, or an ML model), a histogram of gradient methods combined with support vector machine (SVM), a bounding box output, or dense pixel segmentation, as illustrative, non-limiting examples. In some embodiments, the ROI identifier 121 may be configured to generate position data that indicates a position of the ROI and/or a detected object class within the media content. As illustrative, non-limiting examples, the position data may include or indicate a pixel coordinate, multiple pixel coordinates, or a bounding box. Additionally, or alternatively, the ROI identifier 121 may be configured to perform a segmentation operation to generate segmentation data that includes or indicates a portion of the media content, where the portion includes a detected instance of the object class 107. For example, the segmentation operation can be configured to identify, in an image, which pixels belong to an identified object (and which pixels do not belong to the identified object) and to generate segmentation data that includes, for each pixel identified as belonging to the object, an indication that the pixel is part of the object. In a particular embodiment, the segmentation data includes a segmentation frame having pixels of a first value (e.g., 255, or an all-1 value) to indicate pixels in the image that belong to a detected object class 107 and pixels of a second value (e.g., 0, or an all-0 value) to indicate pixels in the image that do not belong to the detected object class 107.

In some embodiments, the ROI identifier 121 is configured to detect a conditional object, such as a conditional object that is indicated by the condition. Based on detection of the conditional object in the media content, the ROI identifier 121 may generate the contextual data 132 that indicates detection of the conditional object.

The ROI masker 122 is configured to mask the ROI (e.g., the portion of the media content) identified by the ROI identifier 121. The ROI masker 122 may mask the ROI using one or more techniques (e.g., a mask type), such as blurring using uniform kernels or gaussian kernels, masking the region a solid color (e.g., black or white), masking the region with a pattern (e.g., stripes), masking the region with an encrypted version of the ROI (e.g., encrypted pixel values that appear to be random noise in the ROI), or a combination thereof. In some embodiments, the ROI masker 122 masks the ROI in the media content to generate a masked version of the media content. In some embodiments, the ROI masker 122 is configured to receive a mask indicator which indicates a mask technique or a mask type to be used by the ROI masker 122. The mask indicator may be received from the protection controller 110. For example, the content protection indicator 135 may include or indicate the mask indicator.

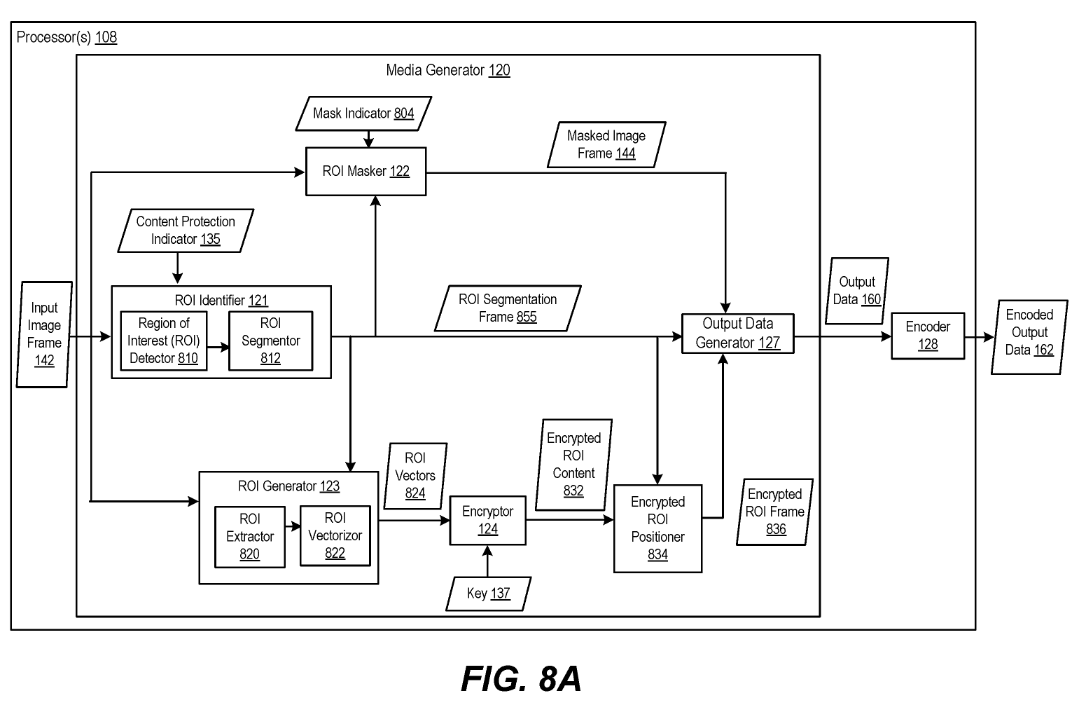

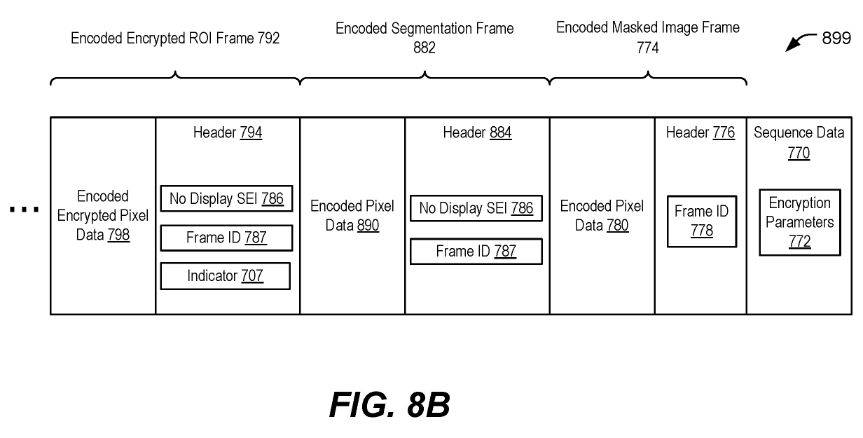

The ROI generator 123 is configured to obtain ROI content 146 included in the ROI (e.g., the portion of the media content) identified by the ROI identifier 121. For example, the ROI generator 123 may copy or extract the ROI content 146 from the media content based on the ROI identified by the ROI identifier 121. One or more operations that may be performed by the ROI generator 123 to obtain the ROI content 146 are described further herein at least with reference to FIG. 8A. In some embodiments, the ROI content 146 includes a vectorized representation (e.g., a one-dimensional array of data (vector)) that is suitable for encryption.

The encryptor 124 is configured to encrypt the ROI content 146 to generate encrypted ROI content 148. For example, the encryptor 124 may encrypt the ROI content 146 based on or using the key 137. In some embodiments, the encryptor 124 uses a format preserving encryption (input and output have the same size) to generate the encrypted ROI content 148 based on the ROI content 146. Illustrative, non-limiting examples of a format preserving encryption include format-preserving, Feistel-based encryption (FFX), such as FF1 or FF3. In some embodiments, one or more encryption parameters, such as a block size or an alphabet, to be used by the encryptor 124 may be obtained from the content encryption configuration 130, the content protection indicator 135, or a combination thereof.

In some embodiments, the encryptor 124 is configured to encrypt the key 137 to generate an encrypted key. For example, the encryptor 124 may encrypt the key 137 using a key (e.g., the key 104), such as a public key of a public-private key pair. The encrypted key may be provided to the output data generator 127, the encoder 128, the protection controller 110, the memory 106, or a combination thereof.

The output data generator 127 is configured to generate output data 160 that includes or is based on the masked image frame 144, the encrypted ROI content 148, or a combination thereof. In some implementations, the output data 160 includes the masked image frame 144 and not the encrypted ROI content 148. In other implementations, the output data 160 includes the encrypted ROI content 148 and not the masked image frame 144. In some embodiments the output data generator 127 is configured to combine the masked image frame 144, the encrypted ROI content 148, position data or segmentation data associated with a position of the portion of the media content that corresponds to the ROI, one or more encoder parameters, or a combination thereof, to generate the output data 160. In some embodiments, to generate the output data 160, the output data generator 127 is configured to concatenate the masked image frame 144, the encrypted ROI content 148, position data or segmentation data associated with a position of the portion of the media content that corresponds to the ROI, one or more encoder parameters, or a combination thereof. It is noted that when the media content includes video content, masked image frames (e.g., the masked image frame 144) and encrypted ROI content (e.g., the encrypted ROI content 148) may be temporally concatenated and provided to the encoder 128 for processing and/or compression.

The encoder 128 is configured to receive the output data 160 and generate encoded output data 162. In some embodiments, the encoder 128 may encode the output data 160 based on the content protection indicator 135, one or more encoder parameters received from the protection controller 110 and/or the media generator 120, or a combination thereof. In a particular embodiment, the encoder 128 uses a higher-compression, lossy encoding to encode the masked image frame 144 in the output data 160 and uses a lower-compression, lossless encoding technique to encode the encrypted ROI content 148 in the output data 160.

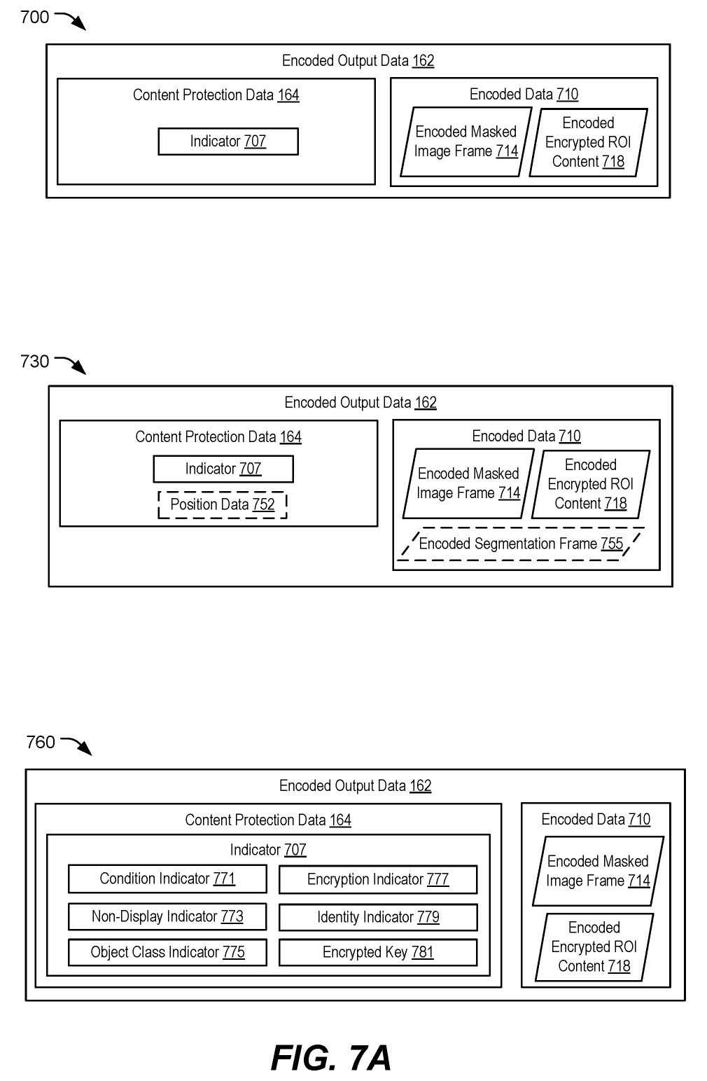

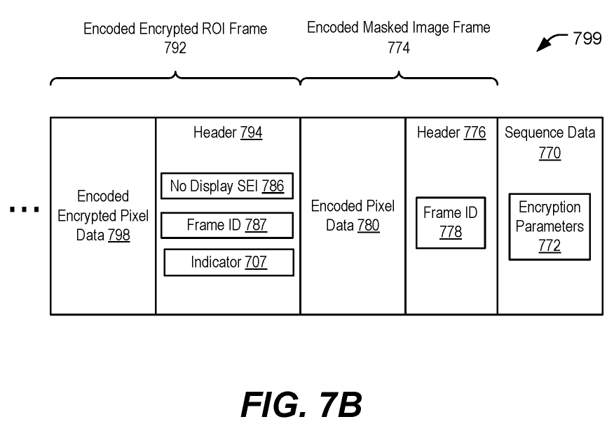

In some embodiments, the encoded output data 162 includes encoded data that includes or corresponds to the masked image frame 144, the encrypted ROI content 148, the output data 160, or a combination thereof. Examples of the encoded data are described further herein at least with reference to FIG. 7A.

In a particular embodiment, the encoded output data 162 includes content protection data 164. In some embodiments, the content protection data 164 may include one or more indicators, the key 137, an encrypted version of the key 137, or a combination thereof. Examples of the one or more indicators are described further herein at least with reference to FIG. 7A. In an illustrative example, the one or more indicators may include an encryption indicator that indicates that the encoded output data 162 includes or indicates the encrypted ROI content 148 (e.g., encrypted media data). For example, the encryption indicator may include or correspond to a flag that indicates the presence of encrypted data in the encoded output data 162. Additionally, or alternatively, the encryption indicator may indicate one or more encryption parameters. The one or more encryption parameters may include or indicate an encryption type, a maximum block size, an alphabet size, one or more formatting details, a number of object classes, or a combination thereof. In some embodiments, the one or more indicators include an identity indicator, a non-display indicator, position data, an object class indicator, or a combination thereof.

In some embodiments, the encoded output data 162 includes a bitstream. The bitstream may be compliant with a standard, such as H.264/MPEG-4 AVC (Advanced Video Coding), H.265/HEVC (High Efficiency Video Coding), MPEG-2, MPEG-1, VC-1 (Windows Media Video). Additionally, or alternatively, the bitstream may include other information. The other information may include or indicate extra information, such as a header, metadata, segmentation data (e.g., a segmentation frame), the encrypted ROI content 148, the masked image frame 144, the key 137, an encrypted version of the key 137 (e.g., encrypted based on the public key), or a combination thereof. Examples of a bitstream are described further herein at least with reference to FIGS. 7B and 8B.

In some embodiments, the encoded output data 162 is included in or corresponds to a bitstream, such as the bitstream 799 described further herein with reference to FIG. 7B or the bitstream 899 described further herein with reference to FIG. 8B. In other embodiments, the encoded output data 162 is included in or corresponds to a media container, such as an MPEG-4 (MP4) container, an Audio Video Interleave (AVI) container, an MPEG transport stream container, or another multimedia container format. The media container may be configured to encapsulate components of the encoded output data 162, such as one or more encoded masked image frames (e.g., the encoded masked image frame 714 described further herein with reference to FIG. 7A), encrypted data such as one or more encoded encrypted ROI frames (e.g., the encoded encrypted ROI content 718 described further herein with reference to FIG. 7A), the content protection data 164, segmentation data such as one or more encoded segmentation frames (e.g., the encoded segmentation frame 755 described further herein with reference to FIG. 7A), or a combination thereof.

In an illustrative example, the media container includes multiple tracks (or, in some container formats, multiple streams), such that a first track of the media container includes the encoded masked image frame 714 and a second track of the media container includes the encoded encrypted ROI content 718. Additionally, or alternatively, the content protection data 164, the segmentation data, or both, may be included in a metadata field of the media container, a supplemental track of the media container, an embedded data field of the media container, or a combination thereof. In some embodiments, the media container provides an alternative to including the encrypted ROI content 148, the segmentation data, or the content protection data 164 within a codec-level bitstream (e.g., the bitstream 799 of FIG. 7B or the bitstream 899 of FIG. 8B), such that the data associated with encryption and content protection is carried at a container level rather than within codec-compliant frame headers or sequence data. In some embodiments in which the encoded output data 162 includes the media container, the output data generator 127, the encoder 128, or both, are configured to operate at a container level to organize the masked image frame 144, the encrypted ROI content 148, the segmentation data, and the content protection data 164 as distinct data elements (e.g., tracks, metadata entries, or embedded data fields) within the media container. Use of the media container can support file-based storage and offline playback workflows in addition to streaming, by encapsulating the encoded components in a single container file that can be stored, transferred, or accessed at a later time.

In a particular embodiment, the content protection data 164 is included in a header of the encoded output data 162, metadata of the encoded output data 162, or a combination thereof. The segmentation data may include or correspond to a segmentation frame that is encoded by the encoder 128 as a no display frame (e.g., using a no display supplemental enhancement information (SEI) message). The encrypted ROI content 148 may be encoded by the encoder 128 as a no display frame (e.g., using a no display SEI message). The one or more indicators may include an encryption indicator that indicates that the encrypted ROI content 148 is included in the bitstream, an encryption standard used by the encryptor 124, or both.

During operation of the system 100, the device 102 obtains the content encryption configuration 130. For example, the device 102 may receive the content encryption configuration 130, or an indicator thereof, from another device. As another example, the device 102 may receive an input, such as an input from a user of the device 102, that indicates the content encryption configuration 130 or a portion thereof. To illustrate, the input may indicate the object class 107, the key 104, or both, and the processor 108 (e.g., the protection controller 110) may generate and store the content encryption configuration 130 based on the input. The device 102 may maintain the content encryption configuration 130 at the memory 106. For example, to maintain the content encryption configuration 130, the processor 108 (e.g., the protection controller 110) may perform one or more operations to add another content encryption configuration to the memory 106, modify the content encryption configuration 130 stored at the memory 106, or remove the content encryption configuration 130 from the memory 106.

In some embodiments, the device 102 (e.g., the processor 108) receives a request to capture media content. Based on the request to capture the media content, the processor 108 receives media content, such as the image data 140. Additionally, or alternatively, the media content may include audio data. The media content, such as image data, audio data, or a combination thereof, may be received from a source device (e.g., a microphone or a camera) or from the memory 106. The image data 140 may include an image frame, such as the input image frame 142. In some embodiments, the image data 140 includes video data, such as a series of image frames including the input image frame 142. The processor 108 provides the input image frame 142 to the media generator 120 (e.g., the ROI identifier 121).

The processor 108 (e.g., the protection controller 110) may, based on the request to capture the media content, generate the content protection indicator 135 that indicates to detect an instance of the object class 107 included in the image data 140 and to encrypt at least a portion of the image data 140 that includes the instance of the object class 107. For example, the protection controller 110 may generate the content protection indicator based on the content encryption configuration 130. The protection controller 110 provides the content protection indicator 135 to the media generator 120. In some embodiments, the protection controller 110 obtains the contextual data 132 and determines whether a condition associated with the content encryption configuration 130 is satisfied and, based on the condition being satisfied, generates the content protection indicator 135.

The ROI identifier 121 is configured to detect an instance of the object class 107 included in the input image frame 142 and identify an ROI associated with the detected instance of the object class 107 – e.g., a portion of the input image frame 142 that includes the detected instance of the object class 107. For example, the ROI identifier 121 may detect the instance of the object class 107 based on the content protection indicator 135 indicating to detect the object class 107 in the image data 140 (e.g., in the input image frame 142). Based on the ROI, the ROI masker 122 masks the ROI (e.g., the portion of the input image frame 142) to generate the masked image frame 144. Additionally, based on the ROI, the ROI generator 123 generates the ROI content 146, which is encrypted by the encryptor 124 to generate the encrypted ROI content 148.

The output data generator 127 generates the output data 160 based on the masked image frame 144, the encrypted ROI content 148, or a combination thereof. For example, the output data generator 127 may combine the masked image frame 144 and the encrypted ROI content 148 to generate the output data 160. In some such examples, the output data generator 127 may concatenate the masked image frame 144 and the encrypted ROI content 148, or may modify the masked image frame 144 such that a masked portion of the masked image frame 144 includes the encrypted ROI content 148. Although the media generator 120 is described as including the output data generator 127, in other implementations, the media generator 120 may not include the output data generator 127 and the masked image frame 144 and the encrypted ROI content 148 may be provided to the encoder 128. In some embodiments, the output data 160 may be provided to and stored at the memory 106.

The encoder 128 generates output media data (e.g., the encoded output data 162) that includes or indicates the masked image frame 144, the encrypted ROI content 148, or a combination thereof. In some embodiments, the encoded output data 162 includes the content protection data 164 that includes one or more indicators. Additionally, or alternatively, the encoded output data 162 (e.g., the content protection data 164) includes a non-display indicator associated with the encrypted media data.

The processor 108 may provide the encoded output data 162 to the memory 106 for storage. Additionally, or alternatively, the processor 108 may send the encoded output data 162 to a decode device of the device 102 or to another device (e.g., a remote device) that includes a decoder.

In some embodiments, the media generator 120 (e.g., the ROI identifier 121) is configured to generate, based on the input image frame 142 and detection of an instance of the object class 107 in the input image frame 142, segmentation data. Generation of the segmentation data (e.g., a segmentation frame) is described further herein at least with reference to FIG. 8A.

In some embodiments, a device (e.g., the device 102) includes a memory (e.g., the memory 106) and one or more processors (e.g., the processor 108). The memory is configured to store one or more content encryption configuration entries (e.g., the content encryption configuration 130). A first content encryption configuration entry of the one or more content encryption configuration entries is associated with a first content encryption configuration and indicates a first object class (e.g., the object class 107) and a first key (e.g., the key 104). The one or more processors are configured to maintain the one or more content encryption configuration entries at the memory. To maintain the first content encryption configuration entry, the one or more processors are further configured to receive an update associated with the first content encryption configuration, and modify, based on the update, the first content encryption configuration entry to generate an updated first content encryption configuration entry.

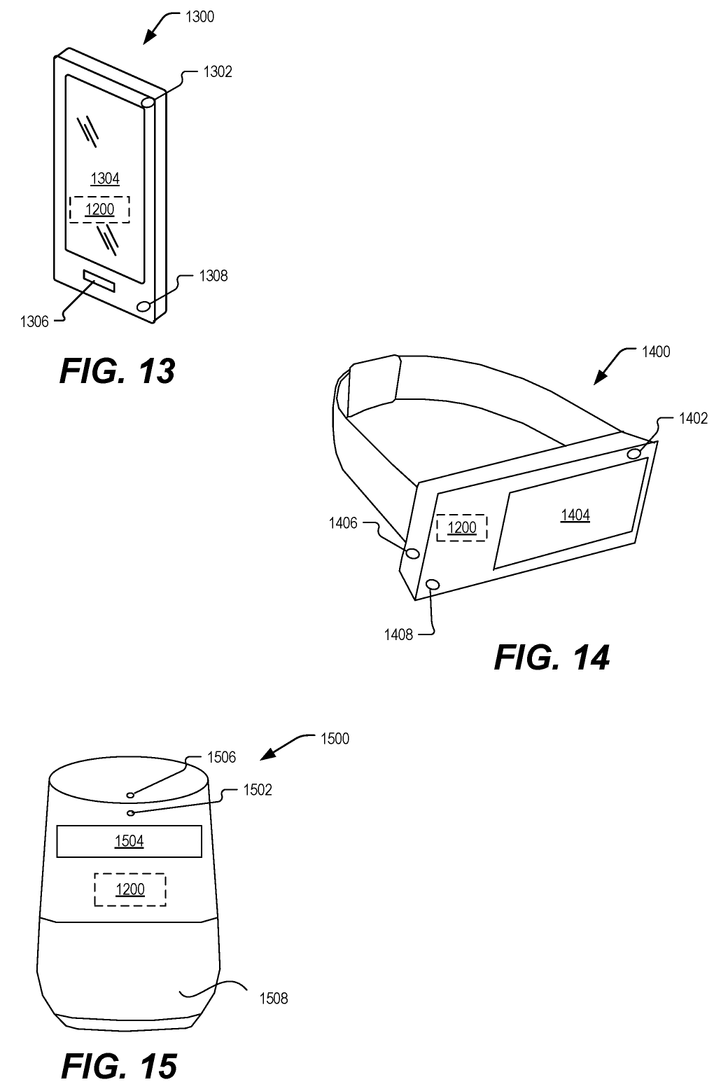

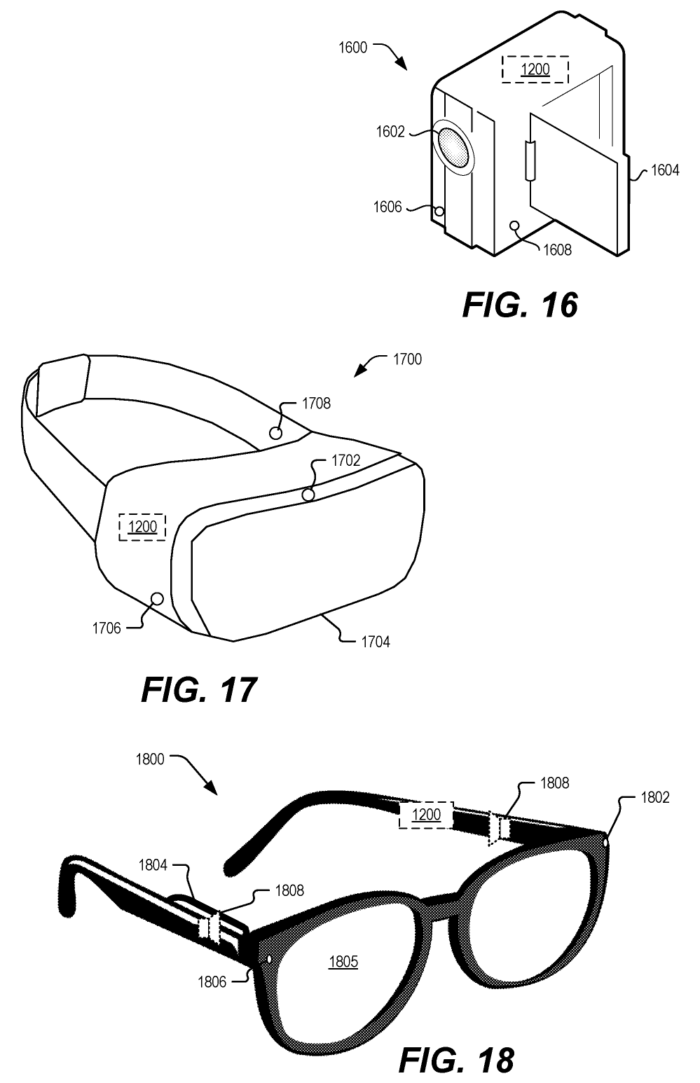

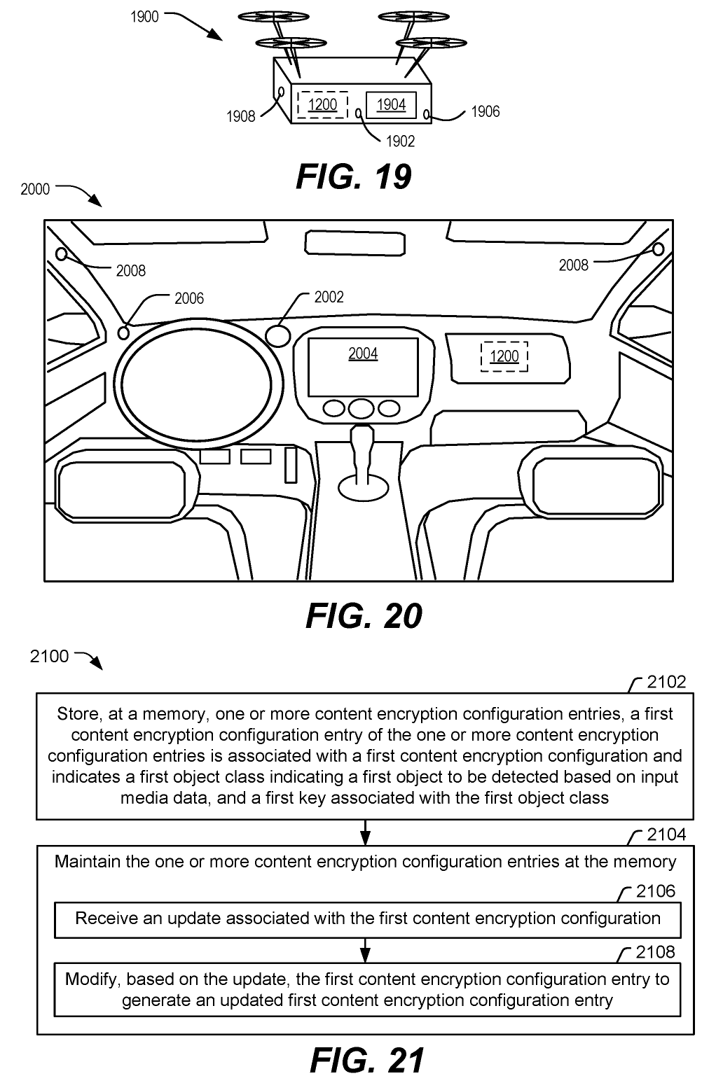

In some examples, the device 102 corresponds to or is included in one of various types of devices, such that the processor 108 can be integrated in multiple types of devices. In an illustrative example, the processor 108 is integrated in a wearable electronic device as depicted in FIG. 14, a virtual reality, mixed reality, or augmented reality headset as depicted in FIG. 17, a mixed reality or augmented reality glasses device as described with reference to FIG. 18, or another wearable device. In another illustrative example, the processor 108 is integrated in a mobile device (a mobile phone or a tablet computer device) as depicted in FIG. 13, a voice-controlled speaker system as depicted in FIG. 15, a camera as depicted in FIG. 16, a vehicle as depicted in FIGS. 19 or 20, a computer (e.g., a laptop computer) or a server, or another system or device.

As described with reference to FIG. 1, the present disclosure provides techniques for managing one or more content encryption configurations that can be used to identify and encrypt media content. For example, one technical advantage of implementing the device 102 as described above is that privacy control and content management is provided through management of the one or more content encryption configurations, such as the content encryption configuration 130, and/or by identification of the ROI (associated with an instance of the object class 107) of the input image frame 142, and encryption of at least the portion the input image frame 142 based on the ROI. To further illustrate the technical advantage, sensitive, private, or confidential content to be protected in the input image frame 142 is masked based on the ROI to generate the masked image frame 144, which can be displayed by one or more device or users that do not have authorization or access to the sensitive content (e.g., the encrypted ROI content). A user or a device that has access to a decryption key can decrypt the encrypted portion and thereby recover the sensitive content and combine the recovered sensitive content with the masked content to generate (e.g., recreate) the original content. In some embodiments, the operations described with reference to the system 100 may be applied to provide automatic sensitive content (partial video) encryption while the video is captured for the first time. The partial video encryption can allow for both authorized and non-authorized access of encrypted content using the same encoded output data 162 (e.g., the same encrypted bitstream).

FIGS. 2A-2E are diagrams of examples of content encryption configurations 130 associated with the system of FIG. 1, in accordance with one or more aspects of the present disclosure. For example, FIG. 2A is a first example 200, FIG. 2B is a second example 220, FIG. 2C is a third example 240, FIG. 2D is a fourth example 260, and FIG. 2E is a fifth example 280. The content encryption configurations 130 of FIGS. 2A-2E may include a data structure, such as a table, that is stored at the memory 106. Although the data structure is described as having a format of a table (having columns and rows), in other embodiments, the data structure can be a different format other than a table.

The content encryption configurations 130 of FIGS. 2A-2E each includes one or more entries. For example, each of the examples of FIGS. 2A-2E includes a first entry 221, each of the examples of FIGS. 2C-2E also includes a second entry 242, each of the examples of FIGS. 2D and 2E also includes a third entry 263, and the fifth example 280 of FIG. 2E also includes a fourth entry 284 and a fifth entry 285. Each entry of the examples of FIGS. 2A-2E may include one or more fields, where each field corresponds to a different heading of the respective entry. It is noted that each of the examples of FIGS. 2A-2E may have a single entry or multiple entries. In some embodiments, one of the entries of the FIGS. 2A-2E includes or corresponds to a first content encryption configuration and another entry may include or correspond to a second content encryption configuration.

Additionally, the content encryption configurations 130 of FIGS. 2A-2E each includes one or more headings. For example, each of the examples of FIGS. 2A-2E includes the headings of an object class 207 and a key 210. However, it is noted that in other examples, at least one entry (e.g., content encryption configuration 130) may not have the heading of the key 210. Additionally, or alternatively, in other examples, at least one entry may be associated with a first set of headings and at least one other entry may be associated with a second set of headings that is different from the first set of headings.

The second example 220 of FIG. 2B and the fifth example 280 of FIG. 2E also include the headings of a condition 228, a status 229, a source 230, and a model 231. The third example 240 of FIG. 2C includes the headings of the object class 207, the key 210, and the condition 228. The fourth example 260 of FIG. 2D includes the headings of the object class 207, the key 210, and the status 229. The object class 207 and the key 210 may include or correspond to the object class 107 and the key 104, respectively. The key 210 of an entry (e.g., a respective content encryption configuration) may include or correspond to a key, such as a public key (of a public-private key pair), a private key (of the public-private key pair), an encryption key (e.g., the key 137), or a combination thereof. The condition 228 of an entry may indicate a circumstance or a criterion to be satisfied to encrypt an instance of a respective object class 207. The status 229 may indicate whether or not an entry is active or inactive. In some examples, the status 229 may also indicate a time period or duration during which the entry is configured to be active (or inactive). Additionally, or alternatively, the status 229 may include or indicate a timestamp of when a value of the status was determined or changed. In some embodiments, the status 229 of an entry may indicate whether or not the respective condition 228 of the entry is satisfied or unsatisfied – e.g., satisfied based on contextual data associated with an input image frame. The source 230 of an entry may indicate a user, an entity, or a device that generated or requested the entry. In some embodiments, the source 230 may include or indicate contact information, such as an email address, an Internet protocol (IP) address, an application programming interface (API), phone number, or other contact information associated with the entry. The model 231 of an entry may indicate or be used to detect a respective object class 207. Additionally, or alternatively, the model 231 may include or indicate one or more encryption parameters associated with a respective object class – e.g., to be used to encrypt a respective object class.

It is noted that the headings of the examples of FIGS. 2A-2E are not intended to be limiting and that each of the examples may include headings as described with a different example than the examples of FIGS. 2A-2E. Additionally, or alternatively, one or more of the examples of FIGS. 2A-2E may include one or more different headings than described with reference to FIGS. 2A-2E, such as a heading that indicates a priority of a respective entry, a designation of a respective entry as required or preferred, a pending status of a respective entry, or a combination thereof.

Referring to the first example 200 of FIG. 2A, the first entry 221 includes a first object class for a field associated with the object class 207, and a first key (Key-1) for a field associated with the key 210. Referring to the second example 220 of FIG. 2B, as compared to the first example 200 of FIG. 2A, the second example 220 includes the additional headings of the condition 228, the status 229, the source 230, and the model 231. Accordingly, the first entry 221 includes the first object class for the field associated with the object class 207, the first key for the field associated with the key 210, a first condition (Condition 1) for a field associated with the condition 228, a first status (of Active or Inactive) for a field associated with the status 229, a first source (Source-1) for the source 230, and a first model (Model-1) for a field associated with the model 231.

Referring to the third example 240 of FIG. 2C, the third example 240 includes the first entry 221 and the second entry 242. The third example 240 includes the headings of the object class 207, the key 210, and the condition 228. The first entry 221 of FIG. 2C includes the first object class for the field associated with the object class 207, the first key (Key-1) for the field associated with the key 210, and a first condition (Condition 1) for the field associated with the condition 228. The second entry 242 of FIG. 2C includes a second object class for a field associated with the object class 207, a second key (Key-2) for a field associated with the key 210, and a second condition (Condition 2) for a field associated with the condition 228. The second object class (of the second entry 242) may be the same object class or a different object class as the first object class (of the first entry 221). The second condition (Condition 2 of the second entry 242) may be the same condition or a different condition as the first condition (Condition 1 of the first entry 221).

Referring to the fourth example 260 of FIG. 2D, the fourth example 260 includes the first entry 221, the second entry 242, and the third entry 263. The fourth example 260 includes the headings of the object class 207, the key 210, and the status 229. The first entry 221 of FIG. 2D includes the first object class for the field associated with the object class 207, the first key (Key-1) for the field associated with the key 210, and Active for the field associated with the status 229. The second entry 242 of FIG. 2D includes the second object class for the field associated with the object class 207, the first key (Key-1) for the field associated with the key 210, and Inactive for a field associated with the status 229. The third entry 263 of FIG. 2D includes a third object class for a field associated with the object class 207, the second key (Key-2) for a field associated with the key 210, and Active for a field associated with the status 229. The third object class (of the third entry 263) may be the object class or a different object class as the first object class and/or the second object class.

Referring to the fifth example 280 of FIG. 2E, the fifth example 280 includes the first entry 221, the second entry 242, the third entry 263, the fourth entry 284, and the fifth entry 285, and the headings of the object class 207, the key 210, the condition 228, the status 229, the source 230, and the model 231. The first entry 221 includes the first object class for the field associated with the object class 207, a first user key (User Key-1) for the field associated with the key 210, no conditions for the field associated with the condition 228, Active for the field associated with the status 229, an original equipment manufacturer (OEM) (Regulation) for the field associated with the source 230, and a first model (Model-1) for the field associated with the model 231. The first key (User Key-1) may be a key that is associated with a device (e.g., the device 102) or a user of the device. The source 230 being the OEM (Regulation) may indicate that values for the fields associated with the object class 207, the condition 228, or a combination thereof, of the first entry 221 are dictated by a law, regulation, or statute. In some embodiments, the first entry may be generated or requested by a manufacturer or service provider associated with the device.

The second entry 242 includes the second object class for the field associated with the object class 207, the first user key (User Key-1) for the field associated with the key 210, no conditions for the field associated with the condition 228, Active for the field associated with the status 229, a User for a field associated with the source 230, and a second model (Model-2) for a field associated with the model 231. The User for the field associated with the source 230 may indicate that the second entry 242 was generated by a device (e.g., the device 102) or a user of the device.

The third entry 263 includes the third object class for the field associated with the object class 207, a user contact key (User Contact Key) for the field associated with the key 210, no conditions for a field associated with the condition 228, Active for the field associated with the status 229, a User Contact for a field associated with the source 230, and a third model (Model-3) for a field associated with the model 231. The User Contact for the field associated with the source 230 may indicate that the third entry 263 was generated or requested by a contact of the user of the device (e.g., the device 102) and received by the device. The User Contact Key for the field associated with the key 210 may include a key, such as an encryption key or a public key, that is provided or generated by the contact.

The fourth entry 284 includes a fourth object class for a field associated with the object class 207, a company key (Company Key) for a field associated with the key 210, the first condition (Condition 1) for a field associated with the condition 228, Active for a field associated with the status 229, a Company for a field associated with the source 230, and a fourth model (Model-4) for a field associated with the model 231. The Company for the field associated with the source 230 may indicate that the fourth entry 284 was generated or requested by an entity, such as a company, an agent of the company, an organization, etc. The Company Key for the field associated with the key 210 may include a key, such as an encryption key or a public key, that is provided or generated by the entity.

The fifth entry 285 includes a fifth object class for a field associated with the object class 207, a second user key (User Key-2) for a field associated with the key 210, no conditions for a field associated with the condition 228, Inactive for a field associated with the status 229, the User for a field associated with the source 230, and a fifth model (Model-5) for a field associated with the model 231. The second key (User Key-2) may be a key that is associated with a device (e.g., the device 102) or a user of the device. The second user key (User Key-2) may be a different key than the first user key (User Key-1) of the first entry 221 and the second entry 242.

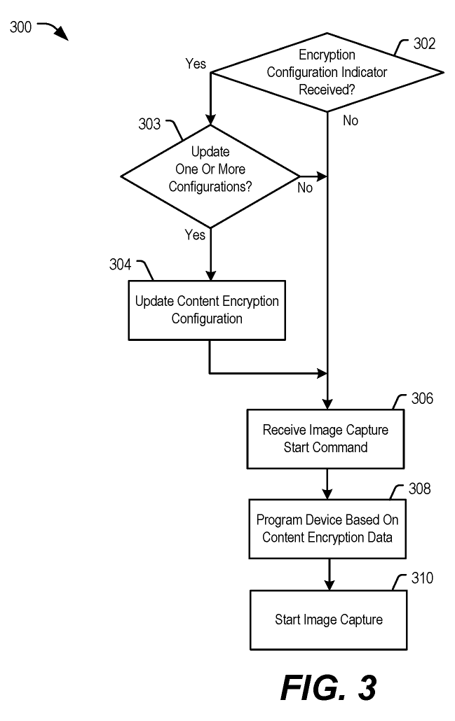

FIG. 3 is a diagram of an example of a method 300 for management of one or more content encryption configurations, in accordance with some aspects of the present disclosure. In a particular aspect, one or more operations of the method 300 are performed by the system 100, the device 102, the processor 108, the protection controller 110, the media generator 120, the encoder 128, or a combination thereof. The one or more content encryption configurations may include or correspond to the content encryption configuration 130, or one of the entries 221, 242, 263, 284, or 285.

In some embodiments, the method 300 includes, at block 302, determining whether an encryption configuration indicator is received. For example, the encryption configuration indicator may include or correspond to a user input or an encryption request that indicates a content encryption configuration. To illustrate, the encryption configuration indicator may be received from a user of the device 102 or from a protection device (as described further herein at least with reference to FIG. 5). Based on a determination that the encryption configuration indicator is not detected, the method 300 advances to block 306. Alternatively, based on a determination that the encryption configuration indicator is detected, the method 300 advances to block 303.

At block 303, the method 300 includes determining whether to update one or more configurations – e.g., one or more content encryption configurations. For example, to determine whether to update the one or more configurations, the method 300 may determine whether the encryption configuration indicator indicators to add, remove, or modify a content encryption configuration. Additionally, or alternatively, to determine whether to update the one or more configurations, the method 300 may determine whether or not the encryption configuration indicator is applicable based on one or more stored content encryption configurations. For example, if the encryption configuration indicator indicates to add a content encryption configuration that is already stored, the encryption configuration indicator may be determined to not be applicable. Based on a determination to not update the one or more configurations based on the encryption configuration indicator, the method 300 advances to block 306. Alternatively, based on a determination to update the one or more configurations based on the encryption configuration indicator, the method 300 advances to block 304.

At block 304, the method 300 includes updating the one or more content encryption configurations. For example, updating the one or more content encryption configurations may include adding, modifying, or removing a content encryption configuration in association with the one or more content encryption configurations.

At block 306, the method 300 includes receiving an image capture start command. For example, the input capture start command may be received via an input device.

At block 308, the method 300 includes programming a device based on content encryption data (e.g., one or more stored content encryption configurations). For example, the device may include or correspond to the device 102, the processor 108, the media generator 120, the encoder 128, or a combination thereof. In some embodiments, the device may be programmed by the processor 108 or the protection controller 110. For example, to program the device, the protection controller 110 may generate the content protection indicator 135.

In some embodiments, the device may be programmed based on one or more stored content encryption configurations having a status that is active. For example, the method 300 may include determining whether a particular content encryption configuration of the one or more content encryption configurations is active or inactive.

At block 310, the method 300 includes starting an image capture operation. In some embodiments, the processor 108 or the media generator 120 may start or initiate the image capture operation. The image capture operation may be performed by a camera. The image capture operation may be performed in accordance with content encryption data – e.g., a content encryption configuration.

In some embodiments, at least one content encryption configuration used to program the device includes a condition, such as the condition 228. In some such embodiments, the method 300 may include determining whether the condition is present – e.g., whether or not the condition is satisfied. A determination of whether or not the condition is present may be based on contextual data, such as the contextual data 132. If the condition is present for the at least one content encryption configuration, the image capture operation may be performed using the at least one content encryption configuration.

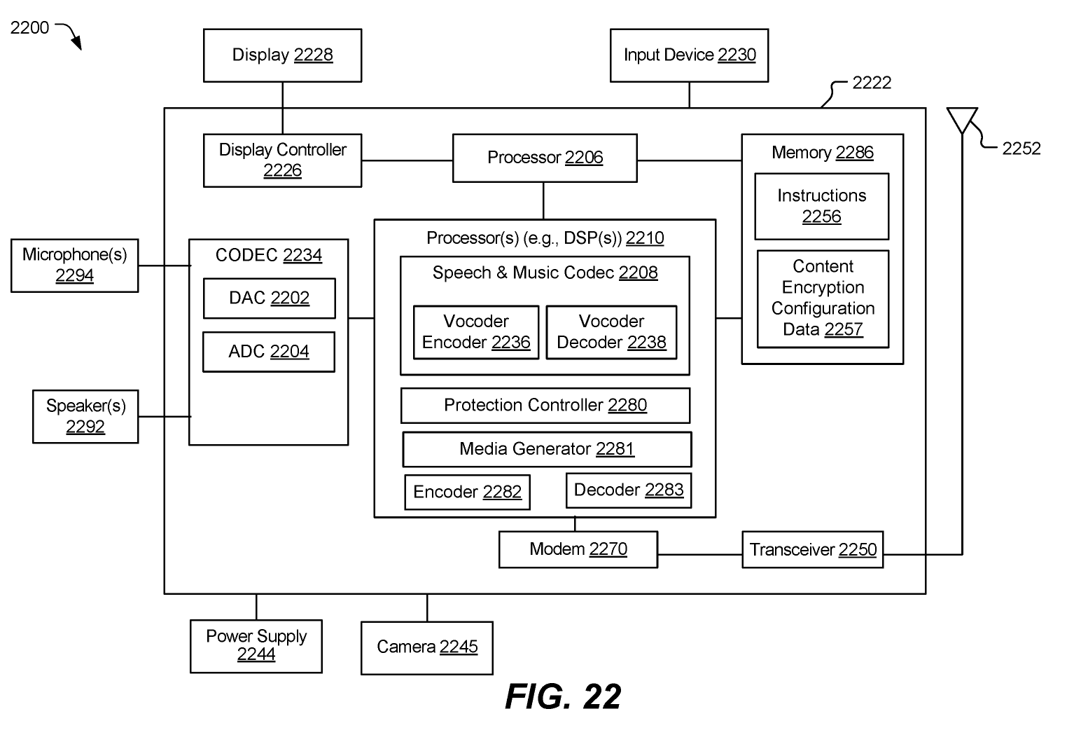

The method 300 may be implemented by a field-programmable gate array (FPGA) device, an application-specific integrated circuit (ASIC), a processing unit such as a central processing unit (CPU), a DSP, a controller, another hardware device, firmware device, or any combination thereof. As an example, the method 300 may be performed by a processor that executes instructions, such as described with reference to FIG. 22.

FIG. 4 is a diagram of an example of management of one or more content encryption configurations, in accordance with some aspects of the present disclosure. Operations described with reference to FIG. 4 may be performed by a device or system, such as the system 100, the device 102, the memory 106, the processor 108, the protection controller 110, the media generator 120, or a combination thereof. The one or more content encryption configurations may include or correspond to the content encryption configuration 130 or one of the entries 221, 242, 263, 284, or 285.

The device may be configured to store and maintain the content encryption configurations 130. For example, the device may store one or more content encryption configuration entries. In some embodiments, each content encryption configuration entry constitutes or defines a different content encryption configuration. The one or more content encryption entries may include or correspond to the entries 221, 242, 263, 284, or 285. Each content encryption configuration entry described with reference to FIG. 4 may include one or more fields, where each field corresponds to a different heading of the respective entry. In FIG. 4, the content encryption configurations 130 include the headings of the object class 207, the key 210, the condition 228, the status 229, and the model 231.

Additionally, the device may obtain one or more requests, such as one or more content encryption configuration requests. For example, the device may receive the one or more requests from a user of the device or from another device, such as a protection device (as described with reference to FIG. 5). The one or more requests may indicate to add, modify, or remove a content encryption configuration entry – e.g., a content encryption configuration.

Maintaining the one or more content encryption configuration entries enables continuity of a semantic-cryptographic mapping between object classes (e.g., categories of objects to be detected within media data) and associated keys, conditions, models, or sources, as such semantic-cryptographic mapping may change over time. For example, an update to a content encryption configuration entry may reflect a change in an object detection model (e.g., the model 231) used to detect instances of the object class (e.g., the object class 207) within the media data, a change in an object class (e.g., the object class 207) identified as being associated with sensitive, private, or confidential content to be protected (such as a change in a regulatory class of object to be protected), a change in an encryption condition (e.g., the condition 228) under which instances of the object class are to be encrypted, a change in a status (e.g., the status 229) of the content encryption configuration entry, a change in a source of the content encryption configuration entry, a change in an authorized entity associated with decryption of encrypted media data (e.g., by a change in the key 210), or a combination thereof. In this manner, the one or more content encryption configuration entries may be maintained such that the semantic-cryptographic mapping continues to correspond to currently-applicable object classes, detection models, encryption conditions, or authorized entities as such change over time.

At 400, the device obtains a first request 401 that includes an add entry request 402. For example, the add entry request 402 may request to add a first content encryption configuration entry 411 to the content encryption configurations 130. Accordingly, the device may add the first entry 411 that includes a first object class for a field association with the object class 207, a first key (Key-1) for a field association with the key 210, a first condition (Condition 1) for a field association with the condition 228, Active for a field association with the status 229, and a first model (Model-1) for a field association with the model 231.

At 430, the device obtains a second request 431 that includes a modify model request 432 associated with the first content encryption configuration entry 411. For example, the modify model request 432 may request to update the field association with the model 231 of the first entry 411 to a second model (Model-2). Accordingly, based on the second request 431, the device updates the first content encryption configuration entry 411 to include the second model (Model-2) for the field association with the model 231.

At 440, the device obtains a third request 441 that includes an add entry request 442. For example, the add entry request 442 may request to add a second content encryption configuration entry 452 to the content encryption configurations 130. Accordingly, the device may add the second entry 452 that includes a second object class for a field association with the object class 207, a second key (Key-2) for a field association with the key 210, a second condition (Condition 2) for a field association with the condition 228, Active for a field association with the status 229, and a third model (Model-3) for a field association with the model 231.

At 460, the device obtains a fourth request 461 that includes a modify key request 462 and a modify condition request 463 associated with the second content encryption configuration entry 452. For example, the modify key request 462 may request to update the field association with the key 210 of the second entry 452 to a third key (Key-3), and the modify condition request 463 may request to update the field association with the condition 228 to a third condition (Condition 3). Accordingly, based on the fourth request 461, the device updates the second content encryption configuration entry 452 to include the third key (Key-3) for the field association with the key 210 and the third condition (Condition 3) for the field association with the condition 228.

At 480, the device obtains a fifth request 481 that includes a modify status request 482 associated with the first content encryption configuration entry 411. For example, the modify status request 482 may request to update the field association with the status 229 of the first content encryption configuration entry 411 to Inactive. Accordingly, based on the fifth request 481, the device updates the first content encryption configuration entry 411 to include Inactive for the field association with the status 229.

At 490, the device obtains a sixth request 491 that includes a remove entry request 492 associated with the first content encryption configuration entry 411. For example, the remove entry request 492 may request to remove the first content encryption configuration entry 411 from the content encryption configurations 130. Accordingly, based on the sixth request 491, the device removes the first content encryption configuration entry 411 from the content encryption configurations 130.

FIG. 5 is a block diagram of an example of a system 500 to manage one or more content encryption configurations, in accordance with one or more aspects of the present disclosure. The system 500 includes the device 102 and a protection device 550.

The protection device 550 includes, or is coupled to, a memory 556 (e.g., a memory device) and one or more processors 558 (collectively referred to herein as the “processor 558”). The memory 556 may include one or more memory devices, such as a single memory or multiple different memory devices (of the same type or of different types). In some embodiments, the memory 556 includes or corresponds to the memory 106.

The memory 556 is configured to store instructions 559 and a content encryption configuration 580. The instructions 559, when executed by the processor 558, cause the processor 558 to perform one or more operations as described herein. The content encryption configuration 580 may be associated with or indicate content (e.g., sensitive content) to be protected. The content encryption configuration 580 may be determined by the protection device 550, a user of the protection device 550, a provider (e.g., a service provider or OEM) associated with the protection device 550, by a company or entity associated with the protection device 550, based on a regulation, or a combination thereof. In some embodiments, the content encryption configuration 580 may be associated with media content generated in association with a surveillance system (e.g., a body camera or a closed circuit camera system), a personal recording (e.g., recorded in a public space or a private space), a vehicle (e.g., for autonomous driving, a dashboard camera, or for in-cabin monitoring), or a combination thereof, as illustrative, non-limiting examples.

The content encryption configuration 580 may include or correspond to the content encryption configuration 130, one of the entries 221, 242, 263, 284, 285, 411, or 452, or a combination thereof. The content encryption configuration 580 includes one or more object classes 557 (collectively referred to herein as the “object class 557”) and one or more keys 554 (collectively referred to herein as the “key 554”). The object class 557 and the keys 554 may include or correspond to the object class 107 and the key 104, respectively.

The object class 557 indicates a class or type of one or more objects to be identified or detected within media content. The media content, such as input media content, may include image data, an image frame, video data (e.g., a sequence of multiple image frames), audio data, or a combination thereof. The object class 557 may include or be associated with sensitive, private, or confidential content to be protected. In some embodiments, the class or type of the one or more objects may include or indicate a human body, a body part, a particular individual, a human face, a voice, a word or phrase, a sound, a vehicle, a type of vehicle, a vehicle manufacturer, a vehicle model, a vehicle license plate, an address, a street name, a weapon, a type of weapon, an animal, a document, a poster, a display or monitor (e.g., a computer screen or a display device), a whiteboard, a logo or company identifier, or a combination thereof, as illustrative, non-limiting examples. Additionally, or alternatively, the object class 557 includes or indicates all media content, such as an entire image frame, an entire bitstream, all audio content, or a combination thereof).

The key 554 may include or correspond to a respective object class 557. The key 554 may be configured to encrypt or decrypt at least a portion of media content that includes or is associated with an instance of the object class 557, to encrypt another key, decrypt the other encrypted key, or a combination thereof. In an example in which the key 554 includes multiple keys, the key may include a first key (e.g., an encryption/decryption key such as the key 137) configured to encrypt at least a portion of media content that includes or is associated with an instance of the object class 557 and decrypt an encrypted version of the portion of the media content, a second key (e.g., a public key of a public-private key pair) configured to encrypt information (such as the first key), a third key (e.g., a private key of the public-private key pair) configured to decrypt information encrypted using the second key, or a combination thereof.

In some embodiments, the content encryption configuration 580 may also include a condition, a status, a source, a model, or a combination thereof. The condition, the status, the source, and the model may include or correspond to the condition 228, the status 229, the source 230, and the model 231, respectively.

During operation, the protection device 550 (e.g., the processor 558) stores the content encryption configuration 580 at the memory 556. The protection device 550 may maintain the content encryption configuration 580 at the memory 556. For example, to maintain the content encryption configuration 580, the processor 558 may perform one or more operations to add another content encryption configuration to the memory 556, modify the content encryption configuration 580 stored at the memory 556, or remove the content encryption configuration 580 from the memory 556.

The processor 558 is configured to generate an encryption request 590. The encryption request 590 may include a content encryption configuration indicator 591. In some implementations, the encryption request 590 is associated with an add content encryption configuration request. For example, the encryption request 590 (e.g., the add content encryption configuration request) may include or correspond to the first request 401 or the third request 441 of FIG. 4.

The content encryption configuration indicator 591 may include or indicate at least a portion of a content encryption configuration, such as the content encryption configuration 130 or 580. In some implementations, if the key 554 of the content encryption configuration 580 includes a private key of a public-private key pair, the content encryption configuration indicator 591 does not include the private key of the public-private key pair. However, the content encryption configuration indicator 591 may include or indicate a public key of the public-private key pair.

The device 102 receives the encryption request 590 and stores the content encryption associated with the content encryption configuration indicator 591 as the content encryption configuration 130. In some embodiments, the device 102 may store an entry that corresponds to the content encryption associated with the content encryption configuration indicator 591. For example, the device 102 may perform one or more operations as described with reference to FIG. 4 at 400 or 440. After storage of the content encryption associated with the content encryption configuration indicator 591, the device 102 may perform a media capture operation based on (in accordance with) the stored content encryption configuration 130. For example, the device 102 may perform one or more operations as described herein at least with reference to FIG. 1.

In some embodiments, the protection device 550 may update the content encryption configuration 580. For example, the protection device 550 may receive a user input from a user authorized to add or modify the content encryption configuration 580. As another example, the protection device 550 may be configured to automatically add or update the content encryption configuration 580. To illustrate, the protection device 550 may update a key, a condition, or a model, as illustrative, non-limiting examples.

Based on the update 592 to the content encryption configuration 580, the protection device 550 may optionally (as indicated by the dashed lines) send an update 592to the device 102. For example, the update may include or correspond to the modify model request 432, the modify key request 462, the modify condition request 463, the modify status request 482, or the remove entry request 492. In some embodiments, the update 592 is included in an encryption request, such as the encryption request 590. For example, the encryption request that includes the update 592 may include or correspond to the second request 431, the fourth request 461, the fifth request 481, or the sixth request 491.

In some embodiments, the update 592 originates from a source distinct from a local capture operation of the device 102. For example, the update 592 may originate from the protection device 550, which may be associated with a third-party entity such as a company, an organization, an original equipment manufacturer (OEM), a service provider, a contact of a user associated with the device 102, a regulatory authority, or a combination thereof, as distinct from one or more operations performed by the device 102 to generate, capture, encode, encrypt, or output media data. Accordingly, the device 102 may store and maintain the one or more content encryption configuration entries at the memory 106 based on the update 592 originating from the third-party entity, independent of one or more local operations of the device 102 associated with generation, capture, encoding, encryption, or output of media data.

The device 102 receives the update 592 and updates the content encryption configuration 130 based on the update 592. In some embodiments, the device 102 may modify or remove the content encryption configuration 130 or an entry thereof. For example, the device 102 may perform one or more operations as described with reference to FIG. 4 at 430, 460, 480, or 490.

After implementation of the update 592, the device 102 may perform a media capture operation based on (in accordance with) the stored content encryption configuration 130 – e.g., the updated content encryption configuration 130. For example, the device 102 may perform one or more operations as described herein at least with reference to FIG. 1.

In some embodiments, the device 102 may optionally (as indicated by the dashed lines) generate and send a notification 594 based on use of the content encryption configuration 130 to generate the encoded output data 162. For example, the device 102 may send the notification 594 to the protection device 550 based on source information associated with the content encryption configuration 130. The notification 594 may include at least a portion of the content protection data 164, such as an indicator 707 as described further herein at least with reference to FIG. 7. Additionally, or alternatively, the device 102 may send the encoded output data 162 to the protection device 550.

In some embodiments, the protection device 550 is associated with an OEM or a service provider of the device 102 and the content encryption configuration is associated with a regulation or a law. For example, the regulation may indicate that an individual’s face (any individual/person) in public spaces is to be protected. Accordingly, the protection device 550 may send the encryption request 590 to the device 102 to enable the device 102 to generate the output data (e.g., the encoded output data 162) that complies with the regulation.

In some embodiments, the protection device 550 is associated with an entity, such as a company or property owner, and the content encryption configuration is associated with protecting content in a physical space owned or controlled the by the entity. For example, the physical space may include an office building and the content to be protected may include or correspond to proprietary information (e.g., confidential), such as documents, whiteboards, or computer screens. Accordingly, the protection device 550 may send the encryption request 590 to the device 102 to enable the device 102 to generate the output data (e.g., the encoded output data 162) that protects the proprietary information.

In some embodiments, the protection device 550 is associated with an entity, such as government entity and the content encryption configuration is associated with protecting content in a physical space that is a restricted area. In some such implementations, all content in the restricted area is to be protected. Stated differently, capturing media content in the restricted area is prohibited. Accordingly, the protection device 550 may send the encryption request 590 to the device 102 to enable the device 102 to generate the output data (e.g., the encoded output data 162) that protects all media content captured by the device 102 in the restricted area.

In some embodiments, the protection device 550 is associated with an entity, such as a police department or security organization, and the device 102 is associated with an image capture device, such as a security system or a body camera. The content to be protected may include or correspond to a face of an individual or location/address information (e.g., license plate, address, street name, or signs). Accordingly, the protection device 550 may send the encryption request 590 to the device 102 to enable the device 102 to generate the output data (e.g., the encoded output data 162) that protects faces of individuals and location/address information.

In some embodiments, the protection device 550 is associated with an individual, such as a contact of a user of the device 102. The content to be protected may include or correspond to a face of the user of the protection device 550 or another individual, such as child of the user of the protection device 550. Accordingly, the protection device 550 may send the encryption request 590 to the device 102 to enable the user of the protection device to request that the device 102 to generate the output data (e.g., the encoded output data 162) that protects content indicated by the user of the protection device.

In some embodiments, a device (e.g., the protection device 550) includes a memory (e.g., the memory 556) and one or more processors (e.g., the processor 558). The memory is configured to store one or more content encryption configuration entries (e.g., the content encryption configuration 580). At least one content encryption configuration entry of the one or more content encryption configuration entries indicates a respective object class (e.g., the object class 557) and a respective key (e.g., the key 554). The one or more processors are configured to maintain the one or more content encryption configuration entries at the memory.

In some embodiments, a device (e.g., the device 102) includes a memory (e.g., the memory 106) and one or more processors (e.g., the processor 108). The memory is configured to store a content encryption configuration (e.g., the content encryption configuration 130) that indicates an object class (e.g., the object class 107) and a public key (e.g., the key 104). The one or more processors are configured to obtain the object class that indicates an object to be detected, and obtain the public key associated with the object class. The public key and the object class associated with a content encryption configuration. The public key is configured to encrypt an encryption key associated with the object class. The one or more processors are further configured to generate the content encryption configuration that indicates the object class and the public key.

In some examples, the protection device 550 corresponds to or is included in one of various types of devices, such that the processor 558 can be integrated in multiple types of devices. In an illustrative example, the processor 558 is integrated in a wearable electronic device as depicted in FIG. 14, a virtual reality, mixed reality, or augmented reality headset as depicted in FIG. 17, a mixed reality or augmented reality glasses device as described with reference to FIG. 18, or another wearable device. In another illustrative example, the processor 108 is integrated in a mobile device (a mobile phone or a tablet computer device) as depicted in FIG. 13, a voice-controlled speaker system as depicted in FIG. 15, a camera as depicted in FIG. 16, a vehicle as depicted in FIGS. 19 or 20, a computer (e.g., a laptop computer) or a server, or another system or device.

As described with reference to FIG. 5, the present disclosure provides techniques for managing one or more content encryption configurations that can be used to identify and encrypt media content. For example, one technical advantage of implementing the device 102 as described above is that privacy control and content management is provided through management of the one or more content encryption configurations, such as the content encryption configuration 130. Additionally, the protection device 550 may provide the encryption request 590 that includes or indicates the content encryption configuration 130 to be applied by the device 102. To further illustrate the technical advantage, sensitive, private, or confidential content to be protected by the device 102 in accordance with the encryption request 590. A user or a device (e.g., the protection device 550) that has access to a decryption key can decrypt the encrypted portion and thereby recover the sensitive content and combine the recovered sensitive content with the masked content to generate (e.g., recreate) the original content. In some embodiments, the operations described with reference to the system 100 may be applied to provide automatic sensitive content (partial video) encryption while the video is captured for the first time. The partial video encryption can allow for both authorized and non-authorized access of encrypted content using the same encoded output data 162 (e.g., the same encrypted bitstream).

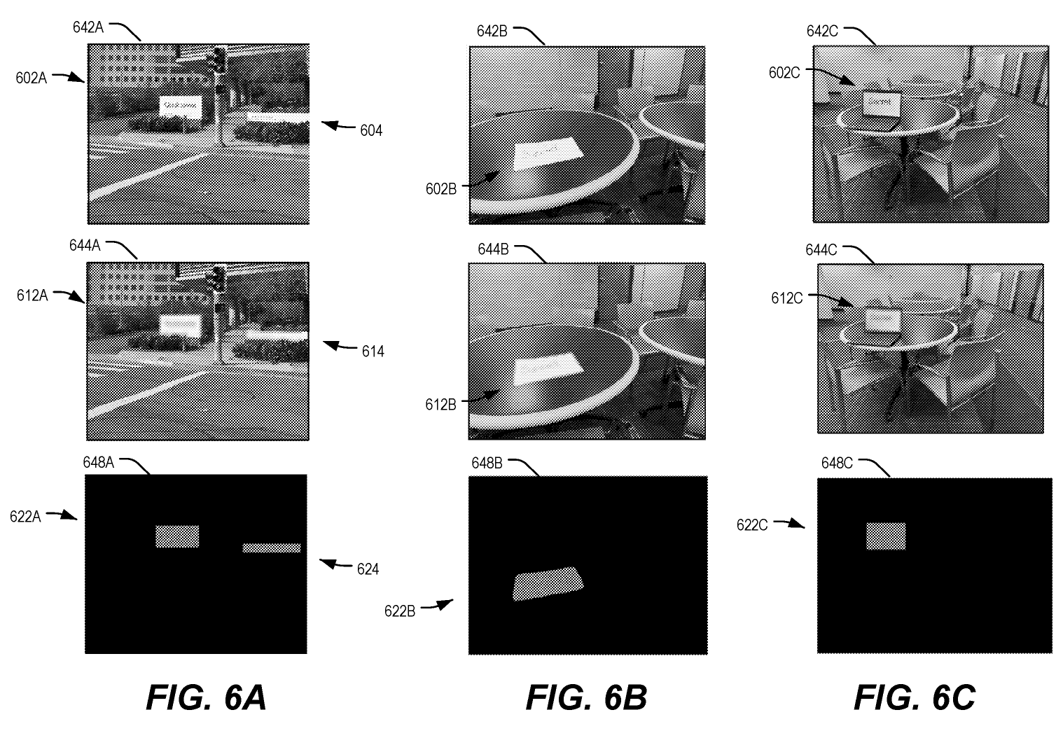

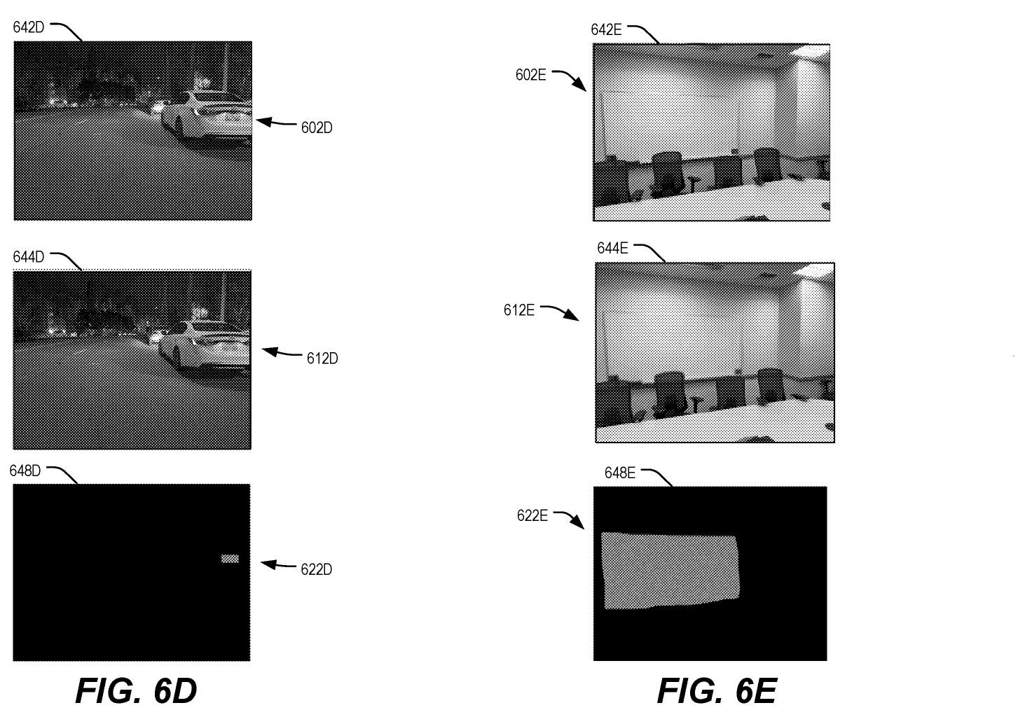

FIGS. 6A-6E are diagrams of examples of image frames to illustrate operations associated with the system of FIG. 1, in accordance with one or more aspects of the present disclosure. For example, the operations may be associated with or correspond to operations of the processor 108 (e.g., the media generator 120) as described with reference to FIG. 1. To illustrate, the operations of the processor 108 may be performed based on the content encryption configuration 130, such as one of the entries 221, 242, 263, 284, 285, 411, or 452.

The examples of FIGS. 6A-6E each includes an input image frame 642, a masked image frame 644, and an encrypted ROI frame 648 including encrypted content. The input image frame 642, the masked image frame 644, and the encrypted ROI frame 648 (including the encrypted content) may include or correspond to the input image frame 142, the masked image frame 144, and the encrypted ROI content 148, respectively.

The input image frame 642 of the examples of FIGS. 6A-6E includes an image of a scene. Additionally, the input image frame 642 includes one or more instances of an object class, such as the object class 107. For example, the input image frame 642 of the examples of FIG. 6A-6E includes a first instance 602 of a first object class, and the input image frame 642 of FIG. 6A includes a second instance 604 of a second object class. The first object class and the second object class may be the same object class or different object classes.

The masked image frame 644 of the examples of FIGS. 6A-6E includes one or more masked portions and a non-masked portion. The one or more masked portions may include or correspond to the one or more instance of the object class included in the input image frame 642. The masked image frame 644 of the examples of FIGS. 6A-6E includes a first portion 612, and the masked image frame 644 of the example of FIG. 6A includes a second portion 614. The first portion 612 may correspond to the first instance 602 and the second portion 614 may correspond to the second instance 604.

The encrypted ROI frame 648 of the examples of FIGS. 6A-6E includes encrypted content. The encrypted content corresponds to the one or more instances of the object class and/or the one or more masked portions. The encrypted ROI frame 648 of the examples of FIGS. 6A-6E includes first encrypted content 622, and the encrypted ROI frame 648 of the example of FIG. 6A includes second encrypted content 624. The first encrypted content 622 may correspond to the first instance 602 and the second encrypted content 624 may correspond to the second instance 604.

In embodiments in which the first object class associated with the first instance 602 and the second object class associated with the second instance 604 are the same object class, the first encrypted content 622 and the second encrypted content 624 may be generated using the same key (e.g., the key 137). In embodiments in which the first object class associated with the first instance 602 and the second object class associated with the second instance 604 are different object classes, the first encrypted content 622 and the second encrypted content 624 may be generated using the same key (e.g., the key 137) or using different keys. For example, when the first object class and the second object class are different object classes, the first encrypted content 622 may be generated based on a first key and the second encrypted content 624 may be generated based on a encryption key that is different from the first key. In some embodiments in which the first encrypted content 622 and the second encrypted content 624 are generated using different keys, the first and second encrypted content 622, 624 may be included in the same encrypted ROI frame 648, or, alternatively, the first encrypted content 622 may be included in a first encrypted ROI frame and the second encrypted content 624 may be included in a second encrypted ROI frame.

The examples of FIGS. 6A-6E each depict operations associated with FIG. 1 in which the ROI identifier 121 (e.g., an object class detector) identifies an instance of the object class 107 present in the input image frame 642. The ROI masker 122 may generate the masked image frame 644, which is a masked version of the input image frame 642 in which at least one or more detected instances of the object class detected by the ROI identifier 121 are masked. The ROI generator 123 may generate the ROI content that corresponds to or is based on the detected one or more instances detected by the ROI identifier 121. The encryptor 124 may encrypt the ROI content 146 to generate the encrypted ROI frame 648.

Referring to FIG. 6A, the object class is or includes a sign (e.g., a building sign or a street sign). Accordingly, the first instance 602A is a first sign and the second instance 604 is a second sign. Referring to FIG. 6B, the object class is or includes a document. Accordingly, the first instance 602B is a document (e.g., a piece of paper). Referring to FIG. 6C, the object class is or includes a monitor (e.g., a screen) or a display device. Accordingly, the first instance 602C is a screen of a laptop computer. Referring to FIG. 6D, the object class is or includes a license plate. Accordingly, the first instance 602D is a license plate of an automobile. Referring to FIG. 6E, the object class includes writing or text on a whiteboard. Accordingly, the first instance 602C is written material on a whiteboard.

FIG. 7A is a diagram of examples of the encoded output data 162 to illustrate operations associated with the system of FIG. 1, in accordance with one or more aspects of the present disclosure. As described above with reference to FIG. 1, the encoded output data 162 may be generated by the encoder 128. For example, the encoder 128 may generate the encoded output data 162 based on the image data 140, the input image frame 142, the masked image frame 144, the encrypted ROI content 148, the output data 160, an ROI segmentation frame (as described further herein at least with reference to FIG. 7A), one or more encoder parameters (e.g., one or more encoding parameters), or a combination thereof.

Each of the examples of the encoded output data 162 of FIG. 7A includes the content protection data 164 and encoded data 710. The content protection data 164 may be included in a header of the encoded output data 162, metadata of the encoded output data 162, or a combination thereof. The content protection data 164 of each of the examples of FIG. 7A includes at least an indicator 707.

The encoded data 710 of each of the examples of FIG. 7A may include or correspond to the masked image frame 144, the encrypted ROI content 148, the output data 160, or a combination thereof. In some embodiments, the encoded data 710 includes an encoded version of the output data 160 encoded by the encoder 128. In some embodiments, the encoded data 710 includes an encoded version of the output data 160 encoded by the encoder 128. In the illustrated embodiment, the encoded data 710 includes an encoded masked image frame 714 and encoded encrypted ROI content 718. The encoded masked image frame 714 may include or correspond to an encoded version of the masked image frame 144 encoded by the encoder 128. The encoded encrypted ROI content 718 may include or correspond to an encoded version of the encrypted ROI content 148 encoded by the encoder 128.

A first example of the encoded output data 162 is designated 700. The encoded output data 162 of the first example 700 includes the indicator 707. The indicator 707 may be associated with the encoded encrypted ROI content 718 and/or may indicate that the encoded data 710 includes or is associated with the encoded encrypted ROI content 718. Additionally, or alternatively, the indicator 707 may include one or more indicators as described further herein with reference to a third example 760 of FIG. 7A.

A second example of the encoded output data 162 is designated 730. The encoded output data 162 of the second example 730, optionally (as indicated by dashed lines), includes position data 752 or an encoded segmentation frame 755 (e.g., segmentation data). For example, the encoded output data 162 includes one of the position data 752 or an encoded segmentation frame 755. Each of the position data 752 and the encoded segmentation frame 755 may enable decrypted ROI content (based on the encoded encrypted ROI content 718) to be combined with a decoded masked image frame (based on the encoded masked image frame 714). For example, the position data 752 may indicate a position (e.g., a pixel location) associated with the decoded masked image frame (based on the encoded masked image frame 714) where the decrypted ROI content (based on the encoded encrypted ROI content 718) is to be positioned.

The encoded segmentation frame 755 may include or correspond to a segmentation frame encoded by the encoder 128. The segmentation frame may include a segmented version of the input image frame 142 that is segmented based on or in association with a detected object class included in the input image frame 142. For example, the segmentation frame may include or correspond to an ROI segmentation frame 855 as described with reference to FIG. 8A. The encoded segmentation frame 755 may be decoded to obtain the segmentation frame which may be used to combine decrypted ROI content (based on the encoded encrypted ROI content 718) with a decoded masked image frame (based on the encoded masked image frame 714).

In the third example 760 of the encoded output data 162, the indicator 707 includes a condition indicator 771, a non-display indicator 773, an object class indicator 775, an encryption indicator 777, an identity indicator 779, and an encrypted key 781. In some embodiments, the indicator 707 may not include one or more of the condition indicator 771, the non-display indicator 773, the object class indicator 775, the encryption indicator 777, the identity indicator 779, or the encrypted key 781. The condition indicator 771 may indicate a condition, such as the condition 228, associated with the encoded encrypted ROI content 718 (e.g., the encrypted ROI content 148).

The non-display indicator 773 may indicate (for a decoder) to decode particular data (e.g., a particular frame), but not display the decoded data. For example, the non-display indicator 773 may include a non-display flag or a no display message (e.g., a no display SEI message). The non-display indicator 773 may indicate or correspond to the encrypted ROI content 148 (e.g., a frame that includes the encrypted ROI content 148), a segmentation frame, the encoded encrypted ROI content 718, or the encoded segmentation frame 755.

The object class indicator 775 may be associated with an object class (e.g., the object class 107) detected in the input image frame 142 and for which the encrypted ROI content 148 was generated (and thereby the encoded encrypted ROI content 718). Additionally, or alternatively, the object class indicator 775 may indicate one or more object classes, a number of detected objects, a number object classes (detected in the input image frame 142), or a combination thereof.

The encryption indicator 777 may indicate that the encoded output data 162 includes or indicates the encrypted ROI content 148 (e.g., encrypted media data). In an illustrative example, the encryption indicator 777 includes or corresponds to a flag that indicates the presence of encrypted data in the encoded output data 162. Additionally, or alternatively, the encryption indicator 777 may indicate one or more encryption parameters. The one or more encryption parameters may include or indicate an encryption type, a maximum block size, an alphabet size, one or more formatting details, a number of object classes, or a combination thereof.

The identity indicator 779 may include or indicate a device ID of a device (e.g., that generated the encoded output data 162), a user ID of a user of the device, or a combination thereof. For example, the device may include or correspond to the device 102.

The encrypted key 781 may include or correspond to the key 137 used to generate the encrypted ROI content 148. For example, the encrypted key 781 may include or indicate the key 137, an encrypted version of the key 137, a public key used to encrypt the key 137 to generate the encrypted version of the key 137, or a combination thereof.

Although each of the examples of FIG. 7A is described as including the indicator 707, one or more of the examples of FIG. 7A may not include the indicator 707. Additionally, or alternatively, although each of the examples of FIG. 7A is described as including the encoded masked image frame 714 and the encoded encrypted ROI content 718, in other examples, the encoded output data 162 may not include one of the encoded masked image frame 714 or the encoded encrypted ROI content 718. For example, the encoded output data 162 may not include the encoded encrypted ROI content 718.

FIG. 7B is a diagram of an example of a bitstream 799 of encoded output data to illustrate operations associated with the system of FIG. 1, in accordance with one or more aspects of the present disclosure. In an illustrative example, the bitstream 799 corresponds to the encoded output data 162.

The bitstream 799 includes sequence data 770 and a sequence of encoded frames that includes data corresponding to the frames. The sequence data 770 includes encryption parameters 772. The encryption parameters 772 can include, for one or more encryption algorithms used to encrypt data in the sequence, data identifying the particular encryption algorithm, a number of parameters for the particular algorithm, an encryption mode, a total parameter size, values of the parameters for the particular algorithm, or a combination thereof. Examples of possible algorithm parameters include alphabet size, max block size, input data bit-width, public key certificate (e.g., digital certificate or identity certificate), certificate authority, digital signature, one or more other parameters, or a combination thereof. Examples of encryption algorithms include FF1: Format-preserving Feistel-based Encryption Mode (ANSI X9 as X9.119 and X9.124); FF3-1: DRAFT SP 800-38G Rev 2; and FF2: The FFX Mode of Operation for Preserving Encryption, as illustrative, non-limiting examples.

The bitstream 799 also includes an encoded masked image frame 774 and an encoded encrypted ROI frame 792 associated with the encoded masked image frame 774. The encoded masked image frame 774 includes a header 776 and encoded pixel data 780. The header 776 includes metadata associated with a frame of the image data 140 (e.g., the input image frame 142), including a display order frame ID 778, such as a display order frame ID that indicates a display order of the encoded masked image frame 774 in the sequence.

The encoded encrypted ROI frame 792 includes a header 794 and encoded encrypted pixel data 798. The header 794 includes metadata for an encrypted ROI frame (e.g., the encrypted ROI content 148) corresponding to the encoded masked image frame 774. As illustrated, the header 794 includes a no display SEI 786 that indicates that the encoded encrypted ROI frame 792 is not to be displayed, the frame ID 787 that indicates or corresponds to the display order frame ID 778 to associate the encoded encrypted ROI frame 792 with the encoded masked image frame 774, and the indicator 707. In some embodiments, the header 794 also may include encryption parameters associated with the encrypted ROI(s) in the encoded encrypted ROI frame 792.

Although the bitstream 799 is described as including both the encoded masked image frame 774 and the encoded encrypted ROI frame 792, in other embodiments, the bitstream 799 may include one of the encoded masked image frame 774 or the encoded encrypted ROI frame 792 and not the other. For example, the bitstream 799 may include the encoded masked image frame 774 and not the encoded encrypted ROI frame 792. Alternatively, the bitstream 799 may include the encoded encrypted ROI frame 792 and not the encoded masked image frame 774.

Although the encoded output data 162 of FIG. 7A and the bitstream 799 of FIG. 7B are described above in the context of a bitstream-based arrangement, in some embodiments the components of the encoded output data 162 — including, for example, the encoded masked image frame 714 (e.g., the encoded masked image frame 774), the encoded encrypted ROI content 718 (e.g., the encoded encrypted ROI frame 792), the position data 752, the encoded segmentation frame 755, the indicator 707, and the content protection data 164 — are instead organized within a media container as described herein with reference to FIG. 1. For example, the encoded masked image frame 714 may be included in a first track of the media container, the encoded encrypted ROI content 718 may be included in a second track of the media container, and the position data 752, the encoded segmentation frame 755, the indicator 707, and the content protection data 164 may be included in a metadata field, a supplemental track, an embedded data field, or a combination thereof, of the media container.

In some such embodiments, frame association data analogous to the display order frame ID 778 and the frame ID 787 (which, in the bitstream 799, are included in the headers 776 and 794, respectively) may be carried as container-level metadata to associate frames within the media container. Additionally, or alternatively, an indication that a frame or track of the media container is not to be displayed by a standard media player (analogous to the no-display SEI 786 in the bitstream 799) may be included as container-level metadata associated with the encoded encrypted ROI content 718, the encoded segmentation frame 755, or both.

FIG. 8A is a diagram of an illustrative example of the processor 108 of the system 100 of FIG. 1, in accordance with one or more aspects of the present disclosure. The processor 108 of FIG. 8A is configured to generate an ROI segmentation frame 855, as described herein. The ROI segmentation frame 855 may be associated with or correspond to the encoded segmentation frame 755.

The processor 108 includes the media generator 120 and the encoder 128. The media generator 120 includes the ROI identifier 121, the ROI masker 122, the ROI generator 123, the encryptor 124, an encrypted ROI positioner 834, and the output data generator 127. The ROI identifier 121 includes an ROI detector 810 and an ROI segmentor 812.

The ROI detector 810 is configured to detect an instance of the object class 107 included in the input image frame 142, and identify an ROI associated with the detected instance of the object class 107. The ROI identifier 121 may receive the content protection indicator 135 that includes or indicates the object class 107. In some examples, the content protection indicator 135 includes or indicates a model to be used by the ROI identifier 121 (e.g., the ROI detector 810) to detect the object class 107 included in the input image frame 142.

The ROI segmentor 812 is configured to, based on the ROI identified by the ROI detector 810, generate the ROI segmentation frame 855. For example, the ROI segmentation frame 855 may indicate the ROI (identified by the ROI detector 810) in a frame.

The ROI masker 122 is configured to receive a mask indicator 804. In some embodiments, the mask indicator 804 is received from the protection controller 110. For example, the content protection indicator 135 may include or indicate the mask indicator 804. The mask indicator 804 may include or indicate a mask technique or a mask type to be used by the ROI masker 122. The ROI masker 122 may generate the masked image frame 144 based on the mask indicator 804, the input image frame 142, and the ROI segmentation frame 855. For example, the ROI masker 122 may apply a mask (based on the mask indicator 804) to the input image frame 142 at a location/position based on the ROI segmentation frame 855 to generate the masked image frame 144.

The ROI generator 123 includes an ROI extractor 820 and an ROI vectorizer 822. The ROI extractor 820 is configured to extract an ROI from the input image frame 142. The extracted ROI may be a two-dimensional (2D) data structure, such as a 2D array that is at least partially populated with pixel values of pixels that are indicated, by use of the ROI segmentation frame 855, to be within the ROI. In a particular embodiment, the ROI extractor 820 applies the ROI segmentation frame 855 as a segmentation mask to the input image frame 142 to extract the ROI.

The ROI vectorizer 822 is configured to generate one or more ROI vectors 824 based on the extracted ROI. The ROI vector 824 may be one-dimensional (1D). In some embodiments, to generate the ROI vector 824, the ROI vectorizer 822 is configured to perform a raster scan on the extracted ROI. For pixel formats with no chroma-subsampling, such as YUV444 or RGB, each channel may be added one after the other to generate the ROI vector 824. Alternatively, the ROI vectorizer 822 may generate the ROI vector 824 one channel at a time. For other pixel formats with chroma-subsampling, such as YUV420, the segmentation mask may be downscaled using a chroma sub-sampling ratio and the downscaled data may be vectorized accordingly. It is noted that the ROI vectorizer 822 may generate a respective ROI vector 824 for each object of the object class 107 detected in the input image frame 142.

The encryptor 124 is configured to receive the ROI vector 824 and encrypt the ROI vector 824 to generate encrypted ROI content 832. For example, the encryptor 124 may receive the ROI vector 824 from the ROI generator 123 and encode, based on the key 137, the ROI vector 824. In some embodiments, the encryptor 124 uses a format preserving encryption (input and output have the same size) to generate the encrypted ROI content 832 based on the ROI of the ROI vector 824.

The encrypted ROI positioner 834 is configured to receive the encrypted ROI content 832 and generate the encrypted ROI frame 836. For example, the encrypted ROI positioner 834 may receive the ROI segmentation frame 855 and may position the encrypted ROI content 832 in the ROI segmentation frame 855 to generate the encrypted ROI frame 836. To illustrate, the encrypted ROI positioner 834 may position the encrypted ROI content 832 in the ROI segmentation frame 855 at a location/position that is associated with the ROI identified by the ROI identifier 121. In some embodiments, the encrypted ROI positioner 834 receives the encrypted ROI content 832 (e.g., a 1D vector) and converts the 1D vector back into a 2D data structure. The encrypted ROI positioner 834 may include the encrypted ROI using the same exact location as the original data using the initial segmentation.

The output data generator 127 is configured to generate the output data 160 based on the masked image frame 144, the ROI segmentation frame 855, the encrypted ROI frame 836, one or more encoder parameters, or a combination thereof. For example, the output data generator 127 may combine the masked image frame 144, the ROI segmentation frame 855, the encrypted ROI frame 836, one or more encoder parameters, or a combination thereof, to generate the output data 160. In some embodiments, to generate the output data 160, the output data generator 127 is configured to concatenate the masked image frame 144, the ROI segmentation frame 855, and the encrypted ROI frame 836 to generate the output data 160.

The encoder 128 is configured to receive the output data 160 and generate encoded output data 162. In some embodiments, the encoder 128 may encode the output data 160 based on the content protection indicator 135, one or more encoder parameters received from the protection controller 110 and/or the media generator 120, or a combination thereof. Additionally, or alternatively, the encoder 128 may include additional data to facilitate decode processing of the encoded output data 162 by a decoder.

FIG. 8B is a diagram of an example of a bitstream 899 of encoded output data to illustrate operations associated with the system of FIG. 8A, in accordance with one or more aspects of the present disclosure. The bitstream 899 may include or correspond to the bitstream 799.

The bitstream 899 also includes the encoded masked image frame 774, an encoded segmentation frame 882 associated with the encoded masked image frame 774, and the encoded encrypted ROI frame 792 associated with the encoded masked image frame 774. The encoded segmentation frame 882 includes a header 794 and encoded pixel data 890. The header 884 includes metadata for a ROI segmentation frame (e.g., the ROI segmentation frame 855 of FIG. 8A) corresponding to the encoded masked image frame 774. As illustrated, the header 884 includes the no display SEI 786 that indicates that the frame is not to be displayed, and includes the frame ID 787 that indicates or corresponds to the display order frame ID 778 to associate the encoded segmentation frame 882 with the encoded masked image frame 774. In some embodiments, the header 884 may include an ROI segmentation frame flag that identifies the frame as an encoded segmentation frame. Additionally, or alternatively, the header 884 may include ROI ID data associated with ROIs in the frame, such as a number of ROIs in the frame and identification of each of the ROIs in the frame.

Although the bitstream 899 is described as including each of the encoded masked image frame 774, encoded segmentation frame 882, and the encoded encrypted ROI frame 792, in other embodiments, the bitstream 799 may not include one of the encoded masked image frame 774, the encoded segmentation frame 882, or the encoded encrypted ROI frame 792. For example, the bitstream 899 may include the encoded masked image frame 774 and the encoded segmentation frame 882. Alternatively, the bitstream 899 may include the encoded segmentation frame 882 and the encoded encrypted ROI frame 792.

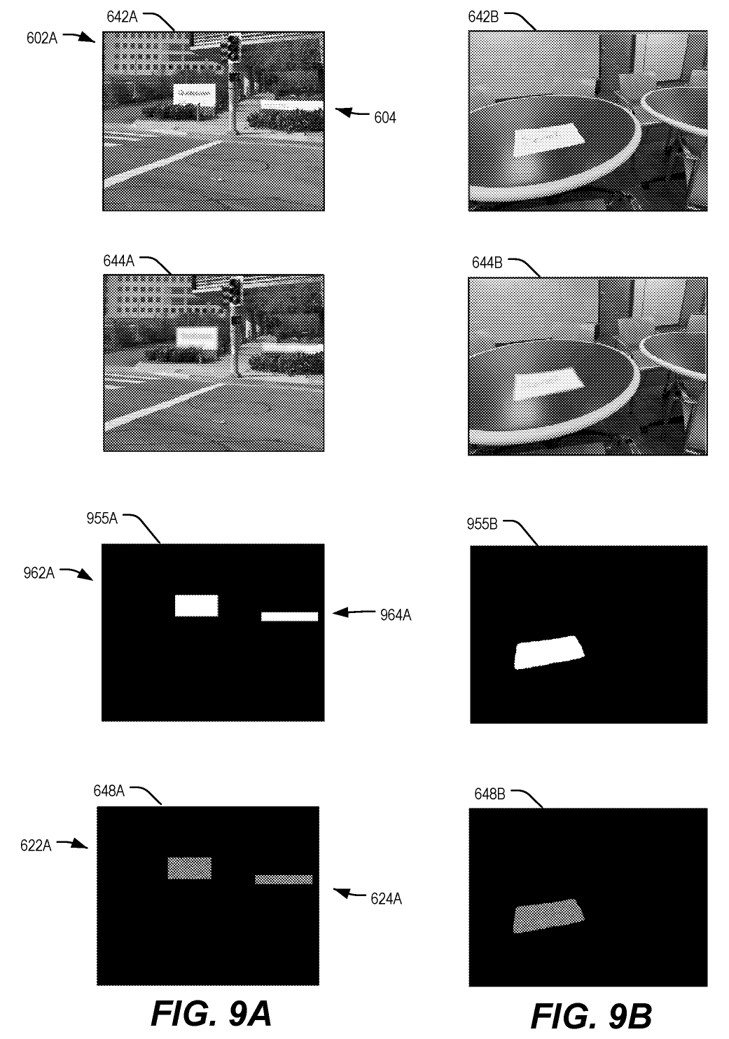

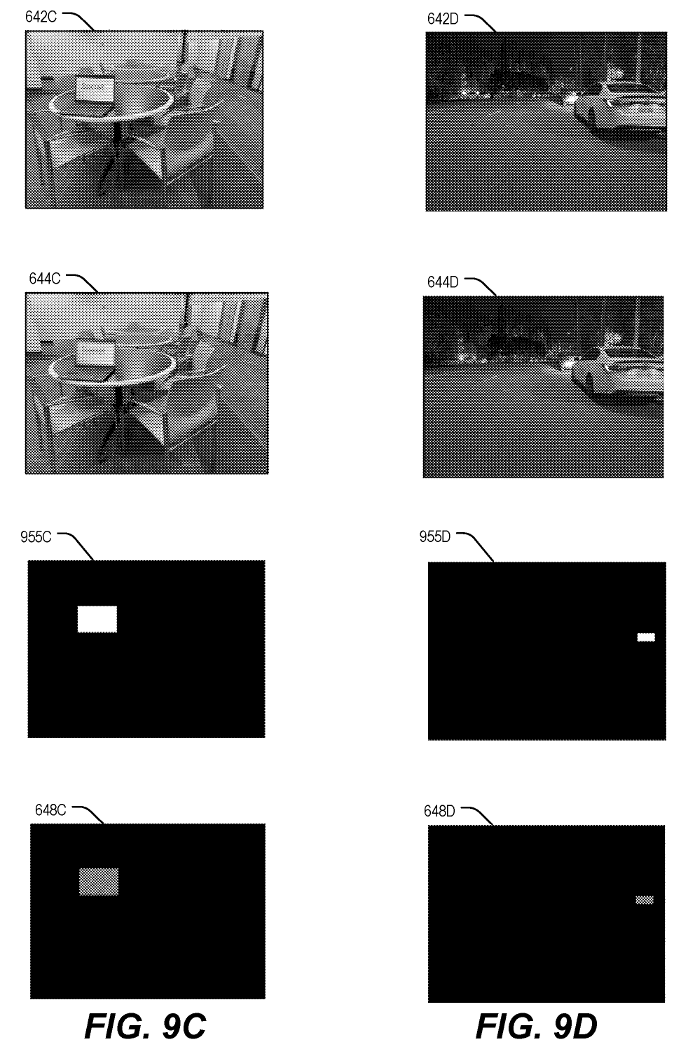

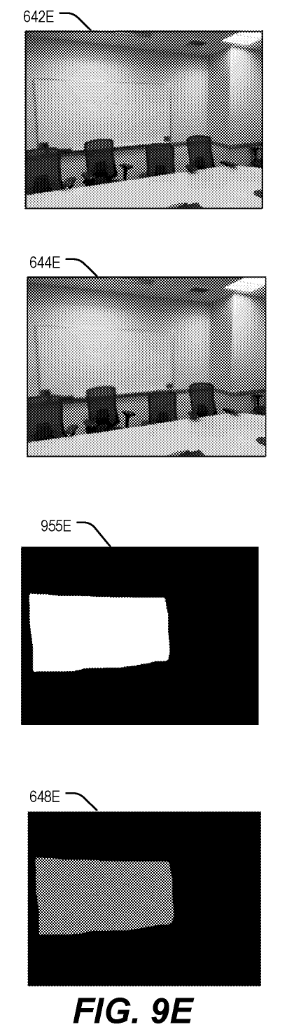

FIGS. 9A, 9B, 9C, 9D, and 9E are diagrams of examples of image frames to illustrate operations associated with the system of FIG. 1, in accordance with one or more aspects of the present disclosure. For example, the operations may be associated with or correspond to operations of the processor 108 (e.g., the media generator 120) as described with reference to FIGS. 1 and 8A. To illustrate, the operations of the processor 108 may be performed based on the content encryption configuration 130 or one of the entries 221, 242, 263, 284, 285, 411, or 452. It is noted that the examples of FIGS. 9A-9E include or correspond to the examples of FIGS. 6A-6E, respectively.

The examples of each of FIGS. 9A-9E includes the input image frame 642, the masked image frame 644, a segmentation frame 955, and the frame including encrypted content (e.g., the encrypted ROI frame 648). The input image frame 642 and the masked image frame 644 may include or correspond to the input image frame 142 and the masked image frame 144, respectively. The encrypted ROI frame 648 (including the encrypted content) may include or correspond to the encrypted ROI content 148 or the encrypted ROI frame 836. The segmentation frame 955 may include or correspond to the encoded segmentation frame 755 or the ROI segmentation frame 855. For purposes of illustration, the segmentation frame 955 includes pixels having two values: white (e.g., 1) for pixels in an identified ROI, and black (e.g., 0) for pixels not in an identified ROI. With reference to FIG. 9A, the segmentation frame 955A indicates a first ROI 962A corresponding to the first instance 602A (e.g., a first sign) and a second ROI 964A corresponding to the second instance 604 (e.g., a second sign) of the input image frame 242A.

The examples of FIGS. 9A-9E are described herein with reference to operations associated with FIG. 8A in which the content protection indicator 135 indicates the object class 107. For example, the ROI identifier 121 (e.g., the ROI detector 810) may identify an instance of the object class 107 indicated by the content protection indicator 135 as present in the input image frame 642. The ROI identifier 121 (e.g., the ROI segmentor 812) may generate the ROI segmentation frame 855 (e.g., the segmentation frame 955) based on the instance (e.g., the ROI) of the object class detected by the ROI detector 810.

The ROI masker 122 may generate, based on the input image frame 142 and the ROI segmentation frame 855, the masked image frame 644 which is a masked version of the input image frame 642 in which at least one or more objects (e.g., the instances 602, 604) detected by the ROI identifier 121 are masked. The ROI generator 123 may generate, based on the input image frame 142 and the ROI segmentation frame 855, the ROI vector 824 that is associated with content that corresponds to or is based on the detected one or more objects detected by the ROI identifier 121. The encryptor 124 may encrypt the ROI content 146 to generate the encrypted ROI content 832. The encrypted ROI positioner 834 may generate the encrypted ROI frame 648 based on the encrypted ROI content 832 and the ROI segmentation frame 855.

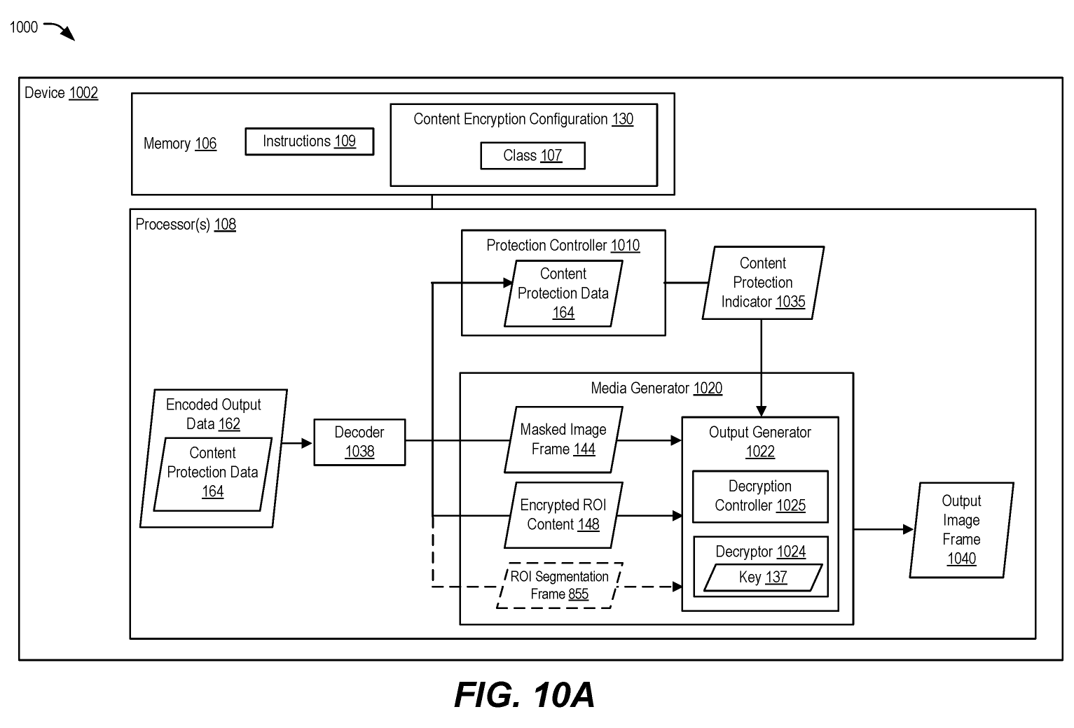

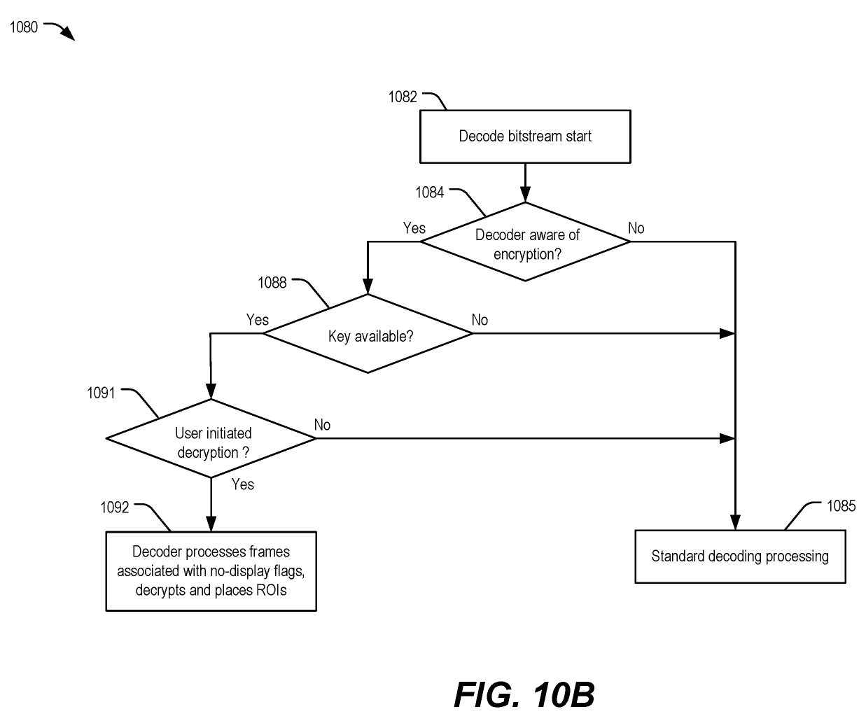

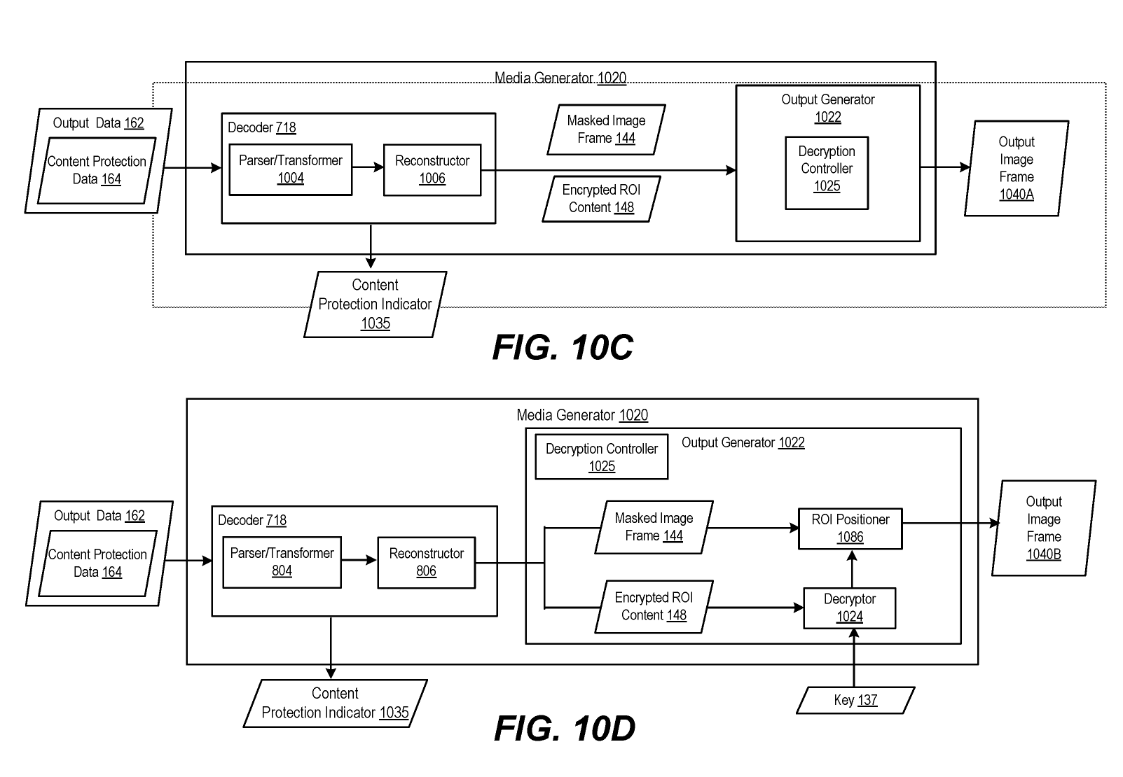

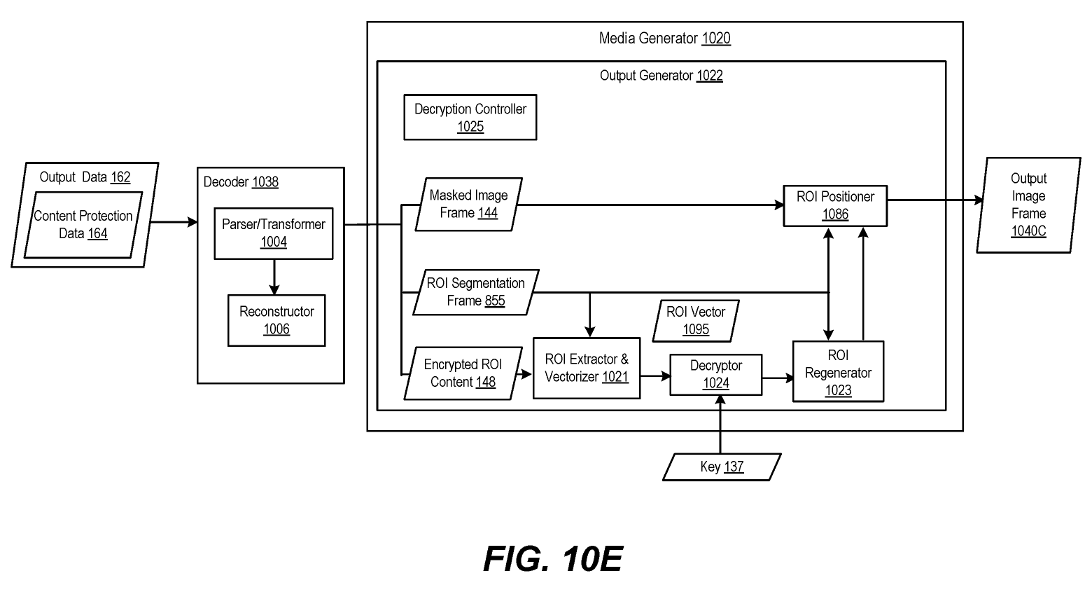

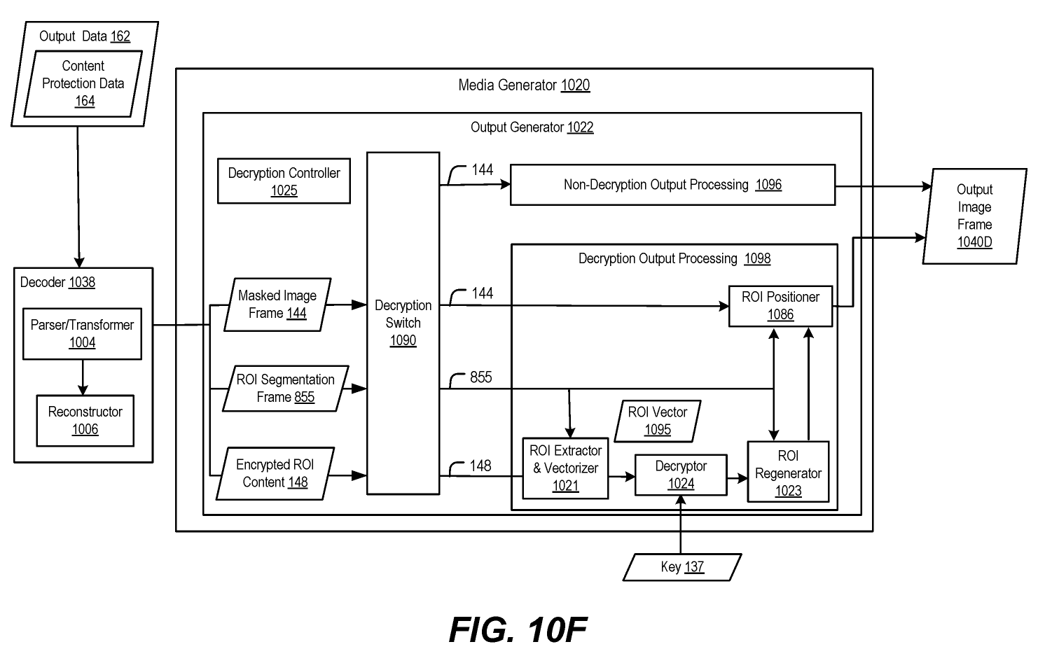

FIG. 10A is a block diagram of an example of a system 1000 to decode media content, in accordance with one or more aspects of the present disclosure. The system 1000 includes a device 1002 that is configured to or is operable to identify encrypted media content and decrypt the encrypted media content. The device 1002 may include or correspond to the device 102 or the protection device 550.

The device 1002 includes, or is coupled to, the memory 106 and the processor 108. The memory 106 is configured to store the instructions 109 and the content encryption configuration 130. In some embodiments, the content encryption configuration 130 of FIG. 10A includes the content encryption configuration 580 of FIG. 5. The content encryption configuration 130 may be associated with or indicate content (e.g., sensitive content) to be protected. The content encryption configuration 130 includes the object class 107. In some embodiments, the content encryption configuration 130 also includes the key 104 that is associated with or corresponds to the object class 107, such as an encryption/decryption key (e.g., the key 137), a public key of a public-private key pair, a private key of the public-private key pair, or a combination thereof. The key 104, such as the encryption/decryption key, may be configured to decrypt at least a portion of media content that includes or is associated with an instance of the object class 107.

In some embodiments, the device 1002 includes an interface configured to receive the encoded output data 162. The interface may include or correspond to a modem, a network interface, a bus interface, a wireless transceiver, or a combination thereof. In some examples, the interface includes a wired interface, such as a bus interface, a wired network interface, a cable interface, or a combination thereof. In some other examples, the interface includes a wireless interface, such as a wireless transceiver, a cellular modem, a Wi-Fi interface, a Bluetooth interface, or a combination thereof. In some embodiments, the interface is configured to provide the encoded output data 162 to the one or more processors (e.g., the processor 108). In some examples, the one or more processors (e.g., the decoder 1038) are configured to generate an output image frame 1040 based on the encoded output data 162, where the output image frame 1040 includes the masked image frame 144 or a modified version of the masked image frame 144 that includes a decrypted portion of the media data. Operations associated with the one or more processors generating the output image frame 1040 are described further herein at least with reference to FIGS. 10B-10F.

In some embodiments in which the encoded output data 162 includes a media container (e.g., an MPEG-4 (MP4) container, an Audio Video Interleave (AVI) container, an MPEG transport stream container, or another multimedia container format), the decoder 1038 is configured to access components of the media container to obtain the encoded masked image frame 714, the encoded encrypted ROI content 718, the content protection data 164, the segmentation data, or a combination thereof. For example, the decoder 1038 may access a first track of the media container to obtain the encoded masked image frame 714 and a second track of the media container to obtain the encoded encrypted ROI content 718. Additionally, or alternatively, the decoder 1038 may access a metadata field of the media container, a supplemental track of the media container, an embedded data field of the media container, or a combination thereof, to obtain the content protection data 164, the segmentation data, or both.

In a particular example, a decoder that is not configured to process the content protection data 164 may play back the first track of the media container to display the masked version of the input media data (e.g., based on the encoded masked image frame 714), while the decoder 1038 (which is configured to process the content protection data 164) may access the second track to obtain the encoded encrypted ROI content 718, decrypt the encrypted ROI content 148 based on the key 137, and provide the decrypted ROI content to a media generator (e.g., the media generator 1020) to be combined with the masked image frame 144 to generate the output image frame 1040.

In some examples, the memory 106 stores other information or data, such as media content. The media content can include or indicate audio content, video content, or a combination thereof. In some examples, the stored media content includes at least an encrypted portion.

The processor 108 includes a protection controller 1010, a media generator 1020, and a decoder 1038. The protection controller 1010 and the media generator 1020 may include or correspond to the protection controller 110 and the media generator 120, respectively. Each of the protection controller 1010, the media generator 1020, and the decoder 1038, or a portion thereof, may be implemented by the processor 108 executing instructions (e.g., software), dedicated hardware (e.g., circuitry), or a combination thereof. It is noted that in some embodiments, two or more of the protection controller 1010, the media generator 1020, or the decoder 1038 may be combined. For example, the media generator 1020 may include the protection controller 1010, the decoder 1038, or both. Additionally, or alternatively, the processor 108 of the device 1002 may be configured to perform one or more operations to maintain the content encryption configuration 130, such as one or more operations as described at least with reference to FIGS. 1 or 4.

The decoder 1038 is configured to receive the encoded output data 162 and decode the encoded output data 162 to obtain the output data 160 including the content protection data 164, and decode the output data 160 to obtain the content protection data 164, the masked image frame 144, and the encrypted ROI content 148. In some embodiments, the decoder 1038 may, optionally (as indicated by the dashed lines), decode the encoded output data 162 to obtain the ROI segmentation frame 855. The decoder 1038 may also decode the content protection data 164 to identify or determine one or more indicators, data, or a combination thereof, included in or indicated by the content protection data 164. For example, the content protection data 164 may include or indicate an object class indicator (that indicates the object class, a number of object classes, or a combination thereof), a device ID, a user ID of a user of the device, an encryption type indicator, one or more encryption parameters, or a combination thereof. In some embodiments, content protection data 164 includes an indicator, such as the indicator 707.

The protection controller 1010 is configured to receive at least a portion of the content protection data 164. The protection controller 1010 may determine, based on the content protection data 164, a content protection indicator 1035. The content protection indicator 1035 may include or indicate the key 137, one or more encryption/decryption parameters, the object class 107, or a combination thereof. For example, the protection controller 1010 may determine the object class 107 based on an object class indicator included in or indicated by the content protection data 164. As another example, the protection controller 1010 may determine the encryption/decryption parameters based on an encryption indicator, an identity indicator, an object class indicator, or a combination thereof, included in or indicated by the content protection data 164. In some embodiments, the content protection indicator 1035 may indicate content encryption configuration 130 (e.g., an encryption requirement) that includes the object class 107, a key (e.g., the key 137, a public key, or a private key), or a combination thereof, to be applied by the media generator 1020 (e.g., the output generator 1022) to identify or detect, and decrypt the encrypted ROI content 148. In some embodiments, the content protection indicator 1035 may indicate a list of object classes 107 and, for each object class, a respective key associated with the object class to enable decryption of one or more encrypted instances of the object class. The protection controller 1010 may provide the content protection indicator 1035 to the media generator 1020 (e.g., the output generator 1022).

In some embodiments, the protection controller 1010 is configured to determine whether or not the device 1002 or a user of the device 1002 is authorized or unauthorized to decrypt the encrypted ROI content 148. For example, the protection controller 1010 may determine whether or not the device 1002 or the user of the device 1002 is authorized or unauthorized based on the content protection data 164, the content encryption configuration 130, a key (e.g., a private key or the key 137), or a combination thereof. In some such embodiments, the content protection indicator 1035 may indicate whether the device 1002 or a user of the device 1002 is authorized or unauthorized, and/or a manner in which the output generator 1022 is to provide the output image frame 1040.

The media generator 1020 includes the output generator 1022. The output generator 1022 includes a decryption controller 1025 and a decryptor 1024. The media generator 1020 (e.g., the output generator 1022) is configured to receive the masked image frame 144, the encrypted ROI content 148, and the content protection indicator 1035. The media generator 1020 (e.g., the output generator 1022) may also obtain the key 137. In some embodiments in which the encoded output data 162 includes an encoded version of the ROI segmentation frame 855, the media generator 1020 (e.g., the output generator 1022) is also configured to receive the ROI segmentation frame 855 from the decoder 1038.

The output generator 1022 is configured to generate the output image frame 1040 based on the masked image frame 144, or based on a combination of the masked image frame 144 and the encrypted ROI content 148 and/or the ROI segmentation frame 855. For example, the output generator 1022 may selectively generate the output image frame 1040 based on whether the device 1002 and/or a user associated with the device 1002 is authorized to decrypt the encrypted ROI content 148. To illustrate, in some embodiments, if the device 1002 and/or the user of the device 1002 is unauthorized, the output generator 1022 may output the masked image frame 144 as the output image frame 1040. In other embodiments, if the device 1002 and/or the user of the device 1002 is authorized, the output generator 1022 may decrypt the encrypted ROI content 148 using the key 137 to obtain (e.g., generate) decrypted ROI content (e.g., the ROI content 146) that is combined with the masked image frame 144 to generate the output image frame 1040. In some other embodiments, if the device 1002 and/or the user of the device 1002 is authorized and the ROI segmentation frame 855 is obtained by the media generator 1020 (e.g., the output generator 1022), the output generator 1022 may decrypt the encrypted ROI content 148 using the key 137 to obtain (e.g., generate) decrypted ROI content (e.g., the ROI content 146) that is combined, based on the ROI segmentation frame 855, with the masked image frame 144 to generate the output image frame 1040.

The decryption controller 1025 may be configured to selectively configure the output generator 1022 (e.g., the decryptor 1024) to output the output image frame 1040. For example, based on a determination or an indication that the device 1002 and/or the user of the device 1002 is unauthorized, the decryption controller 1025 may configure the output generator 1022 to output the masked image frame 144 as the output image frame 1040. To illustrate, the decryption controller 1025 may pass through the masked image frame 144 as the output image frame 1040 and does not display or decrypt the encrypted ROI content 148. As another example, based on a determination or an indication that the device 1002 and/or the user of the device 1002 is authorized, the decryption controller 1025 may configure the output generator 1022 to output the output image frame 1040 that includes a decrypted version (e.g., the ROI content 146) of the encrypted ROI content 148. In some such examples, the output generator 1022 may combine the ROI content 146 with the masked image frame 144 to generate the output image frame 1040. It is noted that although the decryption controller 1025 is described as being included in the media generator 1020 (e.g., the output generator 1022), in other embodiments, the decryption controller 1025 may be included in the protection controller 1010.

The decryptor 1024 is configured to selectively decrypt or attempt to decrypt the encrypted ROI content 148 to obtain the ROI content 146. For example, the decryptor 1024 may selectively decrypt or attempt to decrypt the encrypted ROI content 148 based on the key 137, an indicator or control signal from the decryption controller 1025, the content protection indicator 1035, or a combination thereof.

During operation of the system 1000, the processor 108 obtains the encoded output data 162. The encoded output data 162 includes the content protection data 164 and encoded data. In some embodiments, the encoded output data 162 is associated with media content, such as image data, audio data, or a combination thereof.

The encoded output data 162 is provided to the decoder 1038 which decodes the encoded output data 162. Based on decoding the encoded output data 162, the decoder 1038 provides the content protection data 164 to the protection controller 1010, and provides the masked image frame 144 and the encrypted ROI content 148 to the media generator 1020. In some embodiments, the decoder 1038 also provides the ROI segmentation frame 855 to the media generator 1020 based on decoding the encoded output data 162.

In some embodiments, the protection controller 1010 and/or the decryption controller 1025 may determine whether or not the device 1002 or the user of the device is authorized or unauthorized to output the output image frame 1040 that includes a decrypted version of the encrypted ROI content 148. If the device 1002 or the user of the device 1002 is unauthorized, the output generator 1022 may output the masked image frame 144 as the output image frame 1040. Alternatively, if the device 1002 or the user of the device 1002 is authorized, the decryptor 1024 may decrypt, based on the key 137, the encrypted ROI content 148 to obtain the ROI content 146, and the output generator 1022 may modify the masked image frame 144 based on (e.g., to include) the ROI content 146 to generate the output image frame 1040. In some embodiments, the output image frame 1040 includes or corresponds to the input image frame 142, a bitstream, or a combination thereof. Additionally, or alternatively, the output image frame 1040 may be stored at the memory 106 or sent to another device for output.

In some embodiments, a device (e.g., the device 1002) includes a memory (e.g., the memory 106) and one or more processors (e.g., the processor 108). The memory is configured to store one or more content encryption configuration entries (e.g., the content encryption configuration 130). At least one content encryption configuration entry of the one or more content encryption configuration entries indicates a respective object class (e.g., the object class 107) and a respective key (e.g., the key 104). The one or more processors are configured to maintain the one or more content encryption configuration entries at the memory.

In some embodiments, a device (e.g., the device 1002) includes a memory (e.g., the memory 106) and one or more processors (e.g., the processor 108). The memory is configured to store a content encryption configuration (e.g., the content encryption configuration 130) that indicates an object class (e.g., the object class 107). The one or more processors are configured to obtain output media data (e.g., the encoded output data 162). The output media data includes encrypted media data (e.g., the encrypted ROI content 148) including an encrypted portion of media data. The encrypted portion of the media data is associated with an instance of the object class. The one or more processors are further configured to decrypt, based on a key (e.g., the key 137), the encrypted portion of the media data to obtain a portion of the media data.

In some examples, the device 1002 corresponds to or is included in one of various types of devices, such that the processor 108 can be integrated in multiple types of devices. In an illustrative example, the processor 108 is integrated in a wearable electronic device as depicted in FIG. 14, a virtual reality, mixed reality, or augmented reality headset as depicted in FIG. 17, a mixed reality or augmented reality glasses device as described with reference to FIG. 18, or another wearable device. In another illustrative example, the processor 108 is integrated in a mobile device (a mobile phone or a tablet computer) as depicted in FIG. 13, a voice-controlled speaker system as depicted in FIG. 15, a camera as depicted in FIG. 16, a vehicle as depicted in FIGS. 19 or 20, a computer (e.g., a laptop computer) or a server, or another system or device.

As described with reference to FIG. 10A, the present disclosure provides techniques for supporting decoding or decryption of media content. For example, one technical advantage of implementing the device 1002 as described above is that privacy control and content management of sensitive content which may be selectively decrypted based on the key 137. To further illustrate the technical advantage, the sensitive content of the media content is masked in the masked image frame 144, which can be displayed or stored by the device 1002 based on not having authorization or access to the sensitive content (e.g., the encrypted ROI content 148). In some aspects, device 1002 is authorized to access the sensitive content and decrypts the encrypted ROI content 148 to obtain (e.g., recover) the sensitive content. The sensitive content may then be combined with the masked image frame 144 to obtain the output image frame 1040 - e.g., to recreate the original media content (e.g., the input image frame 142). In some embodiments, the operations described with reference to the system 1000 may be applied to provide automatic sensitive content (partial video) decryption. The partial video decryption can allow for both authorized and non-authorized access of encrypted content using the same encoded output data 162 (e.g., the same encrypted bitstream).

FIG. 10B is a diagram of an example of operations 1080 that may be performed at the system 1000 of FIG. 10A, such as at the decoder 1038, the protection controller 1010, the media generator 1020, or a combination thereof. The operations 1080 include starting a decode process of a bitstream, at block 1082. For example, an encoded video bitstream can be received at the decoder 1038 as the encoded output data 162, the bitstream 799, or the bitstream 899.

At block 1084, a determination is made as to whether the decoder that receives the bitstream is “aware of” encryption. As used herein, a decoder is aware of encryption when the decoder is configured to detect that the bitstream includes encrypted content, such as the encoded data 710 (e.g., the encoded encrypted ROI content 718) or an encryption indicator that indicates encrypted content. Additionally, a decoder is not aware of encryption when the decoder is not configured to detect that the bitstream includes encrypted content (e.g., a “legacy” or “standard” decoder that is not configured to detect encrypted content or another indicator).

Based on the decoder not being aware of encryption, standard decoding processing is performed on the bitstream, at block 1085. For example, any encrypted content in the bitstream that is associated with a no-display SEI is ignored when generating the decoded output. Thus, when a bitstream includes the masked image frame 144 and the encrypted ROI content 148, the resulting output image frame corresponds to the masked image frame 144, while the encrypted ROI content 148 is unused (e.g., discarded or ignored).

Based on the decoder being aware of encryption, a determination is made as to whether a key (e.g., a decryption key) is available, at block 1088. Based on no key being detected or available, standard decoding processing is performed on the bitstream, at block 1085. Alternatively, based on the key (e.g., the key 137) being available, the operations 1080 advance to block 1091.

At block 1091, a determination is made as to whether decryption has been enabled. For example, in some embodiments the device 1002 is responsive to a user input (e.g., received via a user interface, or one or more selectable application settings) that indicates whether protected content is to be shown during playout (via decryption and insertion into the respective ROI) or if instead the masked content is to be shown during playout. Based on decryption not being enabled, standard decoding processing is performed on the bitstream, at block 1085. Alternatively, when decryption is enabled, at 1092, frames associated with non-display flags are processed, encrypted content is decrypted based on the key (e.g., the key 137) and placed into respective ROIs for playout. For example, the decryptor 1024 may decrypt the encrypted ROI content 148 to obtain the ROI content 146. The output generator 1022 may modify the masked image frame 144 based on (e.g., to include) the ROI content 146 to generate the output image frame 1040.

FIGS. 10C, 10D, 10E, and 10F are block diagrams to illustrate operations associated with the system of FIG. 10A. For example, FIG. 10C illustrates operations to provide the masked image frame 144 as the output image frame 1040A. Additionally, FIG. 10D illustrates operations to generate the output image frame 1040B as a combination of the ROI content 146 and the masked image frame 144. Further, FIG. 10E illustrates operations to generate the output image frame 1040C as a combination of or based on the ROI content 146, the masked image frame 144, and the ROI segmentation frame 855. FIG. 10F illustrates operations to selectively generate the output image frame 1040D as the masked image frame 144, or as a combination of at least the ROI content 146 and the masked image frame 144.

With reference to FIGS. 10C, 10D, 10E, and 10F, the decoder 1038 includes a parser/transformer 1004 and a reconstructor 1006. The parser/transformer 1004, such as a bitstream parser or an inverse transformer, is configured to parse the encoded output data 162 to identify the content protection data 164 and the encoded data 710 included in the encoded output data 162. The reconstructor 1006 is configured to reconstruct (e.g., decode) the encoded data 710 to obtain the masked image frame 144, the encrypted ROI content 148, the ROI segmentation frame 855, or a combination thereof.

Referring to FIG. 10C, the decoder 1038 is configured to provide the masked image frame 144 and the encrypted ROI content 148, based on the encoded output data 162, to the output generator 1022. The output generator 1022 outputs the masked image frame 144 as the output image frame 1040A based on a determination that the output generator does not include or have access to a private key to decrypt an encrypted version of the key 137. For example, the output generator 1022 may include a decryption controller 1025 that is configured to determine whether or not the output generator 1022 can decrypt the encrypted version of the key 137 to obtain the key 137. Based on a determination that the output generator 1022 is unable to obtain the key 137, the decryption controller 1025 passes through the masked image frame 144 as the output image frame 1040A and does not display or decrypt the encrypted ROI content 148.

Referring to FIG. 10D, the decoder 1038 is configured to provide the masked image frame 144 and the encrypted ROI content 148, based on the encoded output data 162, to the output generator 1022. The decryption controller 1025 may determine that the output generator 1022 is able to obtain the key 137 based on an encrypted version of the key 137, which may be included in the output data 162. The output generator 1022 includes the decryptor 1024 and an ROI positioner 1086. The decryptor 1024 is configured to decrypt, based on the key 137, the encrypted ROI content 148 to obtain the ROI content 146 that is provided to the ROI positioner 1086. The ROI positioner 1086 is configured to combine the ROI content 146 with the masked image frame 144 to generate the output image frame 1040B. In some embodiments, the ROI positioner 1086 combines the ROI content 146 and the masked image frame 144 based on position data.

Referring to FIG. 10E, the decoder 1038 is configured to provide the masked image frame 144, the encrypted ROI content 148, and the ROI segmentation frame 855, based on the encoded output data 162, to the output generator 1022. The decryption controller 1025 may determine that the output generator 1022 is able to obtain the key 137 based on an encrypted version of the key 137 included in the output data 162. The output generator 1022 includes an ROI extractor and vectorizer 1021, the decryptor 1024, an ROI regenerator 1023, and the ROI positioner 1086. The ROI extractor and vectorizer 1021 is configured to, for each ROI included in or indicated by the ROI segmentation frame 855, perform a raster scan to generate an ROI vector 1095, such as a 1D vector.

The decryptor 1024 is configured to decrypt the ROI vector 1095 based on the key 137 to generate a decrypted ROI content that is provided to the ROI regenerator 1023. The decrypted ROI content may be a 1D vector. The ROI regenerator 1023 may generate ROI content based on the decrypted ROI content and the ROI segmentation frame 855. For example, the ROI regenerator 1023 may generate the ROI content in 2D based on the decrypted ROI content and the ROI segmentation frame 855. The ROI content is provided to the ROI positioner 1086 which is configured to combine the ROI content with the masked image frame 144 based on the ROI segmentation frame 855, such as by overwriting or replacing masked image pixels of a ROI in the masked image frame 144 with the ROI content from the ROI regenerator 1023, to generate the output image frame 1040C.

Referring to FIG. 10F, the output generator 1022 includes a decryption switch 1090 that is configured to selectively route decoded bitstream data for non-decryption output processing 1096 or for decryption output processing 1098. To illustrate, the decoder 1038 is configured to provide the masked image frame 144, the encrypted ROI content 148, and the ROI segmentation frame 855, based on the encoded output data 162, to the output generator 1022. The decryption controller 1025 may determine whether or not the output generator 1022 is able to obtain the key 137 based on an encrypted version of the key 137 included in the output data 162, and to control the decryption switch 1090 accordingly. In a particular embodiment, the decryption switch is configured to perform one or more of the operations 1080 of FIG. 10B.

The decryption output processing 1098 includes an ROI extraction and vectorization of the encrypted ROI content 148 at the ROI extractor and vectorizer 1021, decryption of the ROI vector 1095 at the decryptor 1024, generation of the ROI content, at the ROI regenerator 1023, based on the decrypted ROI vector and the ROI segmentation frame 855, and combining the ROI content with the masked image frame 144 based on the ROI segmentation frame 855, at the ROI positioner 1086, to generate an output image frame 1040D that includes the sensitive content without masking, in a similar manner as described with reference to FIG. 10E. In contrast, the non-decryption output processing 1096 includes processing the masked image frame 144 to generate an output image frame 1040D that has masked ROI portions, or may be a pass-through of the masked image frame 144 as the output image frame 1040D without additional processing, in a similar manner as described with reference to FIG. 10C.

FIG. 11 is a block diagram of an example of a system 1100 to manage one or more content encryption configurations, in accordance with one or more aspects of the present disclosure. The system 1100 includes a device 1102 that is configured to or is operable to encrypt and/or decrypt media content. In some embodiments, the device 1102 includes or corresponds to the device 102 or 1002, or the protection device 550.

The device 1102 includes, or is coupled to, the memory 106 (e.g., a memory device), the processor 108, an image sensor 1112, an input device 1114, a display device 1116, a speaker 1117, and a modem 1118. The memory 106 may include one or more memory devices, such as a single memory or multiple different memory devices (of the same type or of different types).

The memory 106 is configured to store the instructions 109 and the content encryption configuration 130. The instructions 109, when executed by the processor 108, cause the processor 108 to perform one or more operations as described herein. The content encryption configuration 130 may include or correspond to the entry 221, 242, 263, 284, 285, 411, or 452, or the content encryption configuration 580. The content encryption configuration 130 may include the object class 107 and the key 104. In some examples, the memory 106 stores other information or data, such as media content. The media content can include or indicate audio content, video content, or a combination thereof. In some examples, the stored media content includes at least an encrypted portion.

The processor 108 includes a protection controller 1110, a media generator 1120, an encoder 1128, and a decoder 1138. Each of the protection controller 1110, the media generator 1120, the encoder 1128, and the decoder 1138, or a portion thereof, may be implemented by the processor 108 executing instructions (e.g., software), dedicated hardware (e.g., circuitry), or a combination thereof. The protection controller 1110, the media generator 1120, the encoder 1128, and the decoder 1138 may include or correspond to the protection controller 110 or 1010, the media generator 120 or 1020, the encoder 128, and the decoder 1038, respectively. It is noted that although the device 1102 is described as including both the encoder 1128 and the decoder 1138, in other embodiments, the device 1102 may include one of the encoder 1128 or the decoder 1138, and not the other. For example, the device 1102 may include the encoder 1128 and not the decoder 1138, such that the device 1102 is configured to encrypt and/or encode at least a portion of media content. As another example, the device 1102 may include the decoder 1138 and not the encoder 1128, such that the device 1102 is configured to decode and/or decrypt encoded media content. Additionally, or alternatively, the processor 108 of the device 1102 may be configured to perform one or more operations to maintain the content encryption configuration 130, such as one or more operations as described at least with reference to FIGS. 1 or 4.

The modem 1118 is coupled to the processor 108 and is configured to transmit or receive media content (e.g., the encoded output data 162). For example, the modem 1118 may transmit the media content to a second device, or receive the media content from the second device.

In some embodiments, the modem 1118 is configured to transmit or receive media content (e.g., the encoded output data 162). For example, the modem 1118 may transmit the media content to a second device, or receive the media content from the second device. In some embodiments, the modem 1118 includes or corresponds to an interface configured to receive the encoded output data 162 and provide the encoded output data 162 to the processor 108. In some examples, the interface includes a wired interface, such as a bus interface, a wired network interface, a cable interface, or a combination thereof. In some other examples, the interface includes a wireless interface, such as a wireless transceiver, a cellular modem, a Wi-Fi interface, a Bluetooth interface, or a combination thereof. In some embodiments, the interface may include or correspond to the interface described with reference to the device 1002 of FIG. 10A, and the processor 108 (e.g., the decoder 1138) is configured to generate an output image frame 1040 based on the encoded output data 162 in a manner similar to that described with reference to FIGS. 10A-10F.

The processor 108 is also coupled to an image sensor 1112, an input device 1114 (e.g., a microphone, a keyboard or touch screen, etc.), a display device 1116, and a speaker 1117. The image sensor 1112 may include one or more cameras and may be configured to generate input media data, such as the image data 140 or the input image frame 142. Video content, such as the encoded output data 162, may be generated by the processor 108 at least partially based on the input media data.

The input device 1114 is configured to receive an input and provide the input to the processor 108 as input data 1115. For example, the input device 1114 may include a keyboard, a touch screen, or a microphone configured to receive the input and provide the input data 1115 (e.g., an input signal) to the processor 108. The input data 1115 may indicate to store, modify, or remove an entry at the content encryption configuration 130, generate image data 140, store or transmit the encoded output data 162, decode and/or decrypt the encoded output data 162, or present the encoded output data 162 or the output image frame 1040. In some implementations, the image sensor 1112 (e.g., one or more cameras) may generate the image data 140 based on (or in response to) the input data 1115.

The display device 1116 is coupled to the processor 108 and is configured to output the output image frame 1040 generated based on the encoded output data 162. For example, the display device 1116 may output display data based on the output image frame 1040 (e.g., output media data). In some examples, the display device 1116 includes a display screen, a monitor or television, a projector, or a combination thereof. In some embodiments, the device 1102 (e.g., the processor 108) is configured to output audio associated with the output image frame 1040 (e.g., video content). The speaker 1117 is coupled to the processor 108 and is configured to output audio associated with associated with the output image frame 1040 (e.g., video content).

The image sensor 1112, the input device 1114, the display device 1116, the speaker 1117, or a combination there may be coupled to or integrated within the device 1102. Although the device 1102 is described as being coupled to or including the image sensor 1112, the input device 1114, the display device 1116, the speaker 1117, and the modem 1118, in other embodiments, one or more of these elements are optional, and in such embodiments, the device 1102 may not include or be coupled to the image sensor 1112, the input device 1114, the display device 1116, the speaker 1117, the modem 1118, or a combination thereof.

During operation of the system 1100, the processor 108 may perform one or more operations to identify and encrypt media content. For example, the processor 108 may use the protection controller 1110, the media generator 1120, and the encoder 1128 to perform one or more operations as described herein at least with reference to FIGS. 1-9E to identify and encrypt media content. Additionally, or alternatively, during operation of the system 1100, the processor 108 may perform one or more operations to decrypt media content. For example, the processor 108 may use the protection controller 1110, the media generator 1120, and the decoder 1138 to perform one or more operations as described herein at least with reference to FIGS. 10A-10F to process or decrypt media content that is encrypted.

In some embodiments, a device (e.g., the device 1102) includes a memory (e.g., the memory 106) and one or more processors (e.g., the processor 108). The memory is configured to store one or more content encryption configuration entries (e.g., the content encryption configuration 130). At least one content encryption configuration entry of the one or more content encryption configuration entries indicates a respective object class (e.g., the object class 107) and a respective key (e.g., the key 104). The one or more processors are configured to maintain the one or more content encryption configuration entries at the memory.

In some examples, the device 1102 corresponds to or is included in one of various types of devices, such that the processor 108 can be integrated in multiple types of devices. In an illustrative example, the processor 108 is integrated in a wearable electronic device as depicted in FIG. 14, a virtual reality, mixed reality, or augmented reality headset as depicted in FIG. 17, a mixed reality or augmented reality glasses device as described with reference to FIG. 18, or another wearable device. In another illustrative example, the processor 108 is integrated in a mobile device (a mobile phone or a tablet computer) as depicted in FIG. 13, a voice-controlled speaker system as depicted in FIG. 15, a camera as depicted in FIG. 16, a vehicle as depicted in FIGS. 19 or 20, a computer (e.g., a laptop computer) or a server, or another system or device.

FIG. 12 depicts a diagram of an example of an integrated circuit 1200 operable to manage one or more content encryption configurations, in accordance with some examples of the present disclosure. The integrated circuit 1200 includes one or more processors 1208 (herein after referred to as the “processor 1208”) and a memory 1206. The processor 1208 and the memory 1206 may include or correspond to the processor 108 and the memory 106, respectively. The processor 1208 may include a protection controller 1210, a media generator 1220, an encoder 1228, a decoder 1229, or a combination thereof. The protection controller 1210, the media generator 1220, the encoder 1228, and the decoder 1229 may include or correspond to the protection controller 110, 1010, or 1110, the media generator 120, 1020, or 1120, the encoder 128 or 1128, and the decoder 1038 or 1138, respectively. The memory 1206 includes (e.g., stores) content encryption configuration 1230. The content encryption configuration 1230 may include or correspond to the content encryption configuration 130, an entry 221, 242, 263, 284, 285, 411, or 452, the content encryption configuration 580, or a combination thereof.

The integrated circuit 1200 also includes an input interface 1204, such as one or more bus interfaces, to enable the integrated circuit 1200 to receive signals that represent input data 1270 for processing. For example, the input data 1270 can correspond to or include the content encryption configuration 130, the image data 140, the input image frame 142, the contextual data 132, the content protection indicator 135, the output data 160, the encoded output data 162, the request 401, 431, 441, 461, 481, or 491, the encryption request 590, the update 592, the notification 594, the content encryption configuration 1230, or a combination thereof. In some embodiments, the input interface 1204 is configured to receive the encoded output data 162 and provide the encoded output data 162 to the processor 1208 (e.g., the decoder 1229). In some examples, the input interface 1204 includes a wired interface, such as a bus interface, a wired network interface, a cable interface, or a combination thereof. In some other examples, the input interface 1204 includes a wireless interface, such as a wireless transceiver, a cellular modem, a Wi-Fi interface, a Bluetooth interface, or a combination thereof. In some embodiments, the input interface 1204 may include or correspond to the interface described with reference to the device 1002 of FIG. 10A or the interface described with reference to the device 1102 of FIG. 11, and the processor 1208 (e.g., the decoder 1229) is configured to generate an output image frame 1040 based on the encoded output data 162 in a manner similar to that described with reference to FIGS. 10A-10F.

The integrated circuit 1200 also includes an output interface 1205, such as a bus interface, to enable the integrated circuit 1200 to output signals that represent output data 1272. For example, the output data 1272 can correspond to or include the content encryption configuration 130, the image data 140, the input image frame 142, the contextual data 132, the content protection indicator 135, the output data 160, the encoded output data 162, the request 401, 431, 441, 461, 481, or 491, the encryption request 590, the update 592, the notification 594, the output image frame 1040, the content encryption configuration 1230, or a combination thereof.

The integrated circuit 1200 including protection controller 1210, the media generator 1220, the encoder 1228, the decoder 1229, the content encryption configuration 130, or a combination thereof, enables management of the content encryption configuration 1230, which supports implementation of encryption or decryption of media content as a component in a system or a device. For example, the system or the device may include a mobile device (e.g., a mobile phone or tablet) as depicted in FIG. 13, a wearable electronic device as depicted in FIG. 14, a voice-controlled speaker system as depicted in FIG. 15, a camera as depicted in FIG. 16, a virtual reality, mixed reality, or augmented reality headset as depicted in FIG. 17, a mixed reality or augmented reality glasses device, as described with reference to FIG. 18, or a vehicle as depicted in FIGS. 19 or 20.

In some embodiments, the system or the device that includes the integrated circuit 1200 also includes or is coupled to an image sensor (e.g., a camera), an input device (e.g., a microphone, a keyboard or touch screen, etc.), a display device, a speaker, a modem, or a combination thereof. For example, the image sensor, the input device, the display device, the speaker, and the modem may include or correspond to the image sensor 1112, the input device 1114, the display device 1116, the speaker 1117, and the modem 1118, respectively.

In some embodiments, the system or the device that includes the integrated circuit 1200 is operable to store and maintain the content encryption configuration 1230. Additionally, or alternatively, the system or the device that includes the integrated circuit 1200 is operable to generate or implement a request or an update associated with the content encryption configuration 1230. For example, the system or the device that includes the integrated circuit 1200 is operable to generate the encryption request 590, the update 592, or a combination thereof. In some embodiments, the system or the device that includes the integrated circuit 1200 is operable to encrypt, based on content encryption configuration 1230, a portion of the input media data that includes an instance of an object class to generate encrypted media data. In some embodiments, the system or the device that includes the integrated circuit 1200 is operable to obtain output media data that includes encrypted media data including an encrypted portion of media data. The encrypted portion of the media data is associated with an object class. The system or the device that includes the integrated circuit 1200 is further operable to decrypt, based on content encryption configuration 1230, the encrypted portion of the media data to obtain a portion of the media data.

FIG. 13 depicts a diagram of a mobile device 1300 operable to manage one or more content encryption configurations, in accordance with some examples of the present disclosure. The mobile device 1300 may include or correspond to a phone or a tablet computer device, as illustrative, non-limiting examples. The mobile device 1300 includes a camera 1302 (e.g., an image sensor), a display 1304 (e.g., a display screen), a microphone 1306, a speaker 1308, and the integrated circuit 1200. Components of the integrated circuit 1200, including the protection controller 1210, the media generator 1220, the encoder 1228, the decoder 1229, or a combination thereof, are integrated in the mobile device 1300 and are illustrated using dashed lines to indicate internal components that are not generally visible to a user of the mobile device 1300.

FIG. 14 depicts a diagram of a wearable electronic device 1400 operable to manage one or more content encryption configurations, in accordance with some examples of the present disclosure. The wearable electronic device 1400 may include or correspond to a “smart watch,” as an illustrative, non-limiting example. The wearable electronic device 1400 includes a camera 1402 (e.g., an image sensor), a display 1404 (e.g., a display screen), a microphone 1406, a speaker 1408, and the integrated circuit 1200. Components of the integrated circuit 1200, including the protection controller 1210, the media generator 1220, the encoder 1228, the decoder 1229, or a combination thereof, are integrated in the wearable electronic device 1400 and are illustrated using dashed lines to indicate internal components that are not generally visible to a user of the wearable electronic device 1400.

FIG. 15 is a diagram of a voice-controlled speaker system 1500 operable to manage one or more content encryption configurations, in accordance with some examples of the present disclosure. The voice-controlled speaker system 1500 may include or correspond to a wireless speaker and voice activated device, as an illustrative, non-limiting example. The voice-controlled speaker system 1500 can have wireless network connectivity and is configured to execute an assistant operation. The voice-controlled speaker system 1500 includes a camera 1502 (e.g., an image sensor), a display 1504 (e.g., a display screen), a microphone 1506, a speaker 1508, and the integrated circuit 1200. Components of the integrated circuit 1200, including the protection controller 1210, the media generator 1220, the encoder 1228, the decoder 1229, or a combination thereof, are integrated in the voice-controlled speaker system 1500 and are illustrated using dashed lines to indicate internal components that are not generally visible to a user of the voice-controlled speaker system 1500.

FIG. 16 is a diagram of a camera device 1600 operable to manage one or more content encryption configurations, in accordance with some examples of the present disclosure. The camera device 1600 includes an image sensor 1602, a display 1604 (e.g., a display screen), a microphone 1606, a speaker 1608, and the integrated circuit 1200. Components of the integrated circuit 1200, including the protection controller 1210, the media generator 1220, the encoder 1228, the decoder 1229, or a combination thereof, are integrated in the camera device 1600 and are illustrated using dashed lines to indicate internal components that are not generally visible to a user of the camera device 1600.

FIG. 17 is a diagram of a headset 1700, such as a virtual reality, mixed reality, or augmented reality headset, operable to manage one or more content encryption configurations, in accordance with some examples of the present disclosure. A visual interface device is positioned in front of the user's eyes to enable display of augmented reality, mixed reality, or virtual reality images or scenes to the user while the headset 1700 is worn. The headset 1700 also includes a camera 1702 (e.g., an image sensor), a display 1704 (e.g., a display screen), a microphone 1706, a speaker 1708, and the integrated circuit 1200. Components of the integrated circuit 1200, including the protection controller 1210, the media generator 1220, the encoder 1228, the decoder 1229, or a combination thereof, are integrated in the headset 1700 and are illustrated using dashed lines to indicate internal components that are not generally visible to a user of the headset 1700.

FIG. 18 is a diagram of a mixed reality or augmented reality glasses device 1800 operable to manage one or more content encryption configurations, in accordance with some examples of the present disclosure. The glasses 1800 include a holographic projection unit 1804 configured to project visual data onto a surface of a lens 1805 or to reflect the visual data off of a surface of the lens 1805 and onto the wearer’s retina. The glasses 1800 also include a camera 1802 (e.g., an image sensor), a microphone 1806, one or more speakers 1808, and the integrated circuit 1200. Components of the integrated circuit 1200, including the protection controller 1210, the media generator 1220, the encoder 1228, the decoder 1229, or a combination thereof, are integrated in the glasses 1800 and are illustrated using dashed lines to indicate internal components that are not generally visible to a user of the glasses 1800.

FIG. 19 is a diagram of a first example of a vehicle 1900 operable to manage one or more content encryption configurations, in accordance with some examples of the present disclosure. The vehicle 1900 may include or correspond to a manned or unmanned aerial device (e.g., a package delivery drone). The vehicle 1900 includes a camera 1902 (e.g., an image sensor), a display 1904 (e.g., a display screen), a microphone 1906, a speaker 1908, and the integrated circuit 1200. Components of the integrated circuit 1200, including the protection controller 1210, the media generator 1220, the encoder 1228, the decoder 1229, or a combination thereof, are integrated in the vehicle 1900 and are illustrated using dashed lines to indicate internal components that are not generally visible to a user of the vehicle 1900.

FIG. 20 is a diagram of a second example of a vehicle 2000 operable to manage one or more content encryption configurations, in accordance with some examples of the present disclosure. The vehicle 2000 may include or correspond to a car. The vehicle 2000 includes a camera 2002 (e.g., an image sensor), a display 2004 (e.g., a display screen), a microphone 2006, one or more speakers 2008, and the integrated circuit 1200. Components of the integrated circuit 1200, including the protection controller 1210, the media generator 1220, the encoder 1228, the decoder 1229, or a combination thereof, are integrated in the vehicle 2000 and are illustrated using dashed lines to indicate internal components that are not generally visible to a user of the vehicle 2000.

Although the examples of the vehicle of FIGS. 19 and 20 are describe an aerial device and a car, respectively, in other examples, the vehicle can correspond to an aircraft (such as a fixed wing aircraft, a rotary wing aircraft, an aerostat, a hybrid aircraft, spaceship, or another type of aircraft), a land craft (such as a car, a truck, or another type of land craft), or a watercraft (such as a boat, a submersible, a ship, a barge, a ferry, or another type of watercraft). Further, the watercraft, the aircraft, the land craft, or watercraft can be manned or unmanned (e.g., crewed or uncrewed).

In a particular example of one or more of the devices of FIGS. 13-20, the integrated circuit 1200 (e.g., the processor 1208 and/or the memory 1206) is operable to store and manage the content encryption configuration 1230. To illustrate, the integrated circuit 1200 (e.g., the processor 1208) may add, modify, or remove one or more content encryption configurations (e.g., one or more content encryption configuration entries) associated with the content encryption configuration 1230 stored at the memory 1206. Additionally, or alternatively, the integrated circuit 1200 (e.g., the processor 1208) may generate, send, and/or implement a request (e.g., the encryption request 590) or an update (e.g., the update 592) associated with the content encryption configuration 1230.

In a particular example of one or more of the devices of FIGS. 13-20, the integrated circuit 1200 (e.g., the media generator 1220 and the encoder 1228) is operable to generate media data (e.g., the encoded output data 162). To illustrate, the media generator 1220 may detect, in accordance with the content encryption configuration 1230, an instance of the object class 107 included in media content. For example, based on the media content received from a camera or a speaker of the device, the media generator 1220 can detect the instance of the object class 107 and generate the masked image frame 144, the encrypted ROI content 148, or a combination thereof. Additionally, the encoder 1228 generates the encoded output data 162, such as a bitstream, that includes or indicates the masked image frame 144, the encrypted ROI content 148, the indicator 707, or a combination thereof. The encoded output data 162 may be stored at the memory 1206, sent to another device via a modem coupled to the integrated circuit 1200, output via a display or speaker of the one or more devices of FIGS. 11 or 13-20 , or a combination thereof.

In a particular example of one or more of the devices of FIGS. 13-20, the integrated circuit 1200 (e.g., the media generator 1220 and the decoder 1229) is operable to, based on the content encryption configuration 1230, selectively decode the encoded output data 162 and decrypt the encrypted ROI content 148. For example, the decoder 1229 may receive and decode the encoded output data 162. The media generator 1220 can decrypt the encrypted ROI content 148 based on the key 137 and then combine the decrypted ROI content (e.g., the ROI content 146) with the masked image frame 144 to thereby obtain the input image frame 142 (e.g., an original input image frame). The obtained input image frame 142 (e.g., the original input image frame) may be stored at the memory 1206, sent to another device via a modem coupled to the integrated circuit 1200, output via a display or speaker of the one or more devices of FIGS. 11 or 13-20, or a combination thereof. It is noted that if the key 137 is unavailable to decrypt the encrypted ROI content 148, the masked image frame 144 may be displayed, or the encrypted ROI content 148 and the masked image frame 144 may be stored at the memory 1206.

One technical advantage of the integrated circuit 1200 (e.g., the protection controller 1210 and/or the media generator 1220) implemented by the one or more devices of FIGS. 13-20 as described above is that sensitive content (partial video) included in the input image frame 142 may be selectively encrypted. Another technical advantage of the integrated circuit 1200 (e.g., the media generator 1220) implemented by the one or more devices of FIGS. 13-20 as described above is that automatic sensitive content (partial video) encryption may be performed on the input image frame 142, such as when the video is captured for the first time. The partial video encryption can allow for storage, transmission, and playback using the same encoded output data 162 (e.g., the same encrypted bitstream) both where access to encrypted ROI content 148 is authorized (e.g., playback includes unencrypted sensitive content) and where access to the encrypted ROI content 148 is non-authorized (e.g., playback includes a masked version of the sensitive content).

The embodiments of the systems or devices as described with reference to FIGS. 13-20 are described, respectively, as including a display, a microphone, a speaker, a camera, or a combination thereof. As described with reference to FIGS. 13-20, the display, the microphone, the speaker, and the camera may include or correspond to the display device 1116, the input device 1114, the speaker 1117, and the image sensor 1112, respectively. It is noted that in other embodiments of the systems or devices of FIGS. 13-20, one or more of the systems or devices of FIGS. 13-20 may not include the display, the microphone, the speaker, the camera, or a combination thereof. Additionally, or alternatively, one or more of the systems or devices of FIGS. 13-20 may include an additional component. For example, the additional component may include a modem, such as the modem 1118.

FIG. 21 is a diagram of an example of a method 2100 of management of one or more content encryption configurations, in accordance with some aspects of the present disclosure. In a particular aspect, one or more operations of the method 2100 are performed by the system 100, 500, 1000, or 1100, the device 102, 1002, or 1102, the processor 108, 558, or 1208, the protection controller 110, 1010, 1110, 1210, or 2280, the media generator 120, 1020, 1120, 1220, or 2281, the protection device 550, the integrated circuit 1200, the mobile device 1300, the wearable electronic device 1400, the voice-controlled speaker system 1500, the camera device 1600, the headset 1700, the glasses 1800, the vehicle 1900 or 2000, or a combination thereof.

In some embodiments, the method 2100 includes, at block 2102, storing, at a memory, one or more content encryption configuration entries. For example, the memory may include or correspond to the memory 106, 556, or 1206. The one or more content encryption configuration entries may include or correspond to the content encryption configuration 130 or 580, the entry 221, 242, 263, 284, 285, 411, or 452, or a combination thereof. A first content encryption configuration entry of the one or more content encryption configuration entries is associated with a first content encryption configuration and indicates a first object class indicating a first object to be detected based on input media data. The first object class may include or correspond to the object class 107, 207, or 557. In some embodiments, the first object class includes a document, a whiteboard, a poster, a computer screen, a display device, a person, a human face, a body part, an animal, an address, a street name, a weapon, a type of weapon, or a combination thereof. Additionally, or alternatively, the first object class includes a vehicle, a type of vehicle, a vehicle manufacturer, a vehicle model, a vehicle license plate, or a combination thereof. In some other embodiments, the object class includes all content of the input media data. The input media data may include or correspond to the image data 140 or the input image frame 142. The input media data may include image data, audio data, or a combination thereof. In some examples, the input media data represents an image frame. In some embodiments, the method 2100 includes obtaining the input media data. The first key may be associated with the first object class.

The first content encryption configuration entry also indicates a first key associated with the first object class. The first key may include or correspond to the key 104, 137, 210, or 554. In some implementations, the first key can include a first public key configured to encrypt a first encryption key, the first encryption key configured to encrypt an instance of the first object class detected within input media data, a first private key configurated to decrypt an encrypted version of the first encryption key, a decryption key configured to decrypted an encrypted version of the instance of the first object class, or a combination thereof.

In some embodiments, the first content encryption configuration entry of the one or more content encryption configuration entries indicates a first encryption condition, a first status of the first content encryption configuration entry, a first source associated with the first content encryption configuration entry, a first model associated with the first object class of the first content encryption configuration entry, or a combination thereof. For example, the first encryption condition, the first status, the first source, and the first model may be associated with or correspond to the condition 228, the status 229, the source 230, and the model 231, respectively. The first encryption condition may indicate to encrypt the first object class based on a physical space, an environment, an object, or a combination thereof. The first status may indicate an active status or an inactive status. The first source can indicate a user, a contact, an agent, an entity, or a regulation. The first model may be configured to enable detection of an instance of the first object class.

In some such embodiments, the method 2100 includes obtaining the first content encryption configuration that indicates a first object class and a first key. The method 2100 may also include storing the first content encryption configuration at the memory as the first content encryption configuration entry of the one or more content encryption configuration entries. In some embodiments, the one or more content encryption configuration entries further includes a second content encryption configuration entry associated with a second content encryption configuration. Additionally, or alternatively, the method 2100 includes obtaining the second content encryption configuration that indicates a second object class and a second key, and storing the second content encryption configuration at the memory as a second configuration entry of the one or more content encryption configuration entries.

At block 2104, the method 2100 also includes maintaining the one or more content encryption configuration entries at the memory. Maintaining the one or more content encryption configuration entries includes receiving an update associated with the first content encryption configuration. For example, the update may include or correspond to the update 592 or the input data 1115. The update may indicate to modify the first content encryption configuration entry. Maintaining the one or more content encryption configuration entries also includes modifying, based on the update, the first content encryption configuration entry to generate an updated first content encryption configuration entry. For example, based on the update, the method 2100 may include modifying the first content encryption configuration entry to change the first object class, the first key, the first status, the first encryption condition, the first model, or a combination thereof, of the first content encryption configuration entry that correspond to the first content encryption configuration.

In some embodiments, the method 2100 can also include adding at least one content encrypt configuration entry to the one or more content encryption configuration entries or removing at least one content encryption configuration entry from the one or more content encryption configuration entries. For example, the method 2100 can include receiving a request to add the at least one content encryption configuration (e.g., to at a content encryption configuration entry corresponding to the at least one content encryption configuration). As another example, the method 2100 can include receiving a request to remove a content encryption configuration (or a content encryption configuration entry that corresponds to the content encryption configuration). For example, the request to remove the content encryption configuration may be a request to remove the first content encryption configuration and the method 2100 may include removing the first content encryption configuration entry or, in the event that the update has already been implemented, the updated first content encryption configuration encryption entry.

In some embodiments, to obtain the first content encryption configuration, the method 2100 includes receiving a user input, such as the input data 1115. In other embodiments, to obtain the first content encryption configuration, the method 2100 includes receiving, from a protection device, a content encryption configuration request that indicates the first content encryption configuration. For example, the protection device and the content encryption configuration request may include or correspond to the protection device 550 and the encryption request 590, respectively. The protection device may be associated with an entity, a service provider, or a contact of a user associated with a device that received the content encryption configuration request. In some such embodiments, to receive the content encryption configuration request, the method 2100 includes receiving a broadcast message from the protection device, and the broadcast message indicates the content encryption configuration request.

In some embodiments, the method 2100 includes generating a content encryption configuration request that indicates the first content encryption configuration. For example, the content encryption configuration request may include or correspond to the encryption request 590. In some such embodiments, the method 2100 may also include sending the content encryption configuration request to a user device. For example, the content encryption configuration request may be sent as a broadcast message.

In some embodiments, the method 2100 includes receiving a request to obtain the input media data. For example, the request may include or correspond to the input data 1115. The method 2100 may also include selecting a first content encryption configuration entry, such as the content encryption configuration 130 or one of the entries 221, 242,263,284, 284, 411, or 452. Additionally, or alternatively, the method 2100 includes obtaining a first encryption key or encryption value for the first object class of the first content encryption configuration entry. For example, the first encryption key may include or correspond to the key 137. The method 2100 can also include configuring an object detector to detect the first object class within the input media data. The object detector may include or correspond to the ROI identifier 121 or the ROI detector 810. Additionally, or alternatively, the method 2100 can include configuring an encryptor to encrypt, based on the first encryption key, a portion of the input media data. The portion may include the first object class and the encrypted portion of the input media data may be first encrypted media data. For example, the encryptor may include or correspond to the encryptor 124.

In some embodiments, the method 2100 further includes encrypting a portion of the input media data that includes an instance of the first object class to generate encrypted media data. The encrypted media data may include or correspond to the encrypted ROI content 148, the encoded encrypted ROI content 718, or the encrypted ROI frame 648 or 836.

The method 2100 may also include detecting the instance of the first object class within input media data. Additionally, or alternatively, the method 2100 includes generating output media data that includes the encrypted media data. The output media data may include or correspond to the masked image frame 144 or 644, the encrypted ROI content 148 or 832, the encrypted ROI frame 648, the output data 160, the encoded output data 162, the content protection data 164, the encoded masked image frame 714, the encoded encrypted ROI content 718, the encoded segmentation frame 755, the encrypted ROI frame 836, or the ROI segmentation frame 855.

In some embodiments, the output media data includes an indicator. For example, the indicator may include or correspond to the indicator 707. The indicator may indicate an encryption/decryption key, the encrypted media data, a content encryption configuration, the first object class, a device identifier or a user of the device, or a combination thereof. In some embodiments, the output media data includes a bitstream. Additionally, or alternatively, the output media data may include content protection data. For example, the content protection data may include or correspond to the content protection data 164 or the content protection indicator 1035. The content protection data may be included in a header of the output media data, metadata of the output media data, or a combination thereof. In some examples, the content protection data includes the indicator.

In some embodiments, the method 2100 includes obtaining a key, such as the first key, for the first object class. For example, the key may include or correspond to the key 137. The portion of the input media data may be encrypted based on the key. In some embodiments, the key includes a random key. The content encryption configuration may indicate the key and the key may be obtained from the content encryption configuration. Additionally, or alternatively, the key may be generated for the first object class indicated by the content encryption configuration. For example, the key can be generated based on a determination that the content encryption configuration is active. In other embodiments, the key, such as the first key, is a public key that is configured to be used to encrypt an encryption key used to encrypt the portion of the input media data that includes the instance of the first object class.

In some embodiments, the method 2100 includes masking the portion of the input media data to generate a masked version of the input media data. The masked version of the input media data may include or correspond to the masked image frame 144 or 644 or the encoded masked image frame 714. In some embodiments, the output media data includes the masked version of the input media data.

In some embodiments, the method 2100 includes generating, based on the input media data and detection of the first object class, segmentation data. For example, the segmentation may include or correspond to the encoded segmentation frame 755, the ROI segmentation frame 855, or a combination thereof. In some such embodiments, the output media data includes the segmentation data. Additionally, the output media data may include a non-display indicator associated with the segmentation data. In some embodiments, the method 2100 includes combining the segmentation data, the encrypted media data, and the masked version of the input media data to generate the combined media data. The combined media data may include or correspond to the output data 160. To combine the segmentation data, the encrypted media data, and the masked version of the input media data, the method 2100 can include concatenating together the segmentation data, the encrypted media data, and the masked version of the input media data to generate the combined media data. The method 2100 may include providing, to an encoder, the combined media data, one or more encoder settings, or a combination thereof. The encoder may include or correspond to the encoder 128, 1128, or 1128.

In some embodiments, the method 2100 includes obtaining the input media data. For example, to obtain the input media data, the method 2100 may include receiving or retrieving the input media data from a memory, such as the memory 106. In other embodiments, to obtain the input media data, the method 2100 may include receiving the input media data from a generation device, such as a camera, a microphone, or a combination thereof. For example, in some embodiments, the method 2100 includes generating, by one or more cameras, the input media data. The one or more cameras may include or correspond to the image sensor 1112. In some such embodiments, the method 2100 includes receiving, via an input device, an input and providing the input to a processor (e.g., the processor 108). For example, the input device and the input may include or correspond to the input device 1114 and the input data 1115, respectively. In some implementations, the input includes a request to generate the input media data. The method 2100 may include activating, based on the input data, the one or more cameras to generate the input media data.

In some embodiments, the method 2100 includes storing the output media data at a memory, such as the memory 106. Additionally, or alternatively, the method 2100 can include outputting, via a display device, display data based on the output media data. For example, the display device may include or correspond to the display device 1116.

In some embodiments, the method 2100 includes sending the output media data to a decoder device. Additionally, or alternatively, the method 2100 can include transmitting, via a modem, the output media data to a decoder device. For example, the modem may include or correspond to the modem 1118. The decoder device may include or correspond to the device 1002 or the decoder 1038 or 1138.

In some embodiments, the method 2100 includes receiving output media data that includes encrypted media data. The output media data may include or correspond to the masked image frame 144 or 644, the encrypted ROI content 148 or 832, the encrypted ROI frame 648, the output data 160, the encoded output data 162, the content protection data 164, the encoded masked image frame 714, the encoded encrypted ROI content 718, the encoded segmentation frame 755, the encrypted ROI frame 836, or the ROI segmentation frame 855. The method 2100 may also include decrypting, based on the one or more content encryption configuration entries, the encrypted media data.

The method 2100 of FIG. 21 may be implemented by a field-programmable gate array (FPGA) device, an application-specific integrated circuit (ASIC), a processing unit such as a central processing unit (CPU), a DSP, a controller, another hardware device, firmware device, or any combination thereof. As an example, the method 2100 of FIG. 21 may be performed by a processor that executes instructions, such as described with reference to FIG. 22.

It is noted that one or more blocks (or operations) described with reference to FIGS. 3, 4, 10B, and/or 21 may be combined with one or more blocks (or operations) described with reference to another of the figures. For example, one or more blocks (or operations) of FIG. 3 may be combined with one or more blocks (or operations) of FIGS. 4, 10B, or 21. As another example, one or more blocks (or operations) of FIG. 4 may be combined with one or more blocks (or operations) of FIGS. 10B or 21. As another example, one or more blocks (or operations) of FIG. 10B may be combined with one or more blocks (or operations) of FIG. 21. As another example, one or more blocks (or operations) of FIGS. 3, 4, 10B, and/or 21 may be combined with one or more blocks (or operations) of FIGS. 1, 8A, 10A, 11, or 12. As another example, one or more blocks associated with FIGS. 3, 4, 10B, and/or 21 may be combined with one or more blocks (or operations) associated with another of FIGS. 1-20. Additionally, or alternatively, one or more operations described above with reference to FIGS. 1-20 may be combined with one or more operations described with reference to FIG. 22.

Referring to FIG. 22, FIG. 22 is a block diagram of an illustrative example of a device 2200 that is operable to manage one or more content encryption configurations, in accordance with one or more aspects of the present disclosure. In various implementations, the device 2200 may have more or fewer components than illustrated in FIG. 22. In an illustrative implementation, the device 2200 may correspond to the device 102, 1002, or 1102, the protection device 550, the integrated circuit 1200, or a device of any of FIGS. 13-20. In an illustrative implementation, the device 2200 may perform one or more operations described with reference to FIGS. 1-21.

In a particular implementation, the device 2200 includes a processor 2206 (e.g., a central processing unit (CPU)). The device 2200 may include one or more additional processors 2210 (e.g., one or more DSPs). In a particular aspect, the processor 108 of FIG. 1, the processor 558 of FIG. 5, or the processor 1208 of FIG. 12 corresponds to the processor 2206, the processors 2210, or a combination thereof. The processors 2210 may include a speech and music coder-decoder (CODEC) 2208 that includes a voice coder (“vocoder”) encoder 2236, a vocoder decoder 2238, or a combination thereof. Additionally, or alternatively, the processors 2210 may include a protection controller 2280, a media generator 2281, an encoder 2282, a decoder 2283, or a combination thereof. The protection controller 2280 may include or correspond to the protection controller 110, 1010, 1110, or 1210. The media generator 2281 may include or correspond to the media generator 120, 1020, 1120, or 1220. The encoder 2282 may include or correspond to the encoder 128, 1128, or 1228. The decoder 2283 may include or correspond to the decoder 1038, 1138, or 1229.

In this context, the term “processor” refers to an integrated circuit consisting of logic cells, interconnects, input/output blocks, clock management components, memory, and optionally other special purpose hardware components, designed to execute instructions and perform various computational tasks. Examples of processors include, without limitation, central processing units (CPUs), digital signal processors (DSPs), neural processing units (NPU), graphics processing units (GPUs), field programmable gate arrays (FPGAs), microcontrollers, quantum processors, coprocessors, vector processors, other similar circuits, and variants and combinations thereof. In some cases, a processor can be integrated with other components, such as communication components, input/output components, etc. to form a system on a chip (SOC) device or a packaged electronic device.

Taking CPUs as a starting point, a CPU typically includes one or more processor cores, each of which includes a complex, interconnected network of transistors and other circuit components defining logic gates, memory elements, etc. A core is responsible for executing instructions to, for example, perform arithmetic and logical operations. Typically, a CPU includes an Arithmetic Logic Unit (ALU) that handles mathematical operations and a Control Unit that generates signals to coordinate the operation of other CPU components, such as to manage operations a fetch-decode-execute cycle.

CPUs and/or individual processor cores generally include local memory circuits, such as registers and cache to temporarily store data during operations. Registers include high-speed, small-sized memory units intimately connected to the logic cells of a CPU. Often registers include transistors arranged as groups of flip-flops, which are configured to store binary data. Caches include fast, on-chip memory circuits used to store frequently accessed data. Caches can be implemented, for example, using Static Random-Access Memory (SRAM) circuits.

Operations of a CPU (e.g., arithmetic operations, logic operations, and flow control operations) are directed by software and firmware. At the lowest level, the CPU includes an instruction set architecture (ISA) that specifies how individual operations are performed using hardware resources (e.g., registers, arithmetic units, etc.). Higher level software and firmware is translated into various combinations of ISA operations to cause the CPU to perform specific higher-level operations. For example, an ISA typically specifies how the hardware components of the CPU move and modify data to perform operations such as addition, multiplication, and subtraction, and high-level software is translated into sets of such operations to accomplish larger tasks, such as adding two columns in a spreadsheet. Generally, a CPU operates on various levels of software, including a kernel, an operating system, applications, and so forth, with each higher level of software generally being more abstracted from the ISA and usually more readily understandable by human users.

GPUs, NPUs, DSPs, microcontrollers, coprocessors, FPGAs, ASICS, and vector processors include components similar to those described above for CPUs. The differences among these various types of processors are generally related to the use of specialized interconnection schemes and ISAs to improve a processor’s ability to perform particular types of operations. For example, the logic gates, local memory circuits, and the interconnects therebetween of a GPU are specifically designed to improve parallel processing, sharing of data between processor cores, and vector operations, and the ISA of the GPU may define operations that take advantage of these structures. As another example, ASICs are highly specialized processors that include similar circuitry arranged and interconnected for a particular task, such as encryption or signal processing. As yet another example, FPGAs are programmable devices that include an array of configurable logic blocks (e.g., interconnect sets of transistors and memory elements) that can be configured (often on the fly) to perform customizable logic functions.

The device 2200 may include a memory 2286 and a CODEC 2234. The memory 2286 may include or correspond to the memory 106, 556, or 1206. The memory 2286 may include instructions 2256, that are executable by the one or more additional processors 2210 (or the processor 2206) to implement the functionality described with reference to the protection controller 2280, the media generator 2281, the encoder 2282, the decoder 2283, or a combination thereof. The instructions 2256 may include or correspond to the instructions 109 or the instructions 559. The memory 2286 also may include content encryption configuration data 2257. The content encryption configuration data 2257 may include or correspond to the content encryption configuration 130 or one or more of the entries 221, 242, 263, 284, 285, 411, or 452. The device 2200 may include a modem 2270 coupled, via a transceiver 2250, to an antenna 2252. The modem 2270 may include or correspond to the modem 1118.

In some embodiments, the device 2200 includes an interface configured to receive the encoded output data 162 and provide the encoded output data 162 to the processor 2206, the processors 2210 (e.g., the decoder 2283), or a combination thereof. In some examples, the interface includes a wired interface, such as a bus interface, a wired network interface, a cable interface, or a combination thereof. In some other examples, the interface includes a wireless interface, such as a wireless transceiver, a cellular modem, a Wi-Fi interface, a Bluetooth interface, or a combination thereof. In some embodiments, the interface includes or corresponds to the modem 2270, the transceiver 2250, or a combination thereof. In some examples, the interface may include or correspond to the interface described with reference to the device 1002 of FIG. 10A, the device 1102 of FIG. 11, or the integrated circuit 1200 of FIG. 12, and the decoder 2283 is configured to generate an output image frame 1040 based on the encoded output data 162 in a manner similar to that described with reference to FIGS. 10A-10F.

The device 2200 may include a display 2228 coupled to a display controller 2226. The display 2228 may include or correspond to the display device 1116. One or more speakers 2292, one or more microphone(s) 2294, or both, may be coupled to the CODEC 2234. The microphone(s) 2294 may include or correspond to the input device 1114. The CODEC 2234 may include a digital-to-analog converter (DAC) 2202, an analog-to-digital converter (ADC) 2204, or both. In a particular implementation, the CODEC 2234 may receive analog signals from the microphone(s) 2294, convert the analog signals to digital signals using the analog-to-digital converter 2204, and provide the digital signals to the speech and music codec 2208. The speech and music codec 2208 may process the digital signals, and the digital signals may further be processed by the protection controller 2280, the media generator 2281, the encoder 2282, the decoder 2283, or a combination thereof. In a particular implementation, the speech and music codec 2208 may provide digital signals to the CODEC 2234. The CODEC 2234 may convert the digital signals to analog signals using the digital-to-analog converter 2202 and may provide the analog signals to the speaker 2292. The speaker 2292 may include or correspond to the speaker 1117.

In a particular implementation, the device 2200 may be included in a system-in-package or system-on-chip device 2222. In a particular implementation, the memory 2286, the processor 2206, the processors 2210, the display controller 2226, the CODEC 2234, and the modem 2270 are included in the system-in-package or system-on-chip device 2222. In a particular implementation, an input device 2230, a power supply 2244, and a camera 2245 are coupled to the system-in-package or the system-on-chip device 2222. For example, the input device 2230 and the camera 2245 may include or correspond to the input device 1114 and the image sensor 1112, respectively. In some examples, the input device 2230 may include or be associated with the display device 1116 or the display 2228. Moreover, in a particular implementation, as illustrated in FIG. 22, the display 2228, the input device 2230, the speaker(s) 2292, the microphone(s) 2294, the antenna 2252, the power supply 2244, and the camera 2245 are external to the system-in-package or the system-on-chip device 2222. In a particular implementation, each of the display 2228, the input device 2230, the speaker(s) 2292, the microphone(s) 2294, the antenna 2252, the power supply 2244, and the camera 2245 may be coupled to a component of the system-in-package or the system-on-chip device 2222, such as an interface or a controller.

The device 2200 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, an earbud, a hearing aid, a car, a computing device, a communication device, an internet-of-things (IoT) device, a virtual reality (VR) device, a base station, a mobile device, or any combination thereof.

In conjunction with the described implementations, an apparatus includes means for storing one or more content encryption configuration entries. For example, the means for storing can include the system 100, 500, 1000, or 1100, the device 102, 1002, or 1102, the memory 106, 556, or 1206, the protection device 550, the integrated circuit 1200, the mobile device 1300, the wearable electronic device 1400, the voice-controlled speaker system 1500, the camera device 1600, the headset 1700, the glasses 1800, the vehicle 1900, the vehicle 2000, the memory 2286, the system-in-package or the system-on-chip device 2222, the device 2200, other circuitry configured to store the one or more content encryption configuration entries, or a combination thereof. A first content encryption configuration entry of the one or more content encryption configuration entries is associated with a first content encryption configuration and indicates a first object class indicating a first object to be detected based on input media data, and a first key associated with the first object class.

The apparatus also includes means for maintaining the one or more content encryption configuration entries at the means for storing. For example, the means for maintaining can include the system 100, 500, 1000, or 1100, the device 102, 1002, or 1102, the processor 108, 558, or 1208, the protection controller 110, 1010, 1110, 1210, or 2280, the media generator 120, 1020, 1120, 1220, or 2281, the protection device 550, the integrated circuit 1200, the mobile device 1300, the wearable electronic device 1400, the voice-controlled speaker system 1500, the camera device 1600, the headset 1700, the glasses 1800, the vehicle 1900, the vehicle 2000, the processor 2206, the processor(s) 2210, the system-in-package or the system-on-chip device 2222, the device 2200, other circuitry configured to maintain the one or more content encryption configuration entries, or a combination thereof. The means for maintaining includes means for receiving an update associated with the first content encryption configuration. For example, the means for receiving can include the system 100, 500, 1000, or 1100, the device 102, 1002, or 1102, the processor 108, 558, or 1208, the protection controller 110, 1010, 1110, 1210, or 2280, the media generator 120, 1020, 1120, 1220, or 2281, the protection device 550, the integrated circuit 1200, the mobile device 1300, the wearable electronic device 1400, the voice-controlled speaker system 1500, the camera device 1600, the headset 1700, the glasses 1800, the vehicle 1900, the vehicle 2000, the processor 2206, the processor(s) 2210, the system-in-package or the system-on-chip device 2222, the device 2200, the modem 2270, the transceiver 2250, the antenna 2252, other circuitry configured to receive the update, or a combination thereof. The means for maintaining includes means for modifying, based on the update, the first content encryption configuration entry to generate an updated first content encryption configuration entry. For example, the means for modifying can include the system 100, 500, 1000, or 1100, the device 102, 1002, or 1102, the memory 106, 1206, or 2286, the processor 108, 558, or 1208, the protection controller 110, 1010, 1110, 1210, or 2280, the media generator 120, 1020, 1120, 1220, or 2281, the protection device 550, the integrated circuit 1200, the mobile device 1300, the wearable electronic device 1400, the voice-controlled speaker system 1500, the camera device 1600, the headset 1700, the glasses 1800, the vehicle 1900, the vehicle 2000, the processor 2206, the processor(s) 2210, the system-in-package or the system-on-chip device 2222, the device 2200, other circuitry configured to modify the first content encryption configuration entry, or a combination thereof.

In some implementations, a non-transitory computer-readable medium (e.g., a computer-readable storage device, such as the memory 2286) includes instructions (e.g., the instructions 2256) that, when executed by one or more processors (e.g., the one or more processors 2210 or the processor 2206), cause the one or more processors to store, at a memory (e.g., the memory 2286), one or more content encryption configuration entries (e.g., the content encryption configuration data 2257). A first content encryption configuration entry of the one or more content encryption configuration entries is associated with a first content encryption configuration and indicates a first object class indicating a first object to be detected based on input media data, and a first key associated with the first object class. The instructions further cause the one or more processors to maintain the one or more content encryption configuration entries at the memory. To maintain the one or more content encryption configuration entries, the instructions are further executable by the one or more processors to cause the one or more processors to receive an update associated with the first content encryption configuration, and modify, based on the update, the first content encryption configuration entry to generate an updated first content encryption configuration entry.

Particular aspects of the disclosure are described below in sets of interrelated Examples:

According to Example 1, a device includes: a memory configured to store one or more content encryption configuration entries, a first content encryption configuration entry of the one or more content encryption configuration entries is associated with a first content encryption configuration and indicates: a first object class indicating a first object to be detected based on input media data; and a first key associated with the first object class; and one or more processors configured to maintain the one or more content encryption configuration entries at the memory, where to maintain the first content encryption configuration entry, the one or more processors is further configured to: receive an update associated with the first content encryption configuration; and modify, based on the update, the first content encryption configuration entry to generate an updated first content encryption configuration entry.

Example 2 includes the device of Example 1, where: the input media data includes image media data, video media data, or a combination thereof; and the first key of the first content encryption configuration entry includes an encryption key, a public key of a public-private key pair, a private key of the public-private key pair, or a combination thereof.

Example 3 includes the device of Example 1 or Example 2, where: the first content encryption configuration entry indicates a first source, and the first source indicates a user, a contact, an agent, an entity, or a regulation.

Example 4 includes the device of any of Examples 1 to 3, where the first content encryption configuration entry indicates a first model configured to enable detection of an instance of the first object class.

Example 5 includes the device of any of Examples 1 to 4, where the first content encryption configuration entry indicates a first encryption condition, and the first encryption condition indicates to encrypt the first object class based on a physical space, an environment, an object, or a combination thereof.

Example 6 includes the device of any of Examples 1 to 5, where: the first content encryption configuration entry indicates a first status, and the first status indicates an active status or an inactive status of the first content encryption configuration.

Example 7 includes the device of Example 1 or Example 2, where: the first content encryption configuration entry further includes a first status of the first content, a first encryption condition, and a first model, and to modify the first content encryption configuration entry, the one or more processors are configured to modify, based on the update, the first content encryption configuration entry to change the first object class, the first key, the first status of the first content, the first encryption condition, the first model, or a combination thereof.

Example 8 includes the device of any of Examples 1 to 7, where the one or more processors are configured to: receive a remove request associated with the first content encryption configuration, and remove, based on the remove request, the updated first content encryption configuration.

Example 9 includes the device of any of Examples 1 to 8, where the one or more processors are configured to: obtain the first content encryption configuration of the one or more content encryption configurations; and generate, based on the first content encryption configuration, the first content encryption configuration entry of the one or more content encryption configuration entries stored at the memory.

Example 10 includes the device of Example 9, where: to obtain the first content encryption configuration, the one or more processors are configured to receive, from a protection device, a content encryption configuration request that indicates the first content encryption configuration, and the protection device is associated with an entity, a service provider, or a contact of a user associated with the device.

Example 11 includes the device of Example 10, where: to receive the content encryption configuration request, the one or more processors are configured to receive a broadcast message from the protection device, and the broadcast message indicates the content encryption configuration request.

Example 12 includes the device of Example 9, where, to obtain the first content encryption configuration, the one or more processors are configured to: receive a user input from a user of the device; and generate the first content encryption configuration based on the user input.

Example 13 includes the device of any of Examples 1 to 12, where the one or more processors are configured to: generate a content encryption configuration request that indicates the first content encryption configuration; and send the content encryption configuration request to a user device.

Example 14 includes the device of any of Examples 1 to 13, where the one or more processors are configured to: obtain a second content encryption configuration that indicates a second object class and a second key; and store the second content encryption configuration at the memory as a second configuration entry of the one or more content encryption configuration entries.

Example 15includes the device of any of Examples 1 to 14, where the one or more processors are configured to: receive a request to obtain input media data; select the first content encryption configuration entry; generate a first encryption key for the first object class; configure an object detector to detect the first object class within the input media data; detect the first object class within input media data; configure an encryptor to encrypt, based on the first encryption key, a portion of the input media data, the portion includes the first object class; encrypt, based on the first encryption key, the portion of the input media data that includes the first object class to generate first encrypted media data; and generate output media data that includes: the first encrypted media data; and an encrypted version of the first encryption key encrypted based on the first key.

Example 16 includes the device of Example 15, where the one or more processors are configured to store the first encrypted media data at the memory.

Example 17 includes the device of Example 15 or Example 16, where the one or more processors are configured to send the first encrypted media data to a decoder device.

Example 18 includes the device of any of Examples 15 to 17, and further includes one or more cameras coupled to the one or more processors, and where the one or more cameras are configured to generate the input media data.

Example 19 includes the device of any of Examples 15 to 18, and further includes a display device coupled to the one or more processors and configured to output display data based on the output media data.

Example 20 includes the device of any of Examples 15 to 19, and further includes a modem coupled to the one or more processors, the modem configured to transmit the first encrypted media data to a decoder device.

Example 21 includes the device of any of Examples 15 to 20, and further includes an input device configured to receive an input and provide the input to the one or more processors, where the input includes a request to generate the input media data.

Example 22 includes the device of any of Examples 1 to 21, where the one or more processors are integrated in a mobile phone, a tablet computer device, a wearable electronic device, a virtual reality headset, a mixed reality headset, an augmented reality headset, or a camera device.

Example 23 includes the device of any of Examples 1 to 21, where the one or more processors are integrated in a vehicle.

According to Example 24, a method includes: storing, at a memory, one or more content encryption configuration entries, a first content encryption configuration entry of the one or more content encryption configuration entries is associated with a first content encryption configuration and indicates: a first object class indicating a first object to be detected based on input media data; and a first key associated with the first object class; and maintaining the one or more content encryption configuration entries at the memory, where maintaining the one or more content encryption configuration entries includes: receiving an update associated with the first content encryption configuration; and modifying, based on the update, the first content encryption configuration entry to generate an updated first content encryption configuration entry.

Example 25 includes the method of Example 24, where the first key of the first content encryption configuration entry includes an encryption key, a public key of a public-private key pair, a private key of the public-private key pair, or a combination thereof.

Example 26 includes the method of Example 24 or 25, where: the first content encryption configuration entry indicates a first source, and the first source indicates a user, a contact, an agent, an entity, or a regulation.

Example 27 includes the method of any of Examples 24 to 26, where the first content encryption configuration entry indicates a first model configured to enable detection of an instance of the first object class.

Example 28 includes the method of any of Examples 24 to 27, where the first content encryption configuration entry indicates a first encryption condition, and the first encryption condition indicates to encrypt the first object class based on a physical space, an environment, an object, or a combination thereof.

Example 29 includes the method of any of Examples 24 to 28, where: the first content encryption configuration entry indicates a first status, and the first status indicates an active status or an inactive status of the first content encryption configuration.

Example 30 includes the method of Example 24 or Example 25, where: the first content encryption configuration entry further includes a first status of the first content, a first encryption condition, and a first model, and modifying the first content encryption configuration entry includes modifying, based on the update, the first content encryption configuration entry to change the first object class, the first key, the first status of the first content, the first encryption condition, the first model, or a combination thereof.

Example 31 includes the method of any of Examples 24 to 30, and further includes: receiving a remove request associated with the first content encryption configuration, and removing, based on the remove request, the updated first content encryption configuration.

Example 32 includes the method of any of Examples 24 to 31, and further includes: obtaining the first content encryption configuration of the one or more content encryption configurations; and generating, based on the first content encryption configuration, the first content encryption configuration entry of the one or more content encryption configuration entries stored at the memory.

Example 33 includes the method of Example 32, where: obtaining the first content encryption configuration includes receiving, from a protection device, a content encryption configuration request that indicates the first content encryption configuration, and the protection device is associated with an entity, a service provider, or a contact of a user associated with the device.

Example 34 includes the method of Example 33, where: receiving the content encryption configuration request includes receiving a broadcast message from the protection device, and the broadcast message indicates the content encryption configuration request.

Example 35 includes the method of Example 32, where obtaining the first content encryption configuration includes: receiving a user input from a user of the device; and generating the first content encryption configuration based on the user input.

Example 36 includes the method of any of Examples 24 to 35, and further includes: generating a content encryption configuration request that indicates the first content encryption configuration; and sending the content encryption configuration request to a user device.

Example 37 includes the method of any of Examples 24 to 36, and further includes: obtaining a second content encryption configuration that indicates a second object class and a second key; and storing the second content encryption configuration at the memory as a second configuration entry of the one or more content encryption configuration entries.

Example 38 includes the method of any of Examples 24 to 37, and further includes: receiving a request to obtain input media data; selecting the first content encryption configuration entry; generating a first encryption key for the first object class; configuring an object detector to detect the first object class within the input media data; detecting the first object class within input media data; configuring an encryptor to encrypt, based on the first encryption key, a portion of the input media data, the portion includes the first object class; encrypting, based on the first encryption key, the portion of the input media data that includes the first object class to generate first encrypted media data; and generating output media data that includes: the first encrypted media data; and an encrypted version of the first encryption key encrypted based on the first key.

Example 39 includes the method of Example 38, and further includes storing the first encrypted media data at the memory.

Example 40 includes the method of Example 38 or 39, and further includes sending the first encrypted media data to a decoder device.

Example 41 includes the method of Example 38 to 40, and further includes generating, via one or more cameras, the input media data.

Example 42 includes the method of any of Examples 38 to 41, and further includes outputting, via a display device, display data based on the output media data.

Example 43 includes the method of any of Examples 38 to 42, and further includes transmitting, via a modem, the first encrypted media data to a decoder device.

Example 44 includes the method of any of Examples 38 to 43, and further includes receiving, via an input device, an input that includes a request to generate the input media data.

Example 45 includes the method of any of Examples 24 to 44, where the method is performed at a mobile phone, a tablet computer device, a wearable electronic device, a virtual reality headset, a mixed reality headset, an augmented reality headset, or a camera device.

Example 46 includes the method of any of Examples 24 to 44, where the method is performed at a vehicle.

According to Example 47, an apparatus includes: means for storing one or more content encryption configuration entries, a first content encryption configuration entry of the one or more content encryption configuration entries is associated with a first content encryption configuration and indicates: a first object class indicating a first object to be detected based on input media data; and a first key associated with the first object class; and means for maintaining the one or more content encryption configuration entries at the memory, where the means for maintaining includes: means for receiving an update associated with the first content encryption configuration; and means for modifying, based on the update, the first content encryption configuration entry to generate an updated first content encryption configuration entry.

Example 48 includes the apparatus of Example 47, where the first key of the first content encryption configuration entry includes an encryption key, a public key of a public-private key pair, a private key of the public-private key pair, or a combination thereof.

Example 49 includes the apparatus of Example 47 or 48, where: the first content encryption configuration entry indicates a first source, and the first source indicates a user, a contact, an agent, an entity, or a regulation.

Example 50 includes the apparatus of any of Examples 47 to 49, where the first content encryption configuration entry indicates a first model configured to enable detection of an instance of the first object class.

Example 51 includes the apparatus of any of Examples 47 to 50, where the first content encryption configuration entry indicates a first encryption condition, and the first encryption condition indicates to encrypt the first object class based on a physical space, an environment, an object, or a combination thereof.

Example 52 includes the apparatus of any of Examples 47 to 51, where: the first content encryption configuration entry indicates a first status, and the first status indicates an active status or an inactive status of the first content encryption configuration.

Example 53 includes the apparatus of Example 47 or Example 48, where: the first content encryption configuration entry further includes a first status of the first content, a first encryption condition, and a first model, and the means for modifying the first content encryption configuration entry includes means for modifying, based on the update, the first content encryption configuration entry to change the first object class, the first key, the first status of the first content, the first encryption condition, the first model, or a combination thereof.

Example 54 includes the apparatus of any of Examples 47 to 53, and further includes: means for receiving a remove request associated with the first content encryption configuration, and means for removing, based on the remove request, the updated first content encryption configuration.

Example 55 includes the apparatus of any of Examples 47 to 54, and further includes: means for obtaining the first content encryption configuration of the one or more content encryption configurations; and means for generating, based on the first content encryption configuration, the first content encryption configuration entry of the one or more content encryption configuration entries stored at the means for storing.

Example 56 includes the apparatus of Example 55, where: the means for obtaining the first content encryption configuration includes means for receiving, from a protection device, a content encryption configuration request that indicates the first content encryption configuration, and the protection device is associated with an entity, a service provider, or a contact of a user associated with the device.

Example 57 includes the apparatus of Example 56, where: the means for receiving the content encryption configuration request includes receiving a broadcast message from the protection device, and the broadcast message indicates the content encryption configuration request.

Example 58 includes the apparatus of Example 55, where the means for obtaining the first content encryption configuration includes: means for receiving a user input from a user of the device; and means for generating the first content encryption configuration based on the user input.

Example 59 includes the apparatus of any of Examples 47 to 58, and further includes: means for generating a content encryption configuration request that indicates the first content encryption configuration; and means for sending the content encryption configuration request to a user device.

Example 60 includes the apparatus of any of Examples 47 to 59, and further includes: means for obtaining a second content encryption configuration that indicates a second object class and a second key; and means for storing the second content encryption configuration at the memory as a second configuration entry of the one or more content encryption configuration entries.

Example 61 includes the apparatus of any of Examples 47 to 60, and further includes: means for receiving a request to obtain input media data; means for selecting the first content encryption configuration entry; means for generating a first encryption key for the first object class; means for configuring an object detector to detect the first object class within the input media data; means for detecting the first object class within input media data; means for configuring an encryptor to encrypt, based on the first encryption key, a portion of the input media data, the portion includes the first object class; means for encrypting, based on the first encryption key, the portion of the input media data that includes the first object class to generate first encrypted media data; and means for generating output media data that includes: the first encrypted media data; and an encrypted version of the first encryption key encrypted based on the first key.

Example 62 includes the apparatus of Example 61, and further includes means for storing the first encrypted media data at the memory.

Example 63 includes the apparatus of Example 61 or 62, and further includes means for sending the first encrypted media data to a decoder device.

Example 64 includes the apparatus of Example 61 to 63, and further includes means for generating the input media data.

Example 65 includes the apparatus of any of Examples 61 to 64, and further includes means for outputting display data based on the output media data.

Example 66 includes the apparatus of any of Examples 61 to 65, and further includes means for transmitting the first encrypted media data to a decoder device.

Example 67 includes the apparatus of any of Examples 61 to 66, and further includes means for receiving an input that includes a request to generate the input media data.

Example 68 includes the apparatus of any of Examples 47 to 67, where the apparatus is or is integrated in a mobile phone, a tablet computer device, a wearable electronic device, a virtual reality headset, a mixed reality headset, an augmented reality headset, or a camera device.

Example 69 includes the apparatus of any of Examples 47 to 67, where the apparatus is or is integrated in a vehicle.

According to Example 70, a non-transitory computer-readable medium that stores instructions that are executable by one or more processors to cause the one or more processors to: store, at a memory, one or more content encryption configuration entries, a first content encryption configuration entry of the one or more content encryption configuration entries is associated with a first content encryption configuration and indicates: a first object class indicating a first object to be detected based on input media data; and a first key associated with the first object class; and maintain the one or more content encryption configuration entries at the memory, where, to maintain the one or more content encryption configuration entries, the instructions are further executable by the one or more processors to cause the one or more processors to: receive an update associated with the first content encryption configuration; and modify, based on the update, the first content encryption configuration entry to generate an updated first content encryption configuration entry.

Example 71 includes the non-transitory computer-readable medium of Example 70, where the first key of the first content encryption configuration entry includes an encryption key, a public key of a public-private key pair, a private key of the public-private key pair, or a combination thereof.

Example 72 includes the non-transitory computer-readable medium of Example 70 or 71, where: the first content encryption configuration entry indicates a first source, and the first source indicates a user, a contact, an agent, an entity, or a regulation.

Example 73 includes the non-transitory computer-readable medium of any of Examples 70 to 72, where the first content encryption configuration entry indicates a first model configured to enable detection of an instance of the first object class.

Example 74 includes the non-transitory computer-readable medium of any of Examples 70 to 73, where the first content encryption configuration entry indicates a first encryption condition, and the first encryption condition indicates to encrypt the first object class based on a physical space, an environment, an object, or a combination thereof.

Example 75 includes the non-transitory computer-readable medium of any of Examples 70 to 74, where: the first content encryption configuration entry indicates a first status, and the first status indicates an active status or an inactive status of the first content encryption configuration.

Example 76 includes the non-transitory computer-readable medium of Example 70 or Example 71, where the first content encryption configuration entry further includes a first status of the first content, a first encryption condition, and a first model, and to modify the first content encryption configuration entry.

Example 77 includes the non-transitory computer-readable medium of Example 76, where the instructions are further executable by the one or more processors to cause the one or more processors to modify, based on the update, the first content encryption configuration entry to change the first object class, the first key, the first status of the first content, the first encryption condition, the first model, or a combination thereof.

Example 78 includes the non-transitory computer-readable medium of any of Examples 70 to 77, where the instructions are further executable by the one or more processors to cause the one or more processors to: receive a remove request associated with the first content encryption configuration, and remove, based on the remove request, the updated first content encryption configuration.

Example 79 includes the non-transitory computer-readable medium of any of Examples 70 to 78, where the instructions are further executable by the one or more processors to cause the one or more processors to: obtain the first content encryption configuration of the one or more content encryption configurations; and generate, based on the first content encryption configuration, the first content encryption configuration entry of the one or more content encryption configuration entries stored at the memory.

Example 80 includes the non-transitory computer-readable medium of Example 79, where: to obtain the first content encryption configuration, the instructions are further executable by the one or more processors to cause the one or more processors to receive, from a protection device, a content encryption configuration request that indicates the first content encryption configuration, and the protection device is associated with an entity, a service provider, or a contact of a user associated with the device.

Example 81 includes the non-transitory computer-readable medium of Example 80, where: to receive the content encryption configuration request, the instructions are further executable by the one or more processors to cause the one or more processors to receive a broadcast message from the protection device, and the broadcast message indicates the content encryption configuration request.

Example 82 includes the non-transitory computer-readable medium of Example 79, where, to obtain the first content encryption configuration, the instructions are further executable by the one or more processors to cause the one or more processors to: receive a user input from a user of the device; and generate the first content encryption configuration based on the user input.

Example 83 includes the non-transitory computer-readable medium of any of Examples 70 to 82, where the instructions are further executable by the one or more processors to cause the one or more processors to: generate a content encryption configuration request that indicates the first content encryption configuration; and send the content encryption configuration request to a user device.

Example 84 includes the non-transitory computer-readable medium of any of Examples 70 to 83, where the instructions are further executable by the one or more processors to cause the one or more processors to: obtain a second content encryption configuration that indicates a second object class and a second key; and store the second content encryption configuration at the memory as a second configuration entry of the one or more content encryption configuration entries.

Example 85 includes the non-transitory computer-readable medium of any of Examples 70 to 84, where the instructions are further executable by the one or more processors to cause the one or more processors to: receive a request to obtain input media data; select the first content encryption configuration entry; generate a first encryption key for the first object class; configure an object detector to detect the first object class within the input media data; detect the first object class within input media data; configure an encryptor to encrypt, based on the first encryption key, a portion of the input media data, the portion includes the first object class; encrypt, based on the first encryption key, the portion of the input media data that includes the first object class to generate first encrypted media data; and generate output media data that includes: the first encrypted media data; and an encrypted version of the first encryption key encrypted based on the first key.

Example 86 includes the non-transitory computer-readable medium of Example 85, where the instructions are further executable by the one or more processors to cause the one or more processors to store the first encrypted media data at the memory.

Example 87 includes the non-transitory computer-readable medium of Example 85 or 86, where the instructions are further executable by the one or more processors to cause the one or more processors to send the first encrypted media data to a decoder device.

Example 88 includes the non-transitory computer-readable medium of Example 85 to 87, where the instructions are further executable by the one or more processors to cause the one or more processors to generate, via one or more cameras, the input media data.

Example 89 includes the non-transitory computer-readable medium of any of Examples 85 to 88, where the instructions are further executable by the one or more processors to cause the one or more processors to output, via a display device, display data based on the output media data.

Example 90 includes the non-transitory computer-readable medium of any of Examples 85 to 89, where the instructions are further executable by the one or more processors to cause the one or more processors to transmit, via a modem, the first encrypted media data to a decoder device.

Example 91 includes the non-transitory computer-readable medium of any of Examples 85 to 90, where the instructions are further executable by the one or more processors to cause the one or more processors to receive, via an input device, an input that includes a request to generate the input media data.

Example 92 includes the non-transitory computer-readable medium of any of Examples 70 to 91, where the non-transitory computer-readable medium is included or integrated in a mobile phone, a tablet computer device, a wearable electronic device, a virtual reality headset, a mixed reality headset, an augmented reality headset, or a camera device.

Example 93 includes the non-transitory computer-readable medium of any of Examples 70 to 91, where the non-transitory computer-readable medium is included or integrated in a vehicle.

Example 94 includes the device of Example 15, where: the one or more processors are configured to generate the output media data to further include a masked version of the input media data, the masked version including a masked portion corresponding to the portion of the input media data that includes the first object class; and the output media data comprises a bitstream that includes an encoded masked image frame corresponding to the masked version of the input media data and an encoded encrypted region of interest frame corresponding to the first encrypted media data.

Example 95 includes the device of Example 94, where the encoded encrypted region of interest frame includes a no-display indicator indicating that the encoded encrypted region of interest frame is not to be displayed, a frame identifier that associates the encoded encrypted region of interest frame with the encoded masked image frame, or a combination thereof.

Example 96 includes the device of Example 94, where the bitstream further includes an encoded segmentation frame, the encoded segmentation frame including a no-display indicator and a frame identifier corresponding to the encoded masked image frame.

Example 97 includes the device of Example 15, where the output media data includes content protection data, the content protection data including at least one of an encryption indicator, an identity indicator, a non-display indicator, an object class indicator, or a condition indicator.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
a memory configured to store one or more content encryption configuration entries, a first content encryption configuration entry of the one or more content encryption configuration entries is associated with a first content encryption configuration and indicates:
a first object class indicating a first object to be detected based on input media data; and
a first key associated with the first object class; and
one or more processors configured to maintain the one or more content encryption configuration entries at the memory, wherein to maintain the first content encryption configuration entry, the one or more processors is further configured to:
receive an update associated with the first content encryption configuration; and
modify, based on the update, the first content encryption configuration entry to generate an updated first content encryption configuration entry.

2. The device of claim 1, wherein:
the input media data includes image media data, video media data, or a combination thereof, and
the first key of the first content encryption configuration entry includes an encryption key, a public key of a public-private key pair, a private key of the public-private key pair, or a combination thereof.

3. The device of claim 1, wherein:
the first content encryption configuration entry indicates a first source, and
the first source indicates a user, a contact, an agent, an entity, or a regulation.

4. The device of claim 1, wherein the first content encryption configuration entry indicates a first model configured to enable detection of an instance of the first object class.

5. The device of claim 1, wherein the first content encryption configuration entry indicates a first encryption condition, and the first encryption condition indicates to encrypt the first object class based on a physical space, an environment, an object, or a combination thereof.

6. The device of claim 1, wherein:
the first content encryption configuration entry indicates a first status, and
the first status indicates an active status or an inactive status of the first content encryption configuration.

7. The device of claim 1, wherein the one or more processors are configured to:
receive a request to obtain input media data;
select the first content encryption configuration entry;
generate a first encryption key for the first object class;
configure an object detector to detect the first object class within the input media data;
detect the first object class within input media data;
configure an encryptor to encrypt, based on the first encryption key, a portion of the input media data, the portion includes the first object class;
encrypt, based on the first encryption key, the portion of the input media data that includes the first object class to generate first encrypted media data; and
generate output media data that includes:
the first encrypted media data; and
an encrypted version of the first encryption key encrypted based on the first key.

8. The device of claim 7, wherein:
the one or more processors are configured to generate the output media data to further include a masked version of the input media data, the masked version including a masked portion corresponding to the portion of the input media data that includes the first object class, and
the output media data comprises a bitstream that includes an encoded masked image frame corresponding to the masked version of the input media data and an encoded encrypted region of interest frame corresponding to the first encrypted media data.

9. The device of claim 8, wherein the encoded encrypted region of interest frame includes:
a no-display indicator indicating that the encoded encrypted region of interest frame is not to be displayed,
a frame identifier that associates the encoded encrypted region of interest frame with the encoded masked image frame, or
a combination thereof.

10. The device of claim 8, wherein the bitstream further includes an encoded segmentation frame, the encoded segmentation frame including a no-display indicator and a frame identifier corresponding to the encoded masked image frame.

11. The device of claim 7, wherein the output media data includes content protection data, the content protection data including at least one of an encryption indicator, an identity indicator, a non-display indicator, an object class indicator, or a condition indicator.

12. The device of claim 7, wherein the one or more processors are configured to store the first encrypted media data at the memory.

13. The device of claim 7, wherein the one or more processors are configured to send the first encrypted media data to a decoder device.

14. The device of claim 7, further including one or more cameras coupled to the one or more processors, and wherein the one or more cameras are configured to generate the input media data.

15. The device of claim 7, further including a display device coupled to the one or more processors and configured to output display data based on the output media data.

16. The device of claim 7, further including a modem coupled to the one or more processors, the modem configured to transmit the first encrypted media data to a decoder device.

17. The device of claim 7, further including an input device configured to receive an input and provide the input to the one or more processors, wherein the input includes a request to generate the input media data.

18. The device of claim 1, wherein the one or more processors are integrated in a mobile phone, a tablet computer device, a wearable electronic device, a virtual reality headset, a mixed reality headset, an augmented reality headset, or a camera device.

19. The device of claim 1, wherein the one or more processors are integrated in a vehicle.

20. A method comprising:
storing, at a memory, one or more content encryption configuration entries, a first content encryption configuration entry of the one or more content encryption configuration entries is associated with a first content encryption configuration and indicates:
a first object class indicating a first object to be detected based on input media data; and
a first key associated with the first object class; and
maintaining the one or more content encryption configuration entries at the memory, wherein maintaining the one or more content encryption configuration entries includes:
receiving an update associated with the first content encryption configuration; and
modifying, based on the update, the first content encryption configuration entry to generate an updated first content encryption configuration entry.

21. The method of claim 20, wherein:
the first content encryption configuration entry further includes a first status of the first content, a first encryption condition, and a first model, and
modifying the first content encryption configuration entry includes modifying, based on the update, the first content encryption configuration entry to change the first object class, the first key, the first status of the first content, the first encryption condition, the first model, or a combination thereof.

22. The method of claim 20, further including:
receiving a remove request associated with the first content encryption configuration, and
removing, based on the remove request, the updated first content encryption configuration.

23. The method of claim 20, further including:
obtaining the first content encryption configuration of the one or more content encryption configurations; and
generating, based on the first content encryption configuration, the first content encryption configuration entry of the one or more content encryption configuration entries stored at the memory.

24. The method of claim 23, wherein:
obtaining the first content encryption configuration includes receiving, from a protection device, a content encryption configuration request that indicates the first content encryption configuration, and
the protection device is associated with an entity, a service provider, or a contact of a user associated with the device.

25. The method of claim 24, wherein:
receiving the content encryption configuration request includes receiving a broadcast message from the protection device, and
the broadcast message indicates the content encryption configuration request.

26. The method of claim 23, wherein obtaining the first content encryption configuration includes:
receiving a user input from a user of the device; and
generating the first content encryption configuration based on the user input.

27. The method of claim 20, further including:
generating a content encryption configuration request that indicates the first content encryption configuration; and
sending the content encryption configuration request to a user device.

28. The method of claim 20, further including:
obtaining a second content encryption configuration that indicates a second object class and a second key; and
storing the second content encryption configuration at the memory as a second configuration entry of the one or more content encryption configuration entries.

29. A non-transitory computer-readable medium that stores instructions that are executable by one or more processors to cause the one or more processors to:
store, at a memory, one or more content encryption configuration entries, a first content encryption configuration entry of the one or more content encryption configuration entries is associated with a first content encryption configuration and indicates:
a first object class indicating a first object to be detected based on input media data; and
a first key associated with the first object class; and
maintain the one or more content encryption configuration entries at the memory, wherein, to maintain the one or more content encryption configuration entries, the instructions are further executable by the one or more processors to cause the one or more processors to:
receive an update associated with the first content encryption configuration; and
modify, based on the update, the first content encryption configuration entry to generate an updated first content encryption configuration entry.

30. An apparatus comprising:
means for storing one or more content encryption configuration entries, a first content encryption configuration entry of the one or more content encryption configuration entries is associated with a first content encryption configuration and indicates:
a first object class indicating a first object to be detected based on input media data; and
a first key associated with the first object class; and
means for maintaining the one or more content encryption configuration entries at the memory, wherein the means for maintaining includes:
means for receiving an update associated with the first content encryption configuration; and
means for modifying, based on the update, the first content encryption configuration entry to generate an updated first content encryption configuration entry.
